(19) United States
(12) Patent Application Publication
(10) Pub. No.: US 2024/0364185 A1
(43) Pub. Date: Oct. 31, 2024

(54) MULTI-MOTOR DRIVE SYSTEM

(71) Applicant: Black & Decker Inc., New Britain, CT (US)

(72) Inventors: Austin L. Ganzermiller, Reisterstown, MD (US); Daniel L. Schwarz, Jarrettsville, MD (US); Corey L. Bean, Baltimore, MD (US)

(21) Appl. No.: 18/647,665

(22) Filed: Apr. 26, 2024

Related U.S. Application Data
(60) Provisional application No. 63/498,443, filed on Apr. 26, 2023.

(51) Int. Cl. H02K 7/20; H02K 5/20; H02K 5/22; H02K 7/08; H02K 7/116; H02K 11/33

(52) U.S. Cl. CPC H02K 7/20; H02K 5/20; H02K 5/225; H02K 7/08; H02K 7/116; H02K 11/33; H02K 2213/03

(57) ABSTRACT

A multi-motor drive unit includes a rear cover and a plurality of motors disposed around a center longitudinal axis along a radial plane. A rear end of the plurality of motors is secured to the rear cover and each of the plurality of motors includes a pinion. The multi-motor drive unit includes a master gear including peripheral teeth that engage the pinion of each of the plurality of motors, a motor adapter disposed between the master gear and the plurality of motors to pilot and support the master gear and a front end of the plurality of motors, an output shaft, and a front cover to pilot and support an output bearing of the output shaft.

### CROSS REFERENCE TO RELATED APPLICATION

This application claims priority to and the benefit of U.S. Provisional Application No. 63/498,443, filed on Apr. 26, 2023, and titled “Multi-Motor Drive System,” which is hereby incorporated by reference in its entirety.

### FIELD

This application relates to drive system including a plurality of motors driving a common shaft.

### SUMMARY

According to an embodiment, a multi-motor drive unit is provided including: a rear cover; a plurality of motors disposed around a center longitudinal axis along a radial plane and secured to the rear cover, each motor including a drive output and a pinion; a master gear including peripheral teeth in driving engagement with the pinions; a motor adaptor disposed between the master gear and the plurality of motors to pilot and support a master bearing of the master gear; an output shaft driven by the master gear; and a front cover arranged to pilot and support an output bearing of the output shaft.

In an embodiment, the drive unit further includes a sleeve configured to surround the motors disposed between the rear and front covers.

In an embodiment, rotors of at least a first subset of the motors are aligned relative to their respective stators but rotors of at least a second subset of the motors are aligned relative to their respective stators. In an embodiment, rotors of the motors are sequentially shifted relative to their respective stators.

In an embodiment, commutation drive signals of the second subset of the motors are shifted relative to the commutation drive signals of the first subset of the motors. In an embodiment, the commutation drive signals of the motors are sequentially shifted. In an embodiment, this distributes the torque ripples associated with the motors over a commutation cycle and improves drive unit torque ripple.

In an embodiment, each motor is commutated for a sub-portion of a commutation drive cycle near its peak efficiency, and the motors are commutated in sequence to achieve a full commutation cycle.

In one general aspect, a motor system includes at least one motor driving a shaft, where a power/volume ratio is in a range of approximately 5 W/cm³ to 25 W/cm³. In an embodiment, the power/volume ratio is in a range of approximately 7 W/cm³ to 18 W/cm³. In an embodiment, the power/volume ratio is at least 7 W/cm³. In an embodiment, the power/volume ratio is at least 9 W/cm³. In an embodiment, the power/volume ratio is at least 17 W/cm³.

In one general aspect, a motor system includes at least one motor driving a shaft, where a power/copper ratio is in a range of approximately 25 W/g to 65 W/g. In an embodiment, the power/copper ratio is in the range of approximately 30 W/g to 60 W/g. In an embodiment, the power/copper ratio is at least 30 W/g. In an embodiment the power/copper ratio is at least 35 W/g. In an embodiment, the power/copper ratio is at least 56 W/g.

In one general aspect, a motor system includes at least one motor driving a shaft, where a magnetic interface boundary/cross section ratio is in a range of approximately 1.5 mm/cm² to 3.0 mm/cm². In an embodiment, the magnetic interface boundary/cross section ratio is in a range of approximately 1.7 mm/cm² to 2.8 mm/cm². In an embodiment, the magnetic interface boundary/cross section ratio is in a range of approximately 2.0 mm/cm² to 2.7 mm/cm². In an embodiment, the magnetic interface boundary/cross section ratio is at least 2.5 mm/cm². In an embodiment, the magnetic interface boundary/cross section ratio is at least 2.7 mm/cm².

In one general aspect, a motor system includes at least one motor driving a shaft, where a stator envelope heatsink surface area/motor volume ratio is in a range of approximately 40 mm²/cm³ to 70 mm²/cm³. In an embodiment, the stator envelope heatsink surface area/motor volume ratio is in a range of approximately 50 mm²/cm³ to 60 mm²/cm³. In an embodiment, the stator envelope heatsink surface area/motor volume ratio is in a range of approximately 53 mm²/cm³ to 60 mm²/cm³. In an embodiment, the stator envelope heatsink surface area/motor volume ratio is at least 55 mm²/cm³.

In one general aspect, a motor system includes at least one motor driving a shaft, where a magnetic interface area (MIA)/angular momentum ratio at no load RPM ratio is in a range of approximately 200.0 cm²/kg·m²/s to 600 cm²/kg·m²/s. In an embodiment, the magnetic interface area (MIA)/angular momentum ratio at no load RPM ratio is in a range of approximately 250.0 cm²/kg·m²/s to 565 cm²/kg·m²/s. In an embodiment, the magnetic interface area (MIA)/angular momentum ratio at no load RPM ratio is in a range of approximately 300.0 cm²/kg·m²/s to 555 cm²/kg·m²/s. In an embodiment, the magnetic interface area (MIA)/angular momentum ratio at no load RPM ratio is at least 309.0 cm²/kg·m²/s. In an embodiment, the magnetic interface area (MIA)/angular momentum ratio at no load RPM ratio is at least 550.0 cm²/kg·m²/s.

### BRIEF DESCRIPTION OF THE DRAWINGS

The various advantages of the embodiments will become apparent to one skilled in the art by reading the following specification and appended claims, and by referencing the following drawings, in which:

FIG. 1 depicts a perspective view of a multi-motor drive unit, according to an embodiment;

FIG. 2 depicts another perspective view of the multi-motor drive unit, according to an embodiment;

FIG. 3 depicts an exploded view of the multi-motor drive unit, according to an embodiment;

FIG. 4 depicts another exploded view of the multi-motor drive unit, according to an embodiment;

FIG. 5 depicts an axial cross-section view of the multi-motor drive unit, according to an embodiment;

FIG. 6 depicts a side cross-section of the multi-motor drive unit, according to an embodiment;

FIGS. 7 and 8 depict perspective rear and front views of a single Brushless Direct-Current (BLDC) motor of the multi-motor drive unit, according to an embodiment;

FIG. 9 depicts a partial side cross-section view of the multi-motor drive unit showing the cross-section of one BLDC motor, according to an embodiment;

FIGS. 10 and 11 depict perspective rear and front views of a rear cover of the multi-motor drive unit, according to an embodiment;

FIGS. 12 and 13 depict perspective rear and front views of a plurality of BLDC motors mounted on the rear cover of the multi-motor drive unit, according to an embodiment;

FIGS. 14 and 15 depict perspective rear and front views of a sleeve additionally mounted on the rear cover of the multi-motor drive unit, according to an embodiment;

FIGS. 16 and 17 depict perspective rear and front views of a motor adaptor mounted on a front face of the sleeve of the multi-motor drive unit, according to an embodiment;

FIG. 18 depicts a perspective front view of a spacer mounted on a front face of the motor adaptor of the multi-motor drive unit, according to an embodiment;

FIG. 19 depicts a perspective front view of a master gear mounted in engagement with output pinions of the BLDC motors of the multi-motor drive unit, according to an embodiment;

FIG. 20 depict a perspective rear exploded view of a planet gear and carrier assembly, according to an embodiment;

FIG. 21 depicts a perspective front view of the planet gear and carrier assembly mounted in driving engagement with the master gear of the multi-motor drive unit, according to an embodiment;

FIG. 22 depicts a perspective front view of a ring gear mount mounted in engagement with a front face of the spacer of the multi-motor drive unit, according to an embodiment;

FIG. 23 depicts a perspective front view of a ring gear mounted in engagement with a front face of the ring gear mount in engagement with the planet gears of the multi-motor drive unit, according to an embodiment;

FIG. 24 depict a perspective front view of a front bearing and a bearing seal mounted on the output shaft of the planet gear and carrier assembly, according to an embodiment;

FIG. 25 depicts a perspective rear view of a front cover of the multi-motor drive unit, according to an embodiment;

FIG. 26 depicts a rear perspective view of the multi-motor drive unit including wiring connections for powering the BLDC motors, according to an embodiment;

FIG. 27 depicts a simple circuit diagram of a delta-parallel motor configuration of a single BLDC motor, according to an embodiment;

FIG. 28 depicts a simple circuit diagram of an inverter circuit for driving a single BLDC motor, according to an embodiment;

FIG. 29 depicts a simple voltage waveform diagram of drive signals for driving a single BLDC motor, according to an embodiment;

FIG. 30 depicts a simple circuit diagram of wiring connections for powering the motors of the multi-motor drive unit, according to an embodiment;

FIG. 31 depicts a simple block diagram of a motor control unit for powering the BLDC motors of the multi-motor drive unit, according to an embodiment;

FIG. 32 depicts a simple block diagram of a motor control unit for powering the BLDC motors of the multi-motor drive unit, according to an alternative embodiment;

FIG. 33 depicts a waveform diagram of the drive unit torque ripple where the motors are driven full synchronously, according to an embodiment;

FIG. 34 depicts an axial cross-section view of the multi-motor drive unit where the motors are sequentially oriented with a mechanical phase shift, according to an embodiment;

FIG. 35 depicts a simple voltage waveform diagram of a phase-shift drive scheme applied to the motors of FIG. 34 to reduce torque ripple, according to an embodiment;

FIG. 36 depicts a waveform diagram of the drive unit torque ripple using the phase-shift drive scheme, according to an embodiment;

FIG. 37 depicts a waveform diagram of the drive unit torque ripple using a half-split and a third-split scheme, where the phase-shift drive scheme is applied to the motors in groups of two and three respectively, according to an embodiment;

FIG. 38 depicts a chart showing the improvement in torque ripple resulting from the phase-shift drive scheme using full synch, half split, thirds split, and full split schemes, according to an embodiment;

FIG. 39 depicts a power waveform diagram showing an input power curve and an output power curve of a single motor within the power unit, according to an embodiment;

FIG. 40 depicts an efficiency waveform showing an efficiency curve of the single motor, according to an embodiment;

FIG. 41 depicts a simple voltage waveform diagram of a reduced commutation band drive scheme applied to the motors of the multi-motor drive unit to improve system efficiency, according to an embodiment;

FIG. 42 depicts a waveform diagram of the drive unit efficiency curves using full synch, half split, thirds split, and full split schemes, according to an embodiment; and

FIG. 43 depicts a chart showing the improvement in system efficiency resulting from the reduced commutation band drive scheme, according to an embodiment.

FIG. 44 depicts a perspective view of another multi-motor drive unit, according to an embodiment.

FIG. 45 depicts another perspective view of the multi-motor drive unit of FIG. 44, according to an embodiment.

FIG. 46 depicts an exploded view of the multi-motor drive unit of FIG. 44, according to an embodiment.

FIG. 47 depicts another exploded view of the multi-motor drive unit of FIG. 44, according to an embodiment.

FIG. 48 depicts a perspective view of another multi-motor drive unit, according to an embodiment.

FIG. 49 depicts another perspective view of the multi-motor drive unit of FIG. 48, according to an embodiment.

FIG. 50 depicts a partially exploded view of the multi-motor drive unit of FIG. 48, according to an embodiment.

FIG. 51 depicts an exploded view of the multi-motor drive unit of FIG. 48, according to an embodiment.

FIG. 52 depicts a perspective view of another multi-motor drive unit, according to an embodiment.

FIG. 53 depicts another perspective view of the multi-motor drive unit of FIG. 52, according to an embodiment.

FIG. 54 depicts a partially exploded view of the multi-motor drive unit of FIG. 52, according to an embodiment.

FIG. 55 depicts another partially exploded view of the multi-motor drive unit of FIG. 52, according to an embodiment.

FIG. 56 depicts another partially exploded view of the multi-motor drive unit of FIG. 52, according to an embodiment.

FIG. 57 depicts a perspective view of an inverted arrangement of multiple motors for use in a multi-motor drive unit, according to an embodiment.

FIG. 58 depicts a perspective view of a drive unit having multiple, multi-motor drive units, according to an embodiment.

FIG. 59 depicts another perspective view of the drive unit of FIG. 58, according to an embodiment.

FIG. 60 depicts a partially exploded view of the drive unit of FIG. 58, according to an embodiment.

FIG. 61 depicts another partially exploded view of the drive unit of FIG. 58, according to an embodiment.

FIG. 62 depicts a partially exploded view of the drive unit of FIG. 58, according to an embodiment.

FIG. 63 depicts a rear, left isometric view of an example circular saw.

FIG. 64 depicts a rear, right isometric view of the circular saw of FIG. 63.

FIG. 65 depicts an exploded view of the circular saw of FIG. 63.

FIG. 66 depicts a detail DET1 of the circular saw with the cover removed, as represented in FIG. 64.

FIG. 67 depicts a detail DET2 of the circular saw with the gearing and motors exposed, as represented in FIG. 63.

FIG. 68 depicts a detail DET2 of the circular saw with a front cover and pulley cover removed and the pulley removed, as represented in FIG. 63.

FIG. 69 depicts the transmission and pulley drive of the circular saw of FIG. 63 with covers removed and with idler pulley removed.

FIG. 70 depicts a detailed cross-sectional view Z-Z centered on the master pulley of the circular saw of FIG. 63, as represented in FIG. 67.

FIG. 71 depicts a front, right isometric view of an example multi-purpose saw.

FIG. 72 depicts a rear, right isometric view of the multi-purpose saw of FIG. 71 with a gear cover removed.

FIG. 73 depicts a rear, right isometric view of the multi-purpose saw of FIG. 71 with the gears exposed.

FIG. 74 depicts a rear, left isometric view of the multi-purpose saw of FIG. 71 with the motors exposed.

FIG. 75 depicts a perspective view of an example miter saw.

FIG. 76 depicts another perspective view of the miter saw of FIG. 75 with some components exposed.

FIG. 77 depicts a perspective view of the multi-motor drive unit of the miter saw of FIG. 75 as disposed on the blade housing.

FIG. 78 depicts a perspective view of the multi-motor drive unit and the transmission of the miter saw of FIG. 75.

FIG. 79 depicts a perspective view of the multi-motor drive unit and the transmission of the miter saw of FIG. 75 with the master pulley attached to the master gear.

FIG. 80 depicts a partial cross-sectional view WW centered on the master pulley of the miter saw of FIG. 75 with the cross-section WW represented in FIG. 79.

FIG. 81 depicts a perspective view of the pulley assembly of the miter saw of FIG. 75.

FIG. 82 is a perspective view of an example concrete saw.

FIG. 83 is an exploded view of the example concrete saw shown in FIG. 82.

FIG. 84 is a perspective view from a first side of the example concrete saw,

FIG. 85 is a perspective view from a second side of the example concrete saw, and

FIG. 86 is a side view taken from the first side of the example concrete saw shown in FIGS. 82 and 83, with a motor cover removed so that a multi-motor drive unit installed in a housing of the example concrete saw is visible.

FIG. 87 is a perspective view from the first side of the example concrete saw, with the motor cover removed so that the multi-motor drive unit installed in a housing of the example concrete saw is visible.

FIG. 88 is a perspective view from the second side of the example concrete saw, with a transmission cover removed so that a transmission installed in the housing of the example concrete saw is visible.

FIG. 89 is an assembled perspective view, and FIG. 90 is a partially exploded perspective view, of the example multi-motor drive unit shown in FIGS. 86 and 88.

FIG. 91 is a perspective view from the first side of the example concrete saw, and FIG. 92 is a perspective view from the second side of the example concrete saw, illustrating an arrangement of motors of the example multi-motor drive unit.

FIG. 93 is a partially exploded perspective view from the first side of the example concrete saw, and FIG. 94 is a second partially exploded perspective view from the second side of the example concrete saw, illustrating components of the multi-motor drive unit and the transmission of the example concrete saw.

FIG. 95 is a partially exploded perspective view illustrating components of the transmission.

FIG. 96 is a partially exploded view of an example pulley assembly and example hub assembly, from the first side of the multi-motor drive unit.

FIG. 97 is an exploded view of the example hub assembly, from the second side of the multi-motor drive unit.

FIG. 98A is a perspective view of an example multi-motor drive unit and blade guard assembly, from a first side of the assembly.

FIG. 98B is a perspective view of the example multi-motor drive unit and blade guard assembly shown in FIG. 98A, with a motor cover removed so that components of the multi-motor drive unit are visible.

FIG. 99A is a perspective view of the example multi-motor drive unit and blade guard assembly, from a second side of the assembly.

FIG. 99B is a perspective view of the example multi-motor drive unit and blade guard assembly shown in FIG. 99A, with a transmission cover removed so that components of a transmission are visible.

FIG. 100 is a partially exploded view of the example assembly shown in FIGS. 98A-99B.

FIG. 101 is a partially exploded view of the example multi-motor drive unit shown in FIG. 98B.

FIG. 102 is a partially exploded view of the example transmission shown in FIG. 99B.

FIG. 103 is an exploded view of an example hub assembly coupling the example multi-motor drive unit to a blade.

FIG. 104 depicts a table of power density calculations for various motor configurations.

FIG. 105 depicts a table of gear ratio ranges for various motor configurations.

FIG. 106 depicts a table of magnetic interface boundaries for various motor configurations.

FIG. 107 depicts a table of cooling characteristics for a conventional motor and a multi-motor drive unit.

FIG. 108 depicts a table of inertia calculations for various motor configurations.

Corresponding reference numerals may indicate corresponding parts throughout the several views of the drawings

### DESCRIPTION

Example embodiments will now be described more fully with reference to the accompanying drawings.

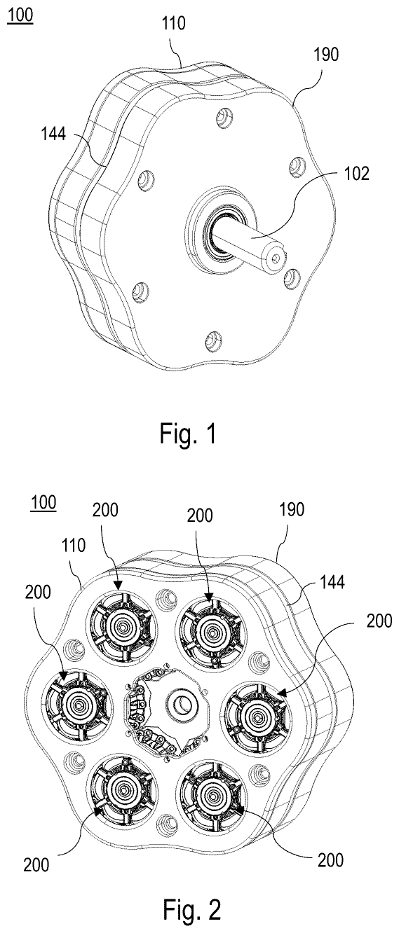

FIG. 1 depicts a perspective view of a multi-motor drive unit 100 (herein referred to as drive unit 100), according to an embodiment. FIG. 2 depicts another perspective view of the drive unit, according to an embodiment.

In an embodiment, multi-motor drive unit 100 includes a series of Brushless Direct-Current (BLDC) motors 200 (in this example six motors) that cooperate to drive a common output shaft 102. Drive unit 200 further includes a rear cover 110 and a front cover 190 that cover two ends of the unit. Motors 200 are disposed along a common radial plane and a circular array around a central longitudinal axis of the drive unit 100 (i.e., longitudinal axis of the output shaft 102) at equidistant angular positions relative to the longitudinal axis. As discussed below in detail, motors 200 are mechanically bound to a single core gear that transfer torque from output shafts of the respective motors 200 to the output shaft 102 of the drive unit 100.

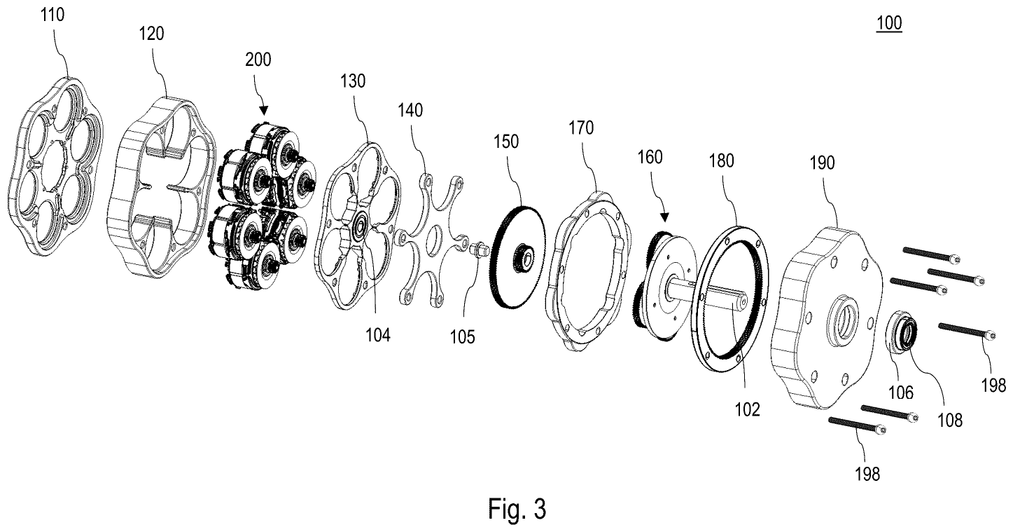

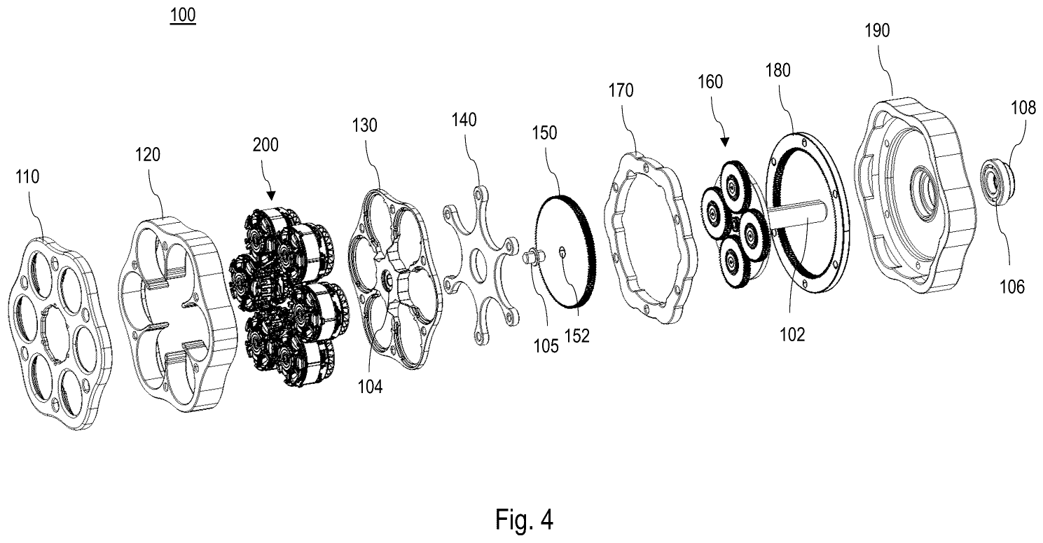

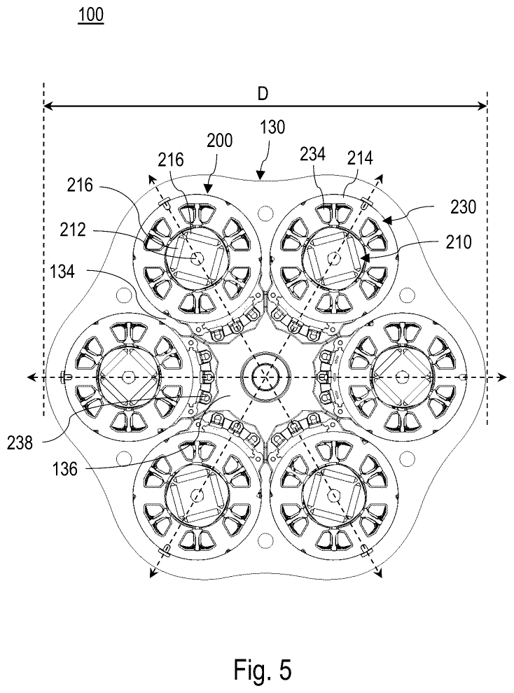

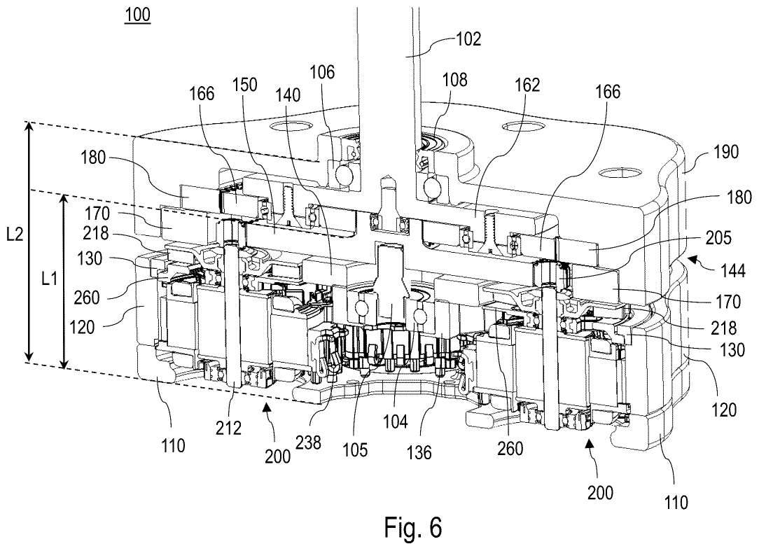

FIG. 3 depicts an exploded view of the multi-motor drive unit 100, according to an embodiment. FIG. 4 depicts another exploded view of the multi-motor drive unit 100, according to an embodiment. FIG. 5 depicts an axial cross-section view of the multi-motor drive unit 100, according to an embodiment. FIG. 6 depicts a side cross-section of the multi-motor drive unit 100, according to an embodiment.

As shown in these figures, in addition to motors 200, rear cover 110, and front cover 190, drive unit 100 includes a sleeve 120 disposed around the motors 200, a motor adapter 130 that supports front portions of the motors 200 and pilots a master bearing 104, a spacer 140 that baffles the motor fans, a master gear 150 that is driven by the motors 200 and piloted to the master bearing 104 via a pilot pin 105, a planet gear and carrier assembly 160 provided for gear reduction, a ring gear mount 170, and a ring gear 180 for engaging the planet gears. In an embodiment, a series of fasteners 198 are received through one of the front cover 190 or the rear cover 110, passed through corresponding through-holes of the aforementioned components, and securely fastened into the other of the rear cover 110 or the front cover 190 to complete the drive unit 100 assembly. These components are described in detail with continued reference to FIGS. 3-6 throughout this disclosure.

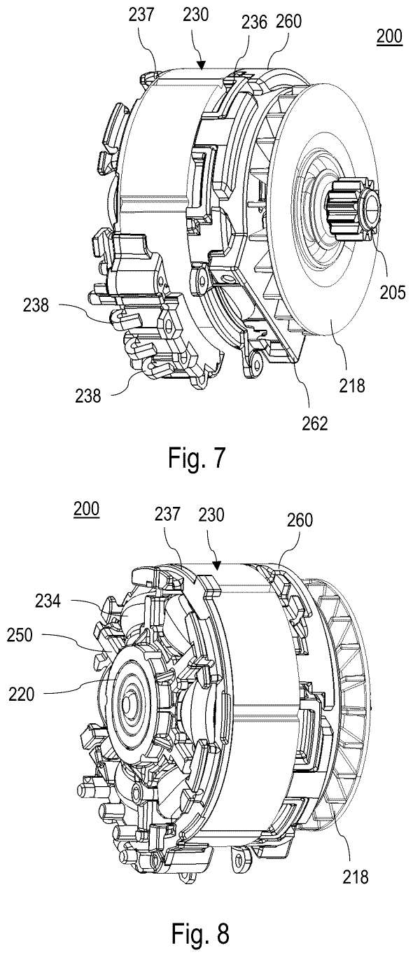

The BLDC motor 200 construction is initially described herein with reference to FIGS. 7-9.

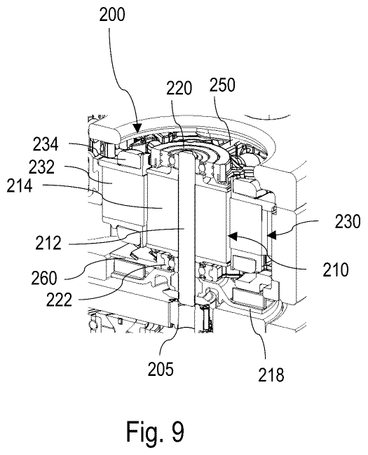

FIGS. 7 and 8 depict perspective rear and front views of a single BLDC motor 200 of the multi-motor drive unit 100, according to an embodiment. FIG. 9 depicts a partial side cross-section view of the multi-motor drive unit 100 showing the cross-section of one BLDC motor 200, according to an embodiment.

In an embodiment, BLDC motor 200 is a three-phase BLDC motor having a rotor assembly 210 rotatably received within a stator assembly 230.

In an embodiment, rotor assembly 210 includes a rotor shaft 212, a rotor lamination stack 214 mounted on and rotatably attached to the rotor shaft 212, and rear and front bearings 220, 222 arranged to support and pilot the rotor shaft 212. In an embodiment, rear and front bearings 220 and 222 provides radial and/or axial support for the rotor shaft 212 to securely position the rotor assembly 210 within the stator assembly 230.

In various implementations, the rotor lamination stack 214 can include a series of flat laminations attached together via, for example, an interlock mechanical, an adhesive, an overmold, etc., that house or hold two or more permanent magnets (PMs) 216 therein. The permanent magnets 216 may be surface mounted on the outer surface of the lamination stack 214 or embedded therein. The permanent magnets 216 may be, for example, a set of four PMs that magnetically engage with the stator assembly 210 during operation. Adjacent PMs have opposite polarities such that the four PMs have, for example, an N-S-N-S polar arrangement. The rotor shaft 210 is securely fixed inside the rotor lamination stack 214. In an embodiment, the rotor permanent magnets 216 may be made, fully or partially, of rare earth material to achieve maximum performance. Alternatively, the permanent magnets 216 may be made of less expensive ferrite materials. Due to construction and efficiency advantages of the drive unit 100 described in this application, the motors 200 operating together are capable of outputting total maximum power that is at least comparable to power output of a conventional motor of a comparable size built with rare earth permanent magnets.

In an embodiment, a fan 218 is mounted on and rotatably attached to a distal end of the rotor shaft 212. Fan 218 rotates with the rotor shaft 212 to cool the motor 200, particularly the stator assembly 230. In an embodiment, a pinion 205 may be disposed on the other distal end of the shaft 212 for driving engagement with the gear system described in detail later.

According to an embodiment, stator assembly 230 includes a generally cylindrical lamination stack 232 having a center bore configured to receive the rotor assembly 210. Stator lamination stack 232 includes a plurality of stator teeth extending inwardly from the cylindrical body of the lamination stack 232 towards the center bore. The stator teeth define a plurality of slots therebetween. A plurality of stator windings 234 are wound around the stator teeth. The stator windings 234 may be coupled and configured in a variety of configurations, e.g., series-delta, series-wye, parallel-delta, or parallel-wye. The stator windings 234 are electrically coupled to motor terminals 238. Motor terminals 238 are mounted on the outer surface of the stator lamination stack 232 via an insulating mount. Motor terminals 238 are coupled to a power switch inverter circuit on one end as described later in detail, and to the stator winding 234 on the other end. The inverter circuit energizes the coil windings 234 using a desired commutation scheme. In an embodiment, three motor terminals 238 are provided to electrically power the three phases of the motor 200. For details of the structure and configuration of the motor terminals 238, reference is made to U.S. Pat. No. 9,819,241, which is incorporated herein by reference in its entirety.

In an embodiment, front and end insulators 236 and 237 may be provided on the end surfaces of the stator lamination stack 232 to insulate the lamination stack 232 from the stator windings 234. The end insulators 236 and 237 may be shaped to be received at the two ends of the stator lamination stack 232. In an embodiment, each insulator 236 and 237 includes a radial plane that mates with the end surfaces of the stator lamination stack 232. The radial plane includes teeth and slots corresponding to the stator teeth and stator slots. The radial plane further includes axial walls that penetrate inside the stator slots. The end insulators 236 and 237 thus cover and insulates the ends of the stator teeth from the stator windings 234.

According to an embodiment, motor 200 additionally includes two bearing support members 250 and 260 formed as motor caps disposed at and secured to the two ends of the stator assembly 230. The bearing support members 250 and 260 provide structural support for the rear and front bearings 220 and 222 relative to the stator assembly 230. In an embodiment, one or both of the bearing support members 250 and 260 are piloted to stator slots and/or the end insulators 236 and 237. For details of the structure and configuration of the bearing support structures, reference is made to U.S. Pat. No. 10,587,163, which is incorporated herein by reference in its entirety.

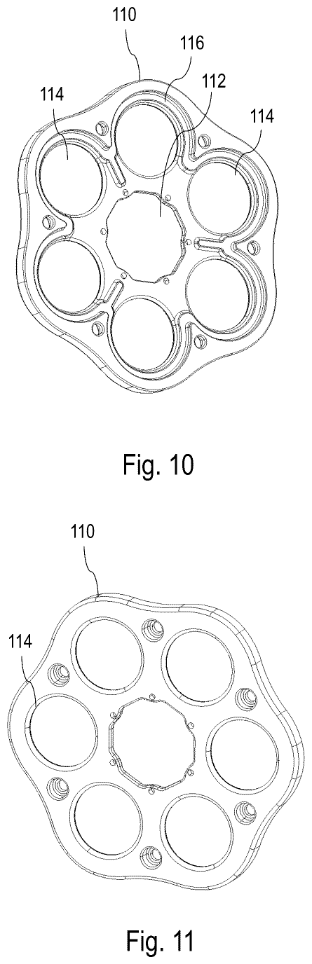

Other components of the drive unit 100 are now described with reference to FIGS. 10-25.

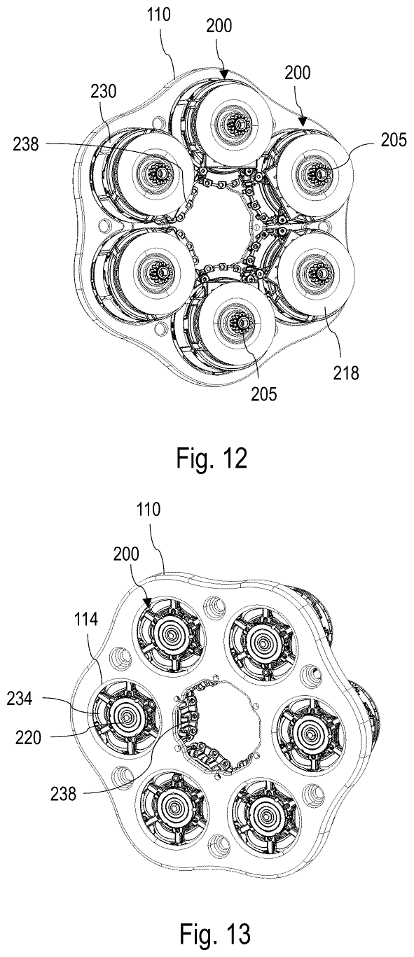

FIGS. 10 and 11 depict perspective rear and front views of the rear cover 110, according to an embodiment. FIGS. 12 and 13 depict perspective rear and front views of the plurality of BLDC motors 200 mounted on the rear cover 110, according to an embodiment;

As shown in FIGS. 10-13, and with continued reference to FIGS. 3-6, in an embodiment, rear cover 110 provides a mounting structure for initial mounting and securement of the motors 200. In an embodiment, rear cover 110 includes main planar body having a center opening 112 and a series of air intakes 114 disposed equidistantly around the center opening 112. Motors 200 are mounted on the air intakes 114, which also may be referred to as peripheral openings. In an embodiment, a rear part of each motor stator 230 is mounted onto the periphery of the respective air intake 114, with rear ends of stator windings 234 being exposed through the air intake 114 to receive airflow needed to cool the motor 200. In an embodiment, motor fans 218 are positioned away from the air intakes 114 to generate the airflow through air intakes 114 into the motors 200.

In an embodiment, a front face of the rear cover 110 includes a mounting portion 116 extending around at least a portion of the circumference of the plurality of air intakes 114. In an embodiment, the rear end insulators 237 of the motor stators 230 are mounted on the mounting portions 116. In an embodiment, the front face of the rear cover 110 further includes a boundary portion 118 that engages with at least portions of the outer surfaces of the stators 230 to securely to provide structure support for the motors 200 in their mounted positions. In an embodiment, air intakes 114 are sized such that a diameter of each the stator 230 is greater than a diameter of the respective air intake 114, and the stator windings 234 of each motor 200 are located within a cylindrical envelope formed by the respective air intake 114.

In an embodiment, motors 200 are oriented such that terminals 238 of each motor are located radially inward of the stator 230 in the direction of a center axis of the center opening 112. In an embodiment, terminals 238 are located radially inward of the circumference of the center opening 112 for easy access and soldering of the power wires (not shown) to the terminals 238. In an embodiment, rear tabs of the terminals 238 to which the power wires are soldered are located adjacent the center opening 112.

As best shown in FIG. 5, in an embodiment, the six rotors 210 are oriented in the same alignment angle relative to the stators 230. Specifically, in a default position of the drive unit 100, a radial line passing through the center of opposing stator teeth coincides with a line passing between ends of the adjacent permanent magnets 216.

Alternative embodiments of rear cover 110 are within the scope of this disclosure. In an embodiment, rear cover 110 may include a structure for supporting the rear bearings 220 of each motor. Specifically, the motors 200 may be configured to pilot and support the rear bearing 220 to the rear cover 110 rather than the individual stators. Further, in an embodiment, the rear cover 110 may include posts, walls, or other retention features for mounting and supporting the motors 200.

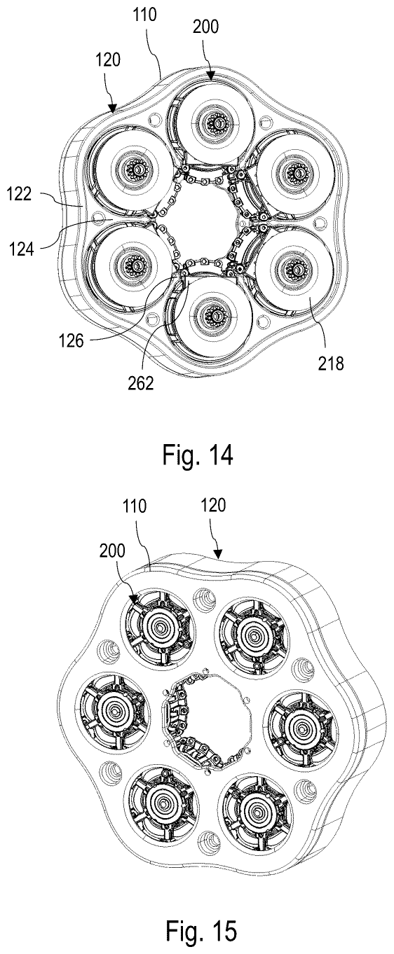

FIGS. 14 and 15 depict perspective rear and front views of the sleeve 120 additionally mounted on the rear cover 110, according to an embodiment.

As shown here, and with continued reference to FIGS. 3-6, in an embodiment, sleeve 120 is provided to surround the motors 200, and in an optional embodiment, it includes appropriate material and features to create a substantially water-sealed enclosure around the motors 200. In an embodiment, sleeve 120 includes an outer body 122 having substantially the same profile as the outer periphery of the rear cover 110 and extending around the motors 200, and a series of arms 124 extending radially inwardly in the spaces between the motors 200. In an embodiment, inner tips 126 of the arms 124 include side bumps that engage a portion of the motor 200 (e.g., a non-circular portion 262 of the front bearing support member 260—see FIG. 7) to radially align and secure the motor 200. In an embodiment, a front face of the sleeve 120 is aligned with the front end insulator 236 or the front bearing support member 260 of the motors 200, but rearward of the fans 218 to allow airflow generated by the fans 218 to exit radially from the motors 218.

In an embodiment, sleeve 120 may be of sized in accordance with the axial length of the motors 200 (or length of the stator lamination stack). In an embodiment, the length of the sleeve 120 may be constructed in accordance to the length of the motors 200, while the remaining components of the drive unit 100 are sized irrespective of the length of the motors 200.

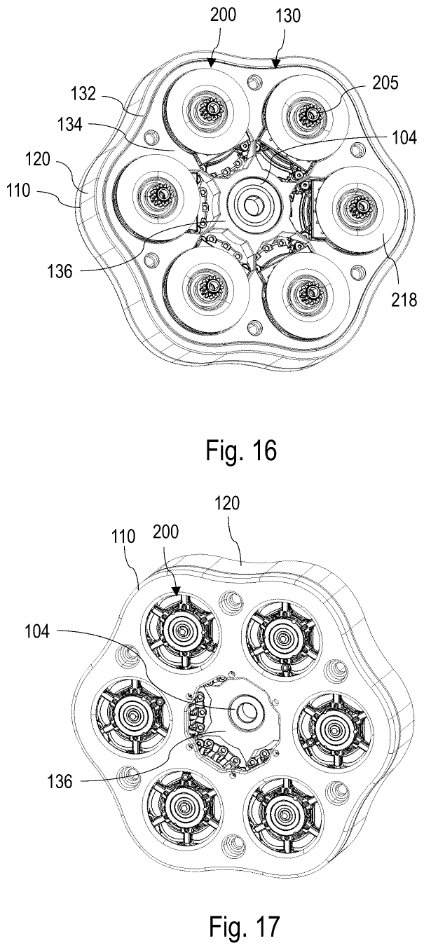

FIGS. 16 and 17 depict perspective rear and front views of motor adapter 130 mounted on a front face of the sleeve 120, according to an embodiment.

As shown here, and with continued reference to FIGS. 3-6, in an embodiment, motor adapter 130 is configured to interlock with the sleeve 120 and the front bearing support members 260 of the motors 200. In an embodiment, motor adapter 130 includes an outer body 132 having substantially the same profile as the outer periphery of the sleeve 120, and a series of arms 134 extending radially inwardly in the spaces between the motors 200 in interlocking contact with the front bearing support members 260. In this manner, the motor adapter 130 pilots and supports front ends of the motors 200 both rotationally and radially. In an embodiment, motor adapter 130 further includes a center bearing support member 136 coupled to inner ends of the arms 134 and designated to hold and support a master bearing 104. As discussed below, the master bearing 104 pilots and supports the master gear 150. In this manner, the motor adapter 130 locates and supports the master gear 150 relative to the motors 200, allowing the pinions 205 to properly mesh with the master gear 150 and thus transfer torque from the motors 200 to the master gear 150.

Alternative embodiments of motor adapter 130 are within the scope of this disclosure. In an embodiment, motor adapter 130 may include a structure for supporting the front bearings 222 of each motor directly rather than via intermediary bearing support structures of the motors. For example, front bearing 222 of each motor 200 may be mounted forward of the fan 218 adjacent the pinion 205, and the motor adapter 130 may include bearing support pockets to receive and support the front bearing 222.

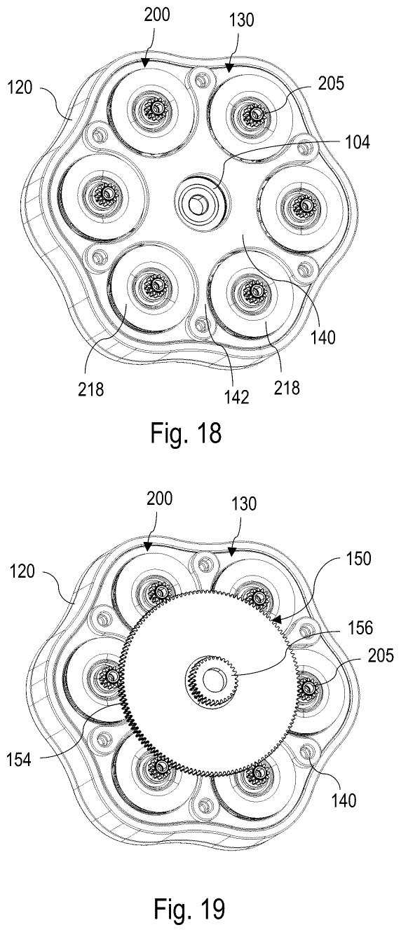

FIG. 18 depicts a perspective front view of the spacer 140 mounted on a front face of the motor adapter 130, according to an embodiment

As shown here, and with continued reference to FIGS. 3-6, in an embodiment, the spacer 140 occupies the space between the motor adapter 130 and the master gear 150. In an embodiment, the spacer 140 includes a series of outwardly-projecting arms 142 that radially extend between the motor fans 218 and circumferentially surround inner peripheries of the motor fans 218. In this manner, the spacer 140 is a baffle that exhausts the airflow generated by the motor fans 218 along generally-radial directions away from the drive unit 100. As will be described later, and shown in FIGS. 1 and 2, the spacer 140 creates a circumferential exhaust port 144 extending around the drive unit 100 in alignment with the motor fans 218.

In an alternative embodiment, the spacer 140 may be replaced with a fan secured to the master gear 150 that generates an airflow through the entire drive unit 100.

FIG. 19 depicts a perspective front view of the master gear 150 mounted in engagement with output pinions 205 of the BLDC motors 200, according to an embodiment.

As shown here, and with continued reference to FIGS. 3-6, in an embodiment, master gear 150 is piloted to the master bearing 104 via pilot pin 105. Pilot pin 105 is press-fitted into a rear opening 152 of the master gear 150 on one end and within the inner race of the master bearing 104 on another end. In an embodiment, master gear 150 includes a first sun gear 154 that meshes with the pinions 205 of the motors 200, and a second sun gear 156, that is coaxial with the first sun gear 154 but includes a smaller diameter, and transmits torque to planet gear and carrier assembly 160. In an embodiment, master gear 150 and the pinions 205 provides approximately a 10:15:1 gear reduction. In an example, where motors 200 run in unison at an output speed of 30,000 RPM, the output speed of the master gear 150 is at 3,000 RPM. Those skilled in the art will understand that the gear reduction ratio may be adjusted as desired by modifying the diameter of the pinions 205 and the master gear 150.

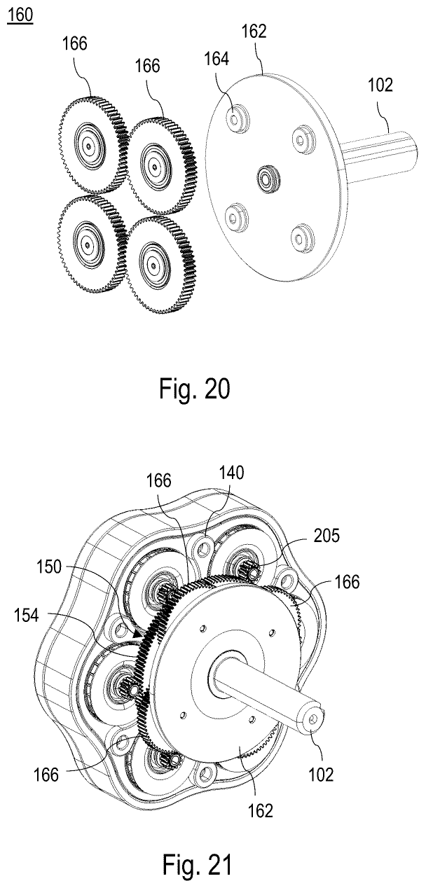

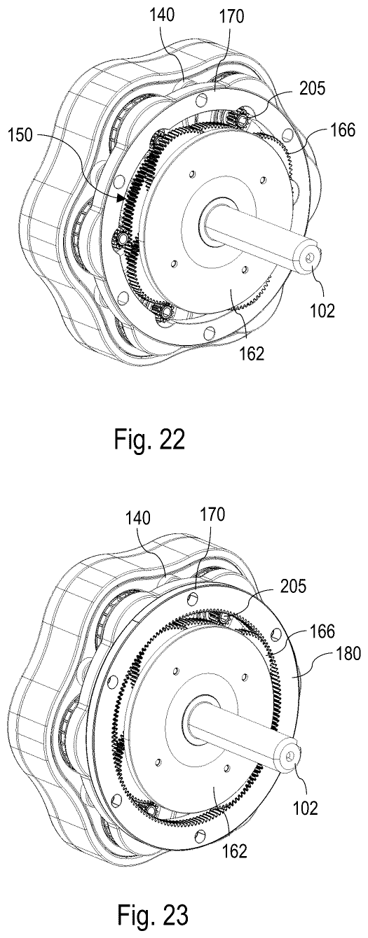

FIG. 20 depict a perspective rear exploded view of a planet gear and carrier assembly 160, according to an embodiment. FIG. 21 depicts a perspective front view of the planet gear and carrier assembly 160 mounted in driving engagement with the master gear 150, according to an embodiment. FIG. 22 depicts a perspective front view of the ring gear mount 170 mounted in engagement with a front face of the spacer 140, according to an embodiment. FIG. 23 depicts a perspective front view of the ring gear 180 mounted in engagement with a front face of the ring gear mount 170 in engagement with the planet gear and carrier assembly 160, according to an embodiment.

As shown here, and with continued reference to FIGS. 3-6, in an embodiment, planet gear and carrier assembly 160 is optionally provided for further gear reduction. In an embodiment, planet gear and carrier assembly 160 includes a carrier 162 drivable coupled to the output shaft 102 and including four gear posts 164 on its rear side equidistantly from the center axis. In an embodiment, four planet gears 166 are mounted on the gear posts 164. In an embodiment, second sun gear 156 is centrally received and meshed with the planet gears 166.

In an embodiment, ring gear mount 170 is secured to the spacer 140 to provide a secure mounting platform for the ring gear 180 relative to the drive unit 100. In an embodiment, ring gear 180 is mounted in meshing contact with the plant gears 166. Ring gear 180 cooperates with the second sun gear 156 of the master gear 150 to cause orbital rotation of the planet gears 166 and rotatably drive the output shaft 102. In an embodiment, planet gear and carrier assembly 160 provides a further gear reduction of approximately 6:1. In an example, this arrangement reduces the output speed of the output shaft 102 from 3000 RPM output speed of the master gear 150 to approximately 650 RPM.

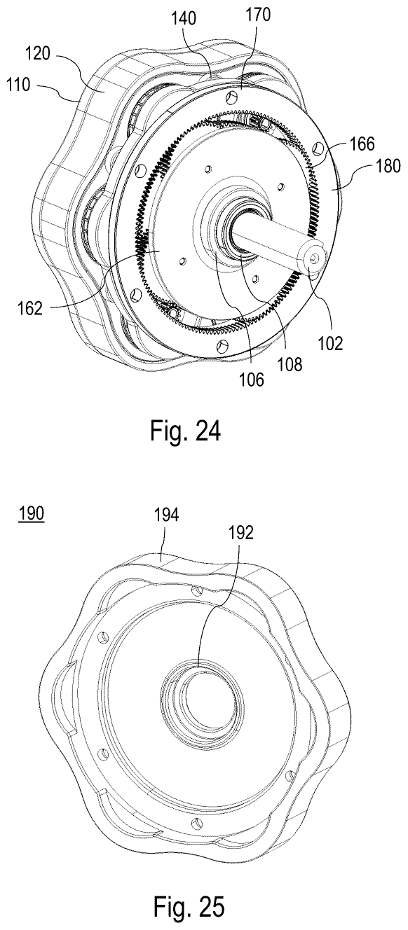

FIG. 24 depicts a perspective front view of a output bearing 106 and a bearing seal 108 mounted on the output shaft 102, according to an embodiment. FIG. 25 depicts a perspective rear view of a front cover 190, according to an embodiment.

As shown here, and with continued reference to FIGS. 3-6, in an embodiment, output bearing 106 cooperates with the master bearing 104, the pilot pin 105, the master gear 150, and the planet gear and carrier assembly 160, to pilot and rotatably support the output shaft 102 relative to the drive unit 100. In an embodiment, the output bearing 106 is mounted on the output shaft 102 adjacent a front face of the carrier 162 and received within a center opening 192 of the front cover 190 for radial and axis constraint. In an embodiment, the bearing seal 108 is optionally provide within the center opening 192 to substantially water-seal the area around the output bearing 106 from ingress of water and contaminate particles.

In an embodiment, the front cover 190 provides a housing for the transmission components including the master gear 150, the planet gear and carrier assembly 160, the ring gear mount 170, and the ring gear 180. In an embodiment, the front cover 190 includes a main planar body that includes the center opening 192 therein, and an outer body 194 having substantially the same profile as the outer periphery of the rear cover 110 and the sleeve 120 that extends around the transmission components.

In an embodiment, the rear end of the outer body 194 is substantially aligned with the rear end of the ring gear mount 170 to form the circumferential exhaust port 144 between the front cover 190 and the sleeve 120. In an alternative embodiment, the rear end of the outer body 194 mates with the sleeve 120 to form a full enclosure around the drive unit 100 components.

In an embodiment, a sealing partition wall (not shown) may be provided within the drive unit 100 in contact with the rear end of the outer body 194 to partition and fully the transmission components from the motors 200. In this embodiment, lubricant material such as oil may be introduced within a partitioned compartment formed by the front cover 190 and the sealing partition wall to lubricate the transmission components and reduce heat and friction losses associated with the transmission components. In yet another embodiment, where the drive unit 100 is fully enclosed, sealing components may be provided to seal any opening between mating surfaces of the front cover 190, the sleeve 120, the rear cover 110, and any openings thereof. This arrangement allows lubricant material to be introduced throughout the drive unit 100 to reduce heat and friction losses associated with the motors 200 as well as the transmission components.

In an embodiment, the motors 200 may be of substantially equal size and output power. In an example, each motor 200 has an outer diameter that is in the range of approximately 45 mm to 57 mm, preferably approximately 48 mm to 54 mm. In an embodiment, the length of the stator lamination stack 232 of each motor may be in the range of approximately 7 mm to 40 mm depending on the power output requirements. One of ordinary skill in the art would recognize that the motor output power is approximately linearly proportional to the length of the lamination stack.

Referring to FIG. 5, drive unit 100 includes an outer diameter D that is in the range of approximately 150 mm to 182 mm, preferably approximately 156 mm to 176 mm, more preferably approximately 162 mm to 170 mm. The arrangement of the motors 200 in a circular array around the center axis increases the effective torque generating boundary of the motors 200 collectively. Specifically, in comparison with a conventional inner-rotor motor with comparable outer diameter, the electro-magnetic boundary (i.e., the boundary area between the outer circumference of the rotor and the inner circumference of the stator) is approximately in the range of 275 mm to 305 mm. Also, in comparison with a conventional outer-rotor motor with a comparable outer diameter, the electro-magnetic boundary (i.e., the boundary area between the inner circumference of the rotor and the outer circumference of the stator) is approximately in the range of 340 mm to 370 mm. By contrast, the electro-magnetic boundary of the drive unit 100 (i.e., the sum of the boundary areas of the individual motors) with the diameter ranges stated above is in the range of approximately 440 mm to 520 mm, preferably in the range of 455 mm to 505 mm, more preferably in the range of approximately 470 mm to 490 mm. This improvement represents an increase in the electro-magnetic boundary of between 60% to 70% compared to the comparably-sized inner-rotor motor and between 30% to 40% compared to the comparably-sized outer-rotor motor. This increase in the electro-magnetic boundary consequently results in a similar increase in the motor power output performance.

Referring to FIG. 6, drive unit 100 includes an axial length L1, as measured from a rear surface of the rear cover 110 to a front surface of the master gear 150, that is approximately in the range of approximately 30 mm to 60 mm depending on the length of the motor stators. An axial length L2 of the drive unit 100, as measured from the rear surface of the rear cover 110 to a front surface of the front cover 190, that is approximately in the range of approximately 45 mm to 75 mm depending on the length of the motor stators, and encompasses the transmission components.

Based on these size parameters, drive unit 100 is capable of outputting a maximum power output, as determined in a step test, that exceeds 6100 watts when using one or more 20V max power tool battery packs (e.g., six 9 Ah 20V battery packs in parallel), and exceeds 8500 watts when using one or more 60V max power tool battery pack (e.g., six 9 Ah 60V max battery packs in parallel). This improvement represents as significant higher power density in comparison to comparably-sized conventional inner-rotor and outer-rotor motors. Table 1 below summarizes these findings.

TABLE 1

| | Conventional | Conventional | | |
|---|---|---|---|---|
| | Outer-Rotor | Inner-Rotor | Drive | Drive |
| | Motor | Motor | Unit 100 | Unit 100 |
| Motor | (60 V) | (60 V) | (60 V) | (20 V) |
| Diameter (mm) | 163 | 182 | 166 | 166 |
| Axial Length (mm) | 96 | 60 | 52 | 52 |
| Avg. Phase | 25 | 51 | 10 | 3.4 |
| Resistance (mOhm) | | | | |
| Max Power Output | 3,950 | 5,700 | 8,550 | 6,100 |
| (W) | | | | |
| Max Power/Volume | 1.98 | 3.67 | 7.67 | 5.47 |
| (W/CM\hat{ }3) | | | | |

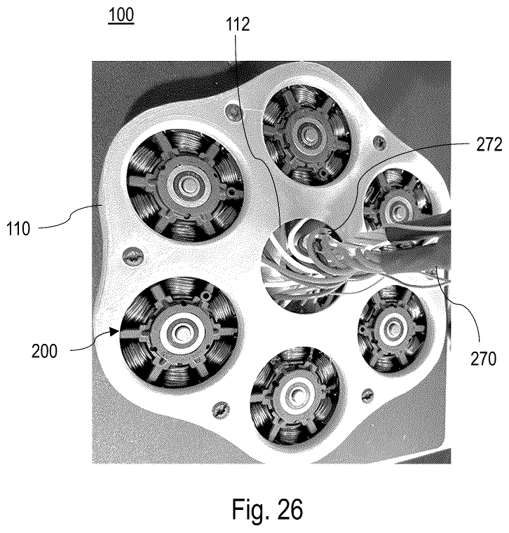

FIG. 26 depicts a rear perspective view of the multi-motor drive unit 100 including wiring connections 270 for powering the BLDC motors 200, according to an embodiment. In an embodiment, as shown here, the wiring connections 270 are received through the center opening 112 of the rear cover 110 and electrically coupled (e.g., via soldering or welding) to motor terminals 238. In an embodiment, three wiring connections 270 are provided (e.g., corresponding to U, V and W phases of the motor), each carrying six wires 272 that are coupled to respective motor terminals 238 of the six motors 200.

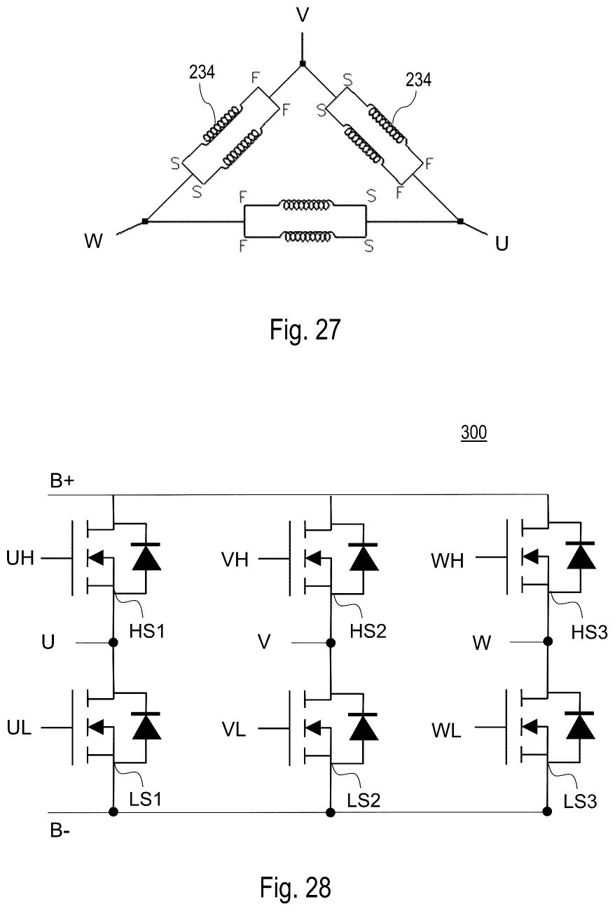

FIG. 27 depicts a simple circuit diagram of a delta-parallel motor configuration of a single BLDC motor 200, according to an embodiment. As described above, stator windings 234 may be coupled and configured in a variety of configurations, including series-delta, series-wye, parallel-delta, or parallel-wye. In this example, the stator windings 234 of each motor 200 are connected in a delta-parallel configuration. U, V and W terminals in this figure are coupled to the three motor terminals 238. In an embodiment, the interconnections discussed above may be made on the same connecting terminals using a printed circuit board (PCB) instead of sets of wires.

FIG. 28 depicts a simple circuit diagram of an inverter circuit 300 for driving the single BLDC motor 200, according to an embodiment. As shown herein, the inverter circuit 300 is a three-phase inverter bridge circuit that includes a series of power switches, in this example, three high-side Field-Effect Transistors (FETs) HS1-HS3 and three low-side FETs LS1-LS3. It should be understood that other types of power switches, such as IGBTs, BJTs, etc. may be alternatively utilized. The gates of the high-side FETs are driven via drive signals UH, VH, and WH, and the gates of the low-side FETs are driven via drive signals UL, VL, and WL. As will be discussed, these drive signals are supplied to the inverter circuit 300 in a controlled fashion by a controller and gate driver circuit. In an embodiment, the drains of the high-side FETs are coupled to the sources of the low-side FETs to output power signals U, V, and W. As discussed above, these power signals are coupled via wiring connections 270 to the motor terminals 238 for driving the motor 200.

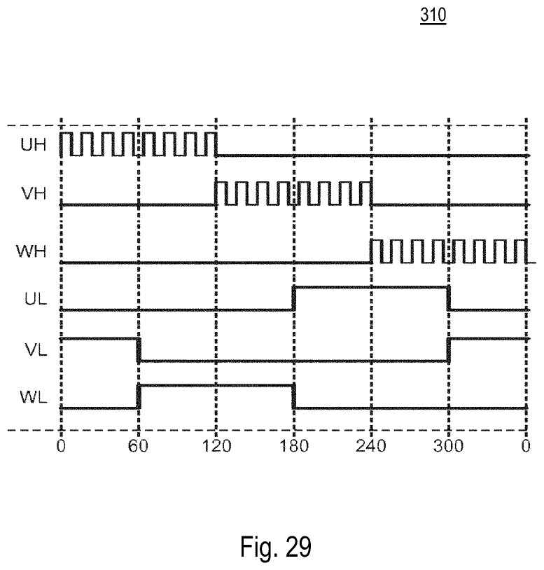

FIG. 29 depicts a simple voltage waveform diagram 310 of drive signals for driving the single BLDC motor 200, according to an embodiment. Specifically, waveform diagram 310 shows a pulse-width modulation (PWM) drive sequence of the inverter circuit 300 within a full 360 degree conduction cycle. As shown in this figure, within a full 360° cycle, each of the drive signals associated with the high-side and low-side power switches is activated during a 120° conduction band (“CB”). In this manner, each associated phase of the motor 200 is energized within a 120° C. B by a pulse-width modulated voltage waveform that is controlled by the control unit 208 as a function of the desired motor 28 rotational speed. For each phase, the high-side switch is pulse-width modulated by controller within a 120° C. B. During the CB of the high-side switch, the corresponding low-side switch is kept low, but one of the other low-side switches is kept high to provide a current path between the power supply and the motor windings. The controller controls the amount of voltage provided to the motor, and thus the speed of the motor, by controlling the PWM duty cycle of the high-side switches.

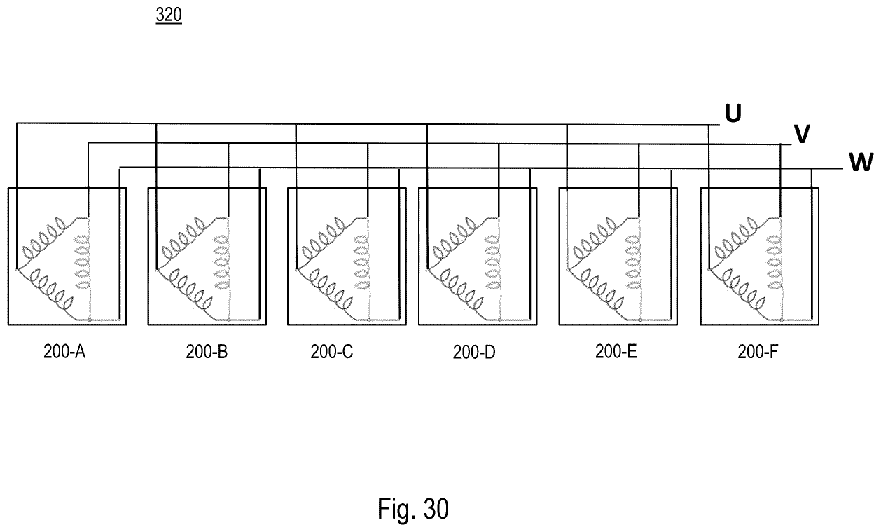

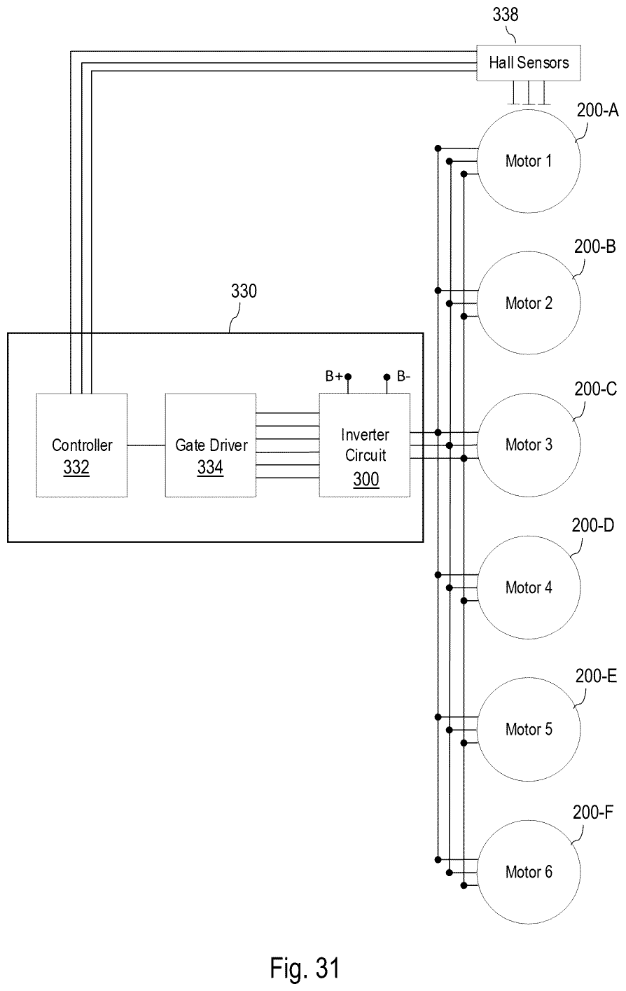

FIG. 30 depicts a simple circuit diagram 320 of wiring connections for powering the motors 200 (in this diagram sequentially labeled 200-A through 200-F) of the drive unit 100, according to an embodiment. In an embodiment, each of the U, V and W drive power lines is coupled to the six motors 200-A through 200-F.

FIG. 31 depicts a simple block diagram of a motor control unit 330 for powering the motors 200-A through 200-F the multi-motor drive unit 100, according to an embodiment.

In an embodiment, motor control unit 330 includes the inverter circuit 300 discussion above arranged to receive electric power from a power source (e.g., a battery pack, designated by B+ and B-terminals). In an embodiment, motor control unit 330 additionally includes a controller 332 and a gate driver 334 that control the supply of power through the inverter circuit 300 from the power source by controlling the switching operation of the power switches HS1, HS2, HS3, LS1, LS2 and LS3 of the inverter circuit 300.

In an embodiment, controller 332 is a programmable device (e.g., a micro-controller, micro-processor, etc.) that controls the PWM and phase control of the motors 200 by applying a gate drive signal to the power switches of the inverter circuit 300. In an embodiment, in addition to controlling the switching operation of the inverter circuit 300, controller 332 handles all aspect of motor control, including, but not limited to, motor drive and commutation control (including controlling the switching operation of the inverter circuit 300 to control motor speed, forward/reverse drive, phase current limit, start-up control, electronic braking, etc.), motor stall detection (e.g., when motor suddenly decelerates or motor current rapidly rises), motor over-voltage detection and shutdown control, motor or module over-temperature detection and shutdown control, electronic clutching, and other control operations related to the motor.

In an embodiment, controller 332 receives rotor rotational position signals from a set of position sensors 338 provided in close proximity to the rotor of one of the motors 200. In an embodiment, position sensors 338 may be Hall sensors. It should be noted, however, that other types of positional sensors may be alternatively utilized. In an embodiment, each motor 200 may be equipped with internal positional sensors proximate the rotor with output terminals that can be wired and coupled to the controller 332. Alternatively, motors 200 do not include internal positional sensors, and the positional sensors are secured within the drive unit 100. In this embodiment, the positional sensors may be positioned in magnetic interface with the permanent magnets 216 of one of the motors 200, or with a sense magnet mounted on the master gear 150, the output shaft 102, or another rotary part of the drive unit 100.

In an embodiment, the controller 332 utilizes the positional signals from only one set of positional sensors 338 of one of the six motors. Since the six motor rotors are coupled to a single core and are driven in unison, the controller 332 can calculate the position of each rotor using the single set of positional sensors 338. This may be done where the rotors are fully synchronous and in phase with one another, as shown in FIG. 5, or where the phases of the motors are out of sync, as will be described later in detail. In an alternative embodiment, however, the controller 332 may receive positional signals from all or a subset of the motors 200.

In an alternative embodiment, controller 332 may be configured to calculate or detect rotational positional information relating to the motor rotor without any positional sensors (in what is known in the art as sensorless brushless motor control). Examples of sensorless motor control can be found in U.S. Pat. Nos. 11,469,697 and 11,171,586, both of which are incorporated herein by reference in their entireties. For example, the controller 332 may be configured to monitor a back-emf voltage of one of the motors 200 induced through the stator coils and determine the angular position of one of the motors 200 accordingly. The controller 332 can then use the determined angular position of one of the motors 200 to control the commutation of all of the motors 200. In another example, the controller 332 may be configured to measure a phase current of one of the motors 200 and determine the angular position of the rotor of the one motor. The controller 332 may use the information from the one motor to control the commutation of all of the motors 200.

In an embodiment, controller 332 may also receive a variable-speed signal from variable-speed actuator or a speed-dial, which allows an operator to control the output speed of the drive unit 100. Based on the rotor rotational position signals from the position sensors 338 and the variable-speed signal, controller 332 outputs drive signals UH, VH, WH, UL, VL, and WL through the gate driver 334. Gate driver 334 is provided to output a voltage level required to drive the gates of the semiconductor switches within the inverter circuit 300.

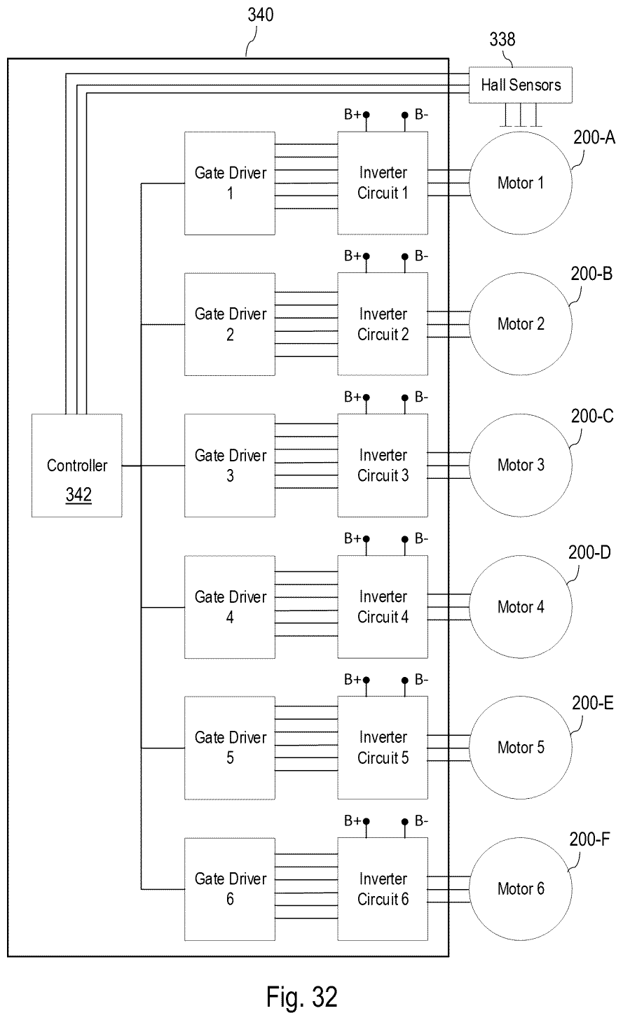

FIG. 32 depicts a simple block diagram of a motor control unit 340 for powering the BLDC motors of the multi-motor drive unit, according to an alternative embodiment. In this embodiment, motor control unit 340 includes a controller 342 that, similar to the above embodiment, received positional signals from position sensors 338 and controls the supply of power to the motors 200 accordingly. Unlike the previous embodiment, however, motor control unit 340 includes a designated inverter circuit and a corresponding gate driver for each motor 200A-F. This allows the controller 342 to drive each motor 200A-F individually.

In yet another embodiment, the drive unit 100 may include discrete motor control units, each including its own controller for driving a respective motor.

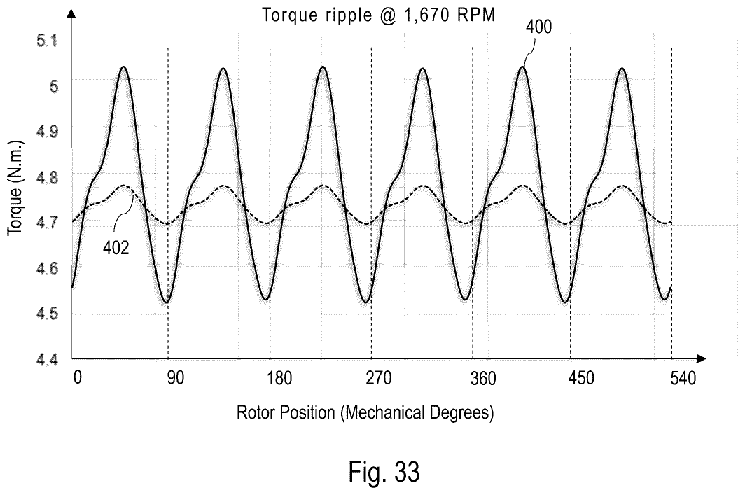

An aspect of the invention is described herein with reference to FIGS. 33-38.

FIG. 33 depicts a waveform diagram of the drive unit torque ripple curve 400 where the motors 200 of the drive unit 100 are driven full synchronously (herein referred to as the full sync phase shift drive scheme), according to an embodiment. Torque ripple curve 400 designates the torque ripple of an individual motor 200. Since the motors 200 are driven via common commutation drive signals, they exhibit simultaneous torque ripple curves 402. As shown in this figure, the torque ripple of the drive unit 100 equals the sum of the torque ripples 402 of the individual motors 200 and is significant. In this example, the torque ripple is approximately 0.5 N.m., representing approximately 10% of the peak torque.

To improve the torque ripple of the drive unit 100, according to an embodiment, the phases of the motors, including the mechanical angular orientation of the rotors and the drive signals applied to the motor, are sequentially shifted to distribute the torque ripples of the individual motors and obtain a smoother torque curve on the output of the drive unit 100. In this embodiment, the motor control unit 340 includes a designated inverter circuit for each of the motors 200, as exemplified in FIG. 32.

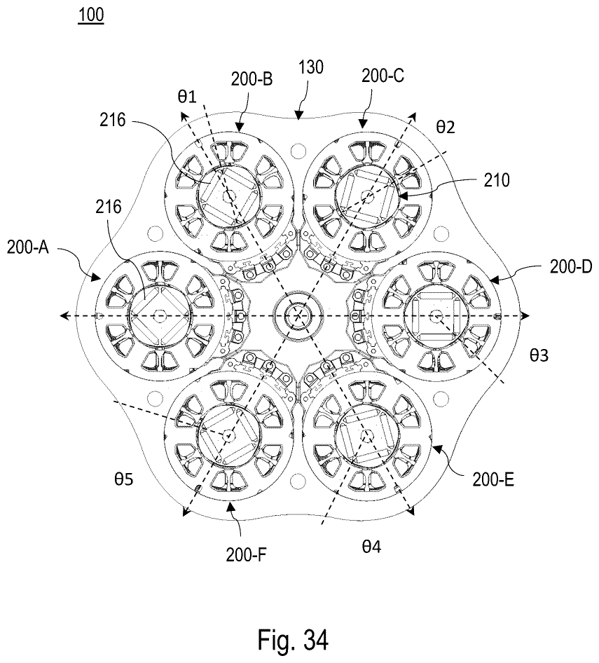

FIG. 34 depicts an axial cross-section view of the multi-motor drive unit 100 where the motors are sequentially oriented with a mechanical phase shift, according to an embodiment. As shown here, in an embodiment, in a default position of the drive unit 100, permanent magnets 216 of first motor 200-A are aligned with the stator assembly 230. In this example, a radial line passing through the center of opposing stator teeth coincides with a line passing between ends of the adjacent magnets 216. In an embodiment, orientation of the permanent magnets 216 of second motor 200-B is shifted by an angle θ1, which in this example is 15 degrees, relative to stator assembly 230. In this example, the radial line passing through center of opposing stator teeth forms an angle of 15 degrees with the line passing between ends of the adjacent magnets 216. Similarly, orientation of the permanent magnets 216 of third motor 200-C is shifted relative to the stator assembly 230 by an angle θ2, which in this example is 30 degrees; orientation of the permanent magnets 216 of fourth motor 200-D is shifted relative to the stator assembly 230 by an angle θ3, which in this example is 45 degrees; orientation of the permanent magnets 216 of fifth motor 200-E is shifted relative to the stator assembly 230 by an angle θ4, which in this example is 60 degrees; and orientation of the permanent magnets 216 of fifth motor 200-F is shifted relative to the stator assembly 230 by an angle θ5, which in this example is 75 degrees. This sequential mechanical shift in the rotor positions may be done during the assembly process, e.g., by properly rotating and interlocking the pinions 205 of the individual motors 200B-F on the master gear 150.

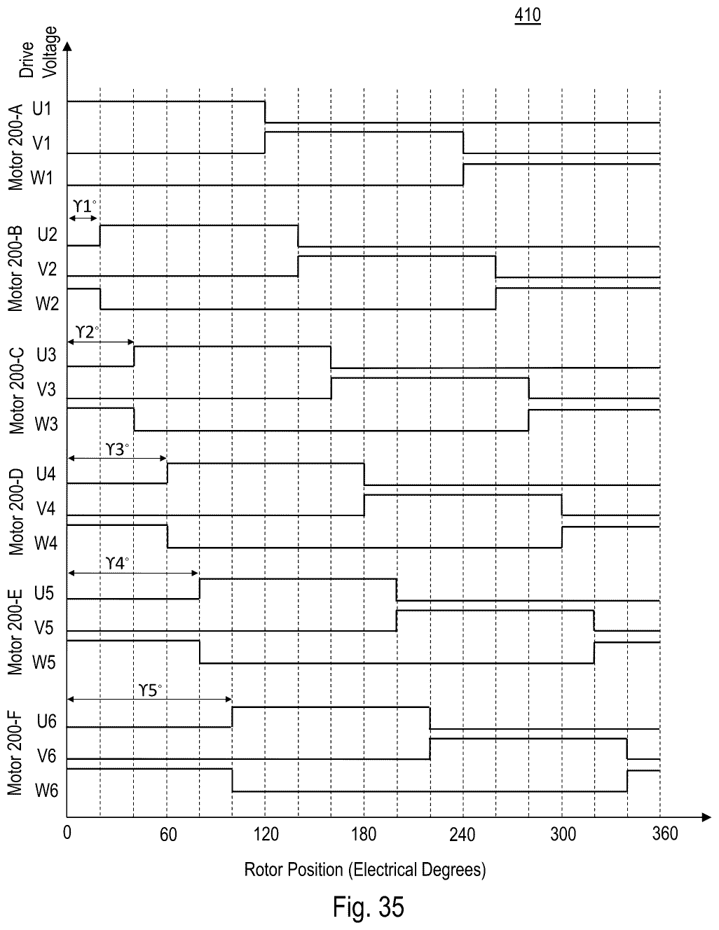

FIG. 35 depicts a simple voltage waveform diagram 410 of a phase-shift drive scheme applied to the motors 200A-F of FIG. 34 to reduce torque ripple, according to an embodiment. In an embodiment, relative to the commutation drive signals of first motor 200A, the commutation drive signals for motor 200-B are shifted by angle γ1, which in this example is 20 electrical degrees, corresponding to rotor mechanical shift angle θ1. Similarly, the commutation drive signals for motor 200-C are shifted by angle γ2, which in this example is 40 electrical degrees, corresponding to rotor mechanical shift angle θ2; the commutation drive signals for motor 200-D are shifted by angle γ3, which in this example is 60 electrical degrees, corresponding to rotor mechanical shift angle θ3; the commutation drive signals for motor 200-E are shifted by angle γ4, which in this example is 80 electrical degrees, corresponding to rotor mechanical shift angle θ4; and the commutation drive signals for motor 200-F are shifted by angle γ5, which in this example is 100 electrical degrees, corresponding to rotor mechanical shift angle θ5.

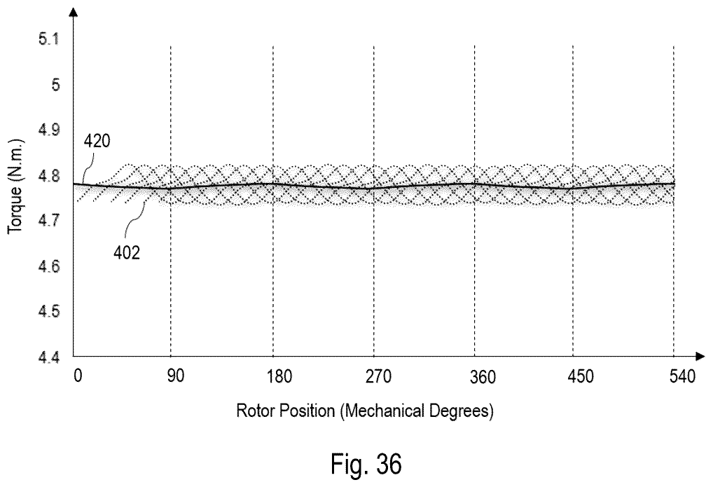

FIG. 36 depicts a waveform diagram of the drive unit torque ripple curve 420 using the above-described phase-shift drive scheme (herein referred to as the full split phase shift drive scheme), according to an embodiment. In an embodiment, by mechanically advancing the motors 200 in succession relative to one another and sequentially shifting the commutation drive signals of the motors, the torque ripple curves 402 associated with the individual motors become evenly distributed over 90 degree cycles, resulting in a significantly smoother torque ripple curve. Specifically, since the torque ripples of the individual motors are not in synch, the torque ripple curve 420 of the drive unit 100 as the sum of the torque ripple curves 402 of the individual motors becomes substantially close to zero.

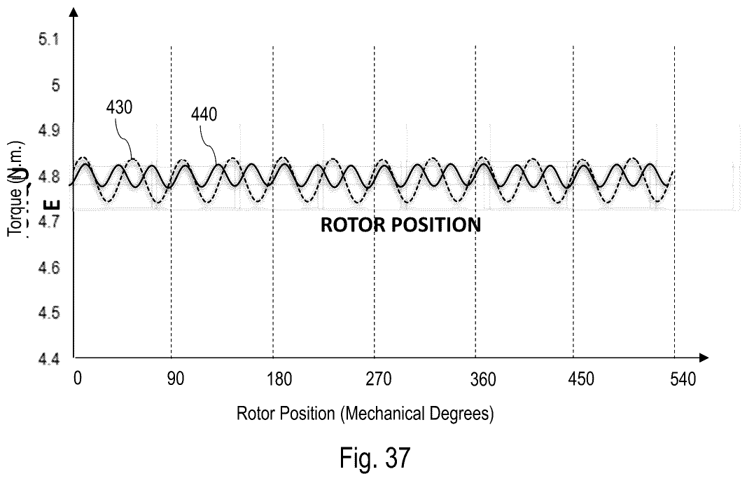

FIG. 37 depicts a waveform diagram of the drive unit torque ripple curves 430 and 440 where the phase-shift drive scheme is applied to the motors in groups, according to an embodiment. Torque ripple curve 430 represents the torque ripple where the motors are divided to two groups of three and the motors in each group are driven using common commutation drive signals (herein referred to as the half split phase shift drive scheme). The mechanical rotor orientations and commutation drive signals of one group are shifted by a predetermined angle, e.g., 45 degrees, relative to the other. Torque ripple curve 440 represents the torque ripple where the motors are divided to three groups of two and the motors in each group are driven using common commutation drive signals (herein referred to as the thirds split phase shift drive scheme). The mechanical rotor orientations and commutation drive signals of the three groups are sequentially shifted by predetermined angles, e.g., 30 degrees, relative to the other. Curves 430 and 440 represent significant torque ripple improvements compared to curve 400 of FIG. 33, but they are not as efficient as curve 420 of FIG. 36.

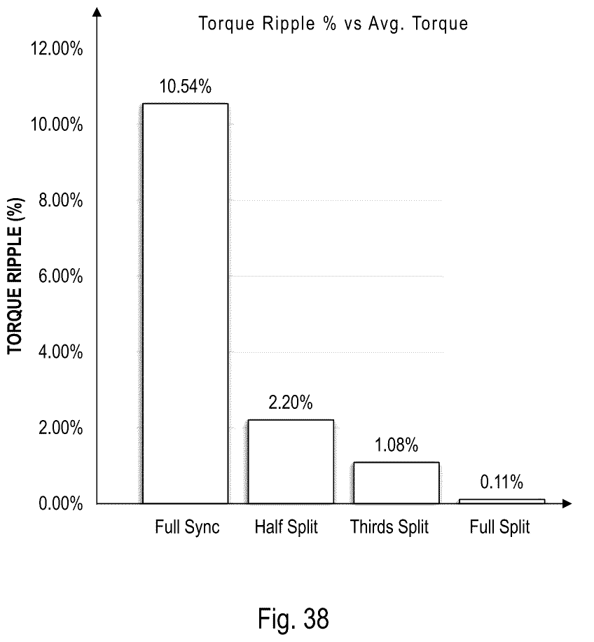

FIG. 38 depicts a chart showing the improvement in torque ripple resulting from the phase-shift drive scheme using full sync (i.e., curve 400), half split (i.e., curve 430), thirds split (i.e., curve 440), and full split (i.e., curve 420) phase shift drive schemes, according to an embodiment. As shown here, the half split drive scheme reduces the torque ripple from approximately 10.5% to approximately 2.2%. The thirds split drive scheme further reduces the torque ripple to approximately 1%. The full split phase-shift drive scheme reduces the torque ripple to approximately 0.1%.

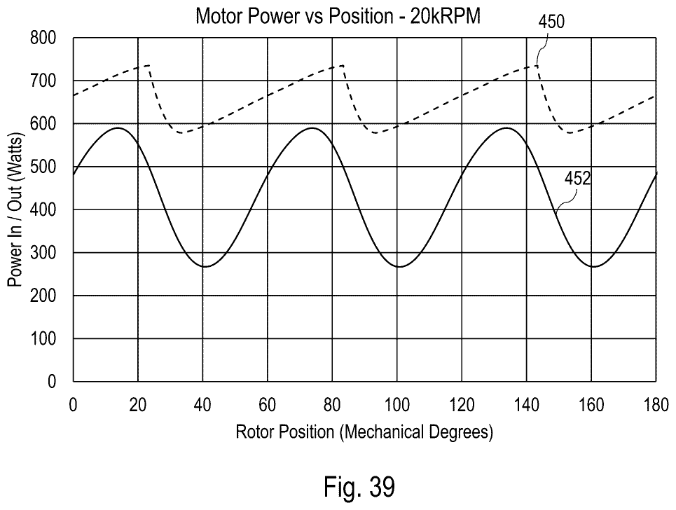

Another aspect of the invention is described herein with reference to FIGS. 39-43.

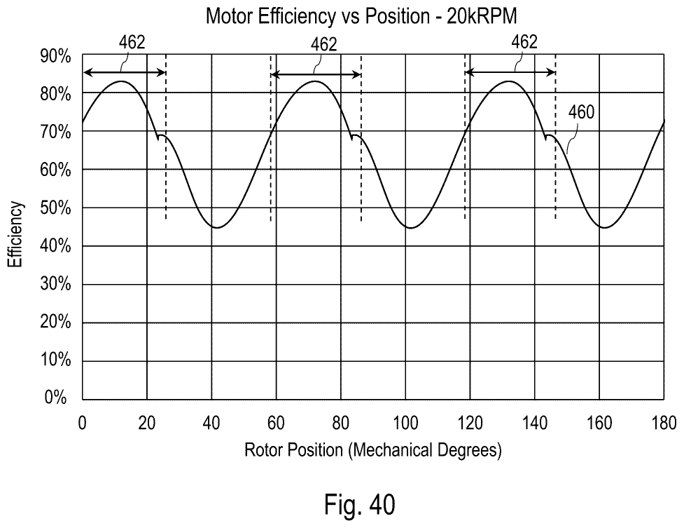

FIG. 39 depicts a power waveform diagram showing input power curve 450 and output power curve 452 of a single motor 200 within the drive unit 100, according to an embodiment. FIG. 40 depicts an efficiency waveform showing efficiency curve 460 of the single motor 200, according to an embodiment.

It is known that efficiency of a motor is calculated as a function of the output power divided by the input power. In the illustrated example, each motor 200 has a nearly sinusoidal efficiency curve that includes regions of maximum efficiency and regions of minimum efficiency ranging between approximately 92% to 55%. In the illustrated example of FIG. 40, the motor 200 has high efficiency zones 462 where the efficiency is greater than or equal to approximately 68%.

When the motors 200 are driven via common commutation drive signals, their efficiency curves align, and the efficiency of the drive unit 100 resembles the efficiency curve 460 of individual motors. In other words, the drive unit 100 operates at high efficiency zones less than 50% of the time.

When using the phase-shift drive scheme as described above, the efficiency curves of the motors is distributed and provides an improved efficiency curve, where the drive unit 100 operates at high efficiency zones more than 50% of the time. However, at any given time, some motors are operating in their high efficiency zones, others are operating in their low efficiency zones. This overall system efficiency is therefore diminished as a result of a subset of the motors operating in their low efficiency zones. What is needed and is addressed herein is a scheme that achieves optimum efficiency of the drive unit 100.

To achieve the optimum efficiency of the drive unit 100, according to an embodiment, each motor 200 is driven within a commutation band (i.e., conduction band or conduction angle) at or near its peak efficiency. Specifically, after implementing the rotor mechanical shift as described in FIG. 34, each motor is driven at or near its peak efficiency bandwidth for a sub-portion of a standard commutation band. In a multi-motor drive unit as described in this application, the commutation band for each motor may be divided to 1/n, where n designates the number of motors in the drive unit. Thus, in the exemplary embodiment utilizing six motors, each motor is commutated at 20 degrees of a full standard commutation band of 120 degrees. The motors 200 are sequentially commutated to achieve a full 120 degree commutation band.

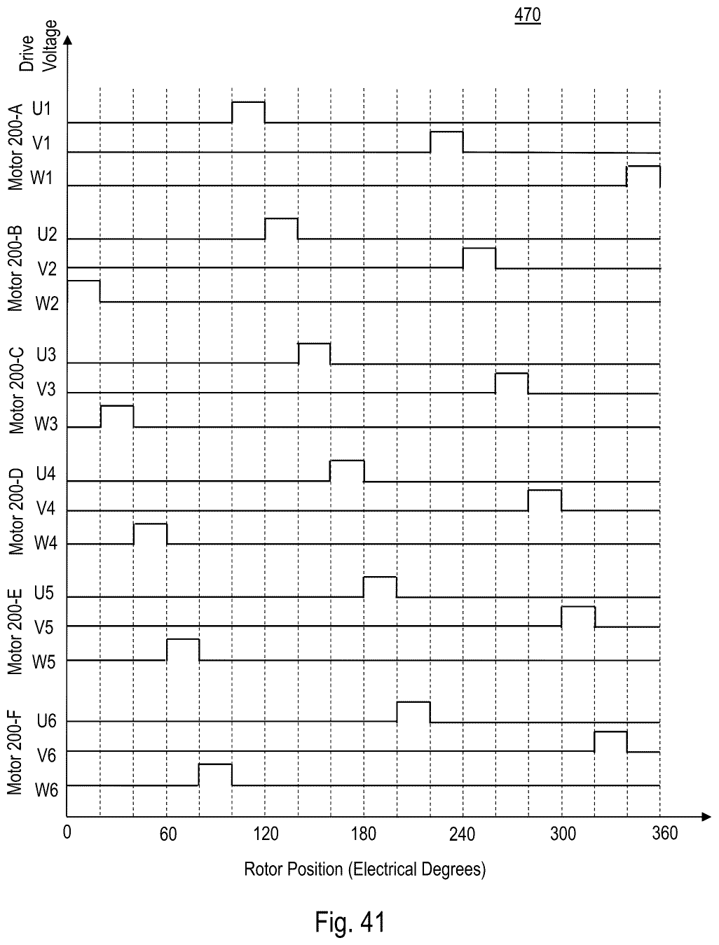

FIG. 41 depicts a simple voltage waveform diagram 470 of a reduced commutation band drive scheme applied to the motors 200A-F of FIG. 34 to increase system efficiency, according to an embodiment. This waveform diagram 460 is an example of a full split phase shift drive scheme, where all the motors are sequentially shifted. In an embodiment, the motors are sequentially commutated at 20 degree intervals, with falling each of a commutation band of one motor being substantially aligned with the rising edge of a commutation band of the next motor in the sequence. It was found that each motor achieves its optimal efficiency near the end of a standard commutation band. Thus, as compared to FIG. 35, each motor 200 is commutated for that last 20 degrees of its standard commutation band. Accordingly, U phases of motors 200A-F are sequentially commutated within electrical angles of 100 degrees to 220 degrees; V phases of motors 200A-F are sequentially commutated within electrical angles of 220 degrees to 340 degrees; and W phases of motors 200A-F are sequentially commutated within electrical angles of 340 degrees to 100 degrees of the next cycle.

Reducing the commutation band of each motor phase in the proposed matter does produce a lower net power and torque output and may not be desirable in applications where high power output is required. This is a tradeoff for achieving higher efficiency and reductions in thermal losses, core loss, switching losses, and improved eddy current dissipation. Specifically, since each motor is being commutated for a fraction of the time and at its peak efficiency, the effects of high frequency switching become less pronounced, eddy current have more time to naturally dissipate, stator windings have momentary drops in current, and rotor cores produce less heat with the lower frequency of flux change.

In an embodiment, controller 342 may be configured to run the motors in groups of two or three for a balanced approach between achieving high efficiency and high power. In an embodiment, as described above, the motors 200 are controlled in a thirds-split phase shift drive scheme, wherein the motors 200 are divided to three groups of two and the motors in each group are driven using common commutation drive signals. In an example, for each 120 degree standard conduction, motors 200-A, 200-C and 200-E are driven simultaneously for a 60 degree commutation band, followed by motors 200-B, 200-D and 200-F being simultaneously driven for the next 60 degree commutation band. Alternatively, the motors 200 are controlled in a half split phase shift drive scheme, wherein the motors are divided to two groups of three and the motors in each group are driven using common commutation drive signals. In an example, for each 120 degree standard conduction, motors 200-A and 200-D are driven simultaneously for an initial 40 degree commutation band, motors 200-B and 200-E are simultaneously driven for an intermediate 40 degree commutation band, and motors 200-C and 200-F are simultaneously driven for the final 40 degree commutation band.

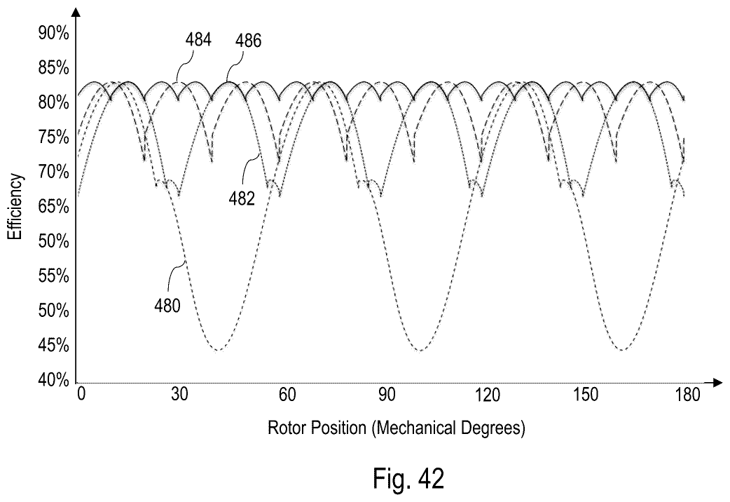

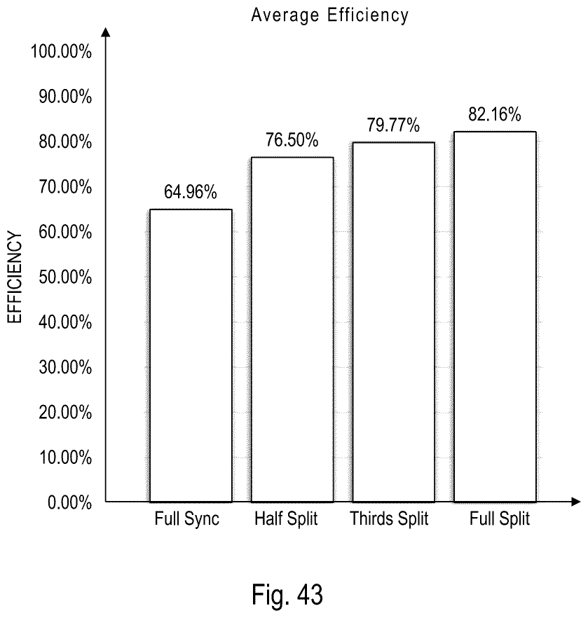

FIG. 42 depicts a waveform diagram of the drive unit efficiency curves 480-486 using the reduced commutation band drive in full sync, half split, third split, and full split phase shift drive schemes respectively, according to an embodiment. FIG. 43 depicts a chart showing the improvement in system efficiency resulting from the reduced commutation band drive in full sync, half split, third split, and full split phase shift drive schemes, according to an embodiment.

Efficiency curve 480 represents the efficiency of the drive unit 100 in full sync phase shift drive scheme, where the motors are being run fully synchronously. In an embodiment, efficiency curve 480 shows an average efficiency of approximately 65%. While maximum power equivalent to approximately the sum of the individual motor power outputs is achievable using this scheme, the overall system efficiency is low.

Efficiency curve 486 represents the efficiency of the drive unit 100 in full split phase shift drive scheme, where the motors are each driven for ⅙^{th} of a standard commutation band (e.g., 20 degree commutation band). Efficiency curve 484 shows an average efficiency of approximately 82%, representing an approximately 17% improvement over efficiency curve 480. Here, the system efficiency of the drive unit 100 is near the peak efficiency of the individual motors 200, and therefore the maximum possible efficiency is achieved. However, the drive unit 100 is driven by only one motor 200 at any given time, so high efficiency is achieved at the expense of the power output.

Efficiency curve 482 represents the efficiency of the drive unit 100 in half split phase shift drive scheme, where the motors are divided to two groups of three motors, and the motors in each group are driven using common commutation signals at half a standard commutation band (e.g., 60 degree commutation band). Efficiency curve 482 shows an average efficiency of approximately 77%, representing an approximately 12% improvement over efficiency curve 480. The half split scheme significantly improves efficiency, although the power output of the drive unit 100 is approximately half of that of the full synch scheme.

Efficiency curve 484 represents the efficiency of the drive unit 100 in thirds split phase shift drive scheme, where the motors are divided to three groups of two motors, and the motors in each group are driven using common commutation signals at a third a standard commutation band (e.g., 40 degree commutation band). Efficiency curve 484 shows an average efficiency of approximately 80%, representing an approximately 15% improvement over efficiency curve 480. The thirds split scheme improves efficiency even further in comparison to the half split scheme, although the power output of the drive unit 100 is approximately ⅓ of that of the full synch scheme.

In an embodiment, the controller 342 may be configured to switch between the full synch, the half split, the third split, and the full split phase shift drive schemes, according to a desired output power required for a given application. For example, in an embodiment, the controller 342 may receive a power mode selection from an operator of the drive unit 100 and set the aforementioned control schemes accordingly.

In general, as discussed above and as discussed further below, a multi-motor drive unit includes a defined unit with a housing defined by the rear and front covers, or any drive unit such as a power tool that utilizes the illustrated components and houses the rear and front covers as discrete components or integrated within its housing. Further, in general, in some embodiments, the multi-motor drive unit may include one or more or all of the transmission components for performing gear reduction and/or driving a shaft or other implement of a power tool. In other embodiments, one or more or all of the transmission components for performing gear reduction and/or driving a shaft or other implement of a power tool may be outside of the multi-motor drive unit.

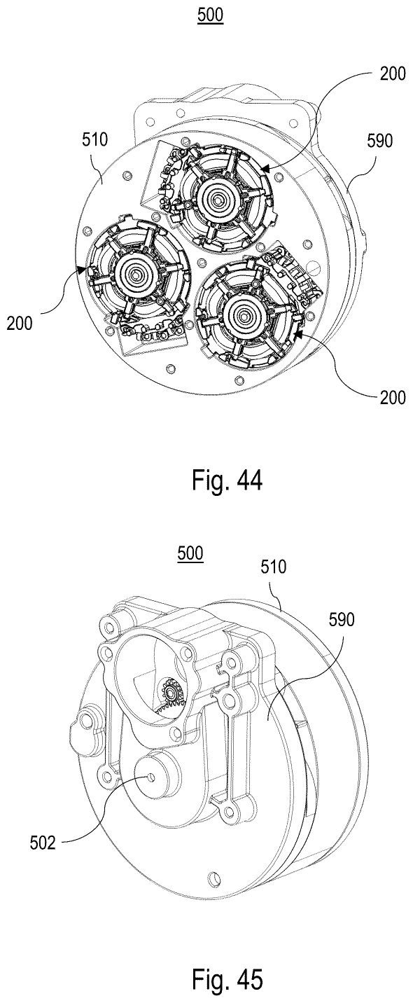

FIG. 44 depicts a perspective view of another multi-motor drive unit 500, according to an embodiment. FIG. 45 depicts another perspective view of the multi-motor drive unit 500 of FIG. 44, according to an embodiment.

In an embodiment, multi-motor drive unit 500 includes a series of Brushless Direct-Current (BLDC) motors 200 (in this example three motors) that cooperate to drive an output shaft 502. The motors 200 may be the same motors 200 as depicted and described above with reference, for example, to FIGS. 2-4 and 7-9. Drive unit 500 further includes a rear cover 510 and a front cover 590 that cover two ends of the unit. Motors 200 are disposed along a common radial plane and a circular array around a center (or central) longitudinal axis of the drive unit 500 (i.e., longitudinal axis of the output shaft 502) at equidistant angular positions relative to the longitudinal axis. As discussed below, motors 200 are mechanically bound to a single core gear that transfers torque from the output shafts of the individual motors 200 to the output shaft 502 of the drive unit 500.

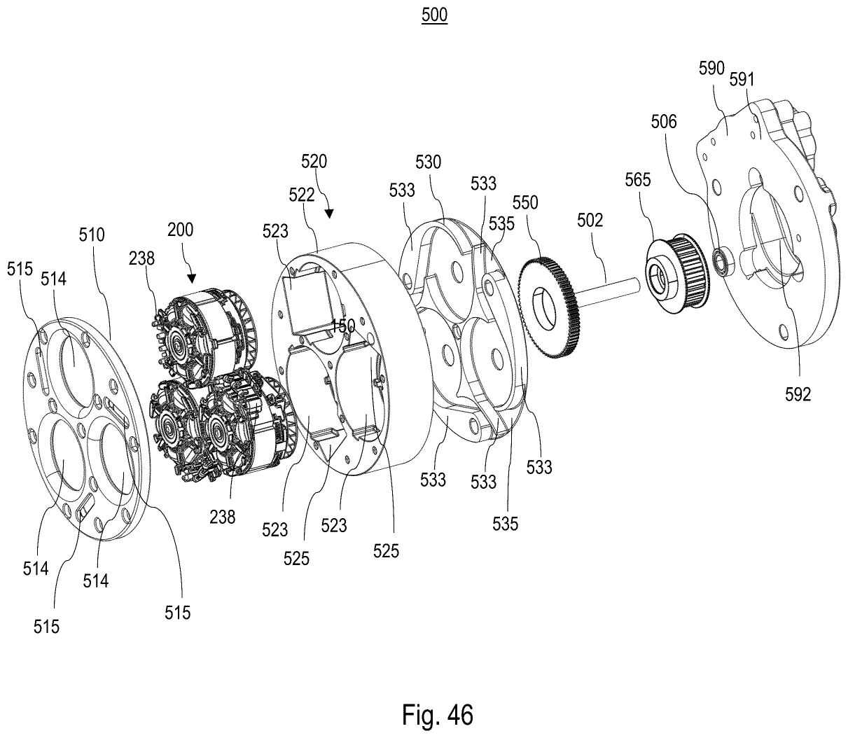

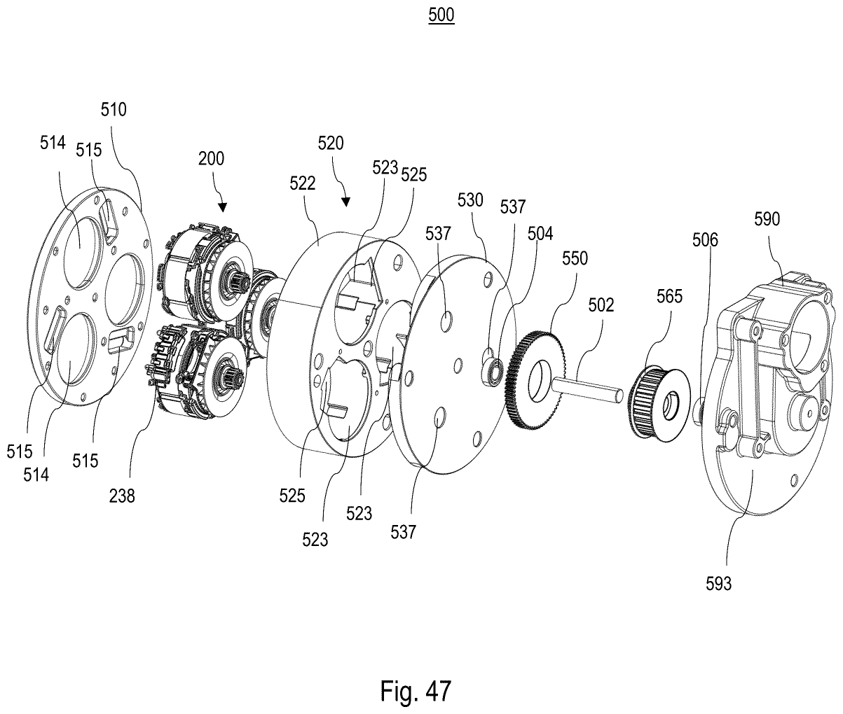

FIG. 46 depicts an exploded view of the multi-motor drive unit 500 of FIG. 44, according to an embodiment. FIG. 47 depicts another exploded view of the multi-motor drive unit 500 of FIG. 44, according to an embodiment.

As shown in FIG. 46 and FIG. 47, in addition to the motors 200, rear cover 510, and front cover 590, drive unit 500 includes a sleeve 520 disposed around the motors 200, a motor adapter 530 that supports front portions of the motors 200 and pilots a master bearing 504, a master gear 550 that is driven by the motors 200, and a pulley 565 that supports an output bearing 506 for the output shaft 502. In an embodiment, a series of fasteners (not shown) are received through one of the front cover 590 or the rear cover 510, passed through corresponding through-holes of the aforementioned components, and securely fastened into the other of the rear cover 510 or the front cover 590 to complete the multi-motor drive unit 500. These components are described in detail with continued reference to FIGS. 44-47 throughout this disclosure.

In an embodiment, the rear cover 510 provides a mounting structure for initial mounting and securement of the motors 200. In an embodiment, rear cover 510 includes a set of air intakes 514 disposed equidistantly around a center of the rear cover 510. The rear cover 510 also includes a set of openings 515. Motors 200 are mounted in the set of air intakes 514 and the motor terminals 238 are mounted in the set of openings 515. In an embodiment, motor fans are positioned away from the set of air intakes 514 to generate air flow through the set of air intakes 514 into the motors 200.

In an embodiment, motors 200 are oriented such that the motor terminals 238 of each motor point out laterally instead of towards the center of the rear cover 510. The motor terminals 238 fall within the overall geometry of the multi-motor drive unit 500 and within rear cover 510 and sleeve 520 without any increase in stator diameter or stator length of the motors 200.

In an embodiment, sleeve 520 is provided to surround the motors 200 and may include material and features to create a substantially water-sealed enclosure around the motors 200. In an embodiment, sleeve 520 includes an outer body 522 having substantially the same profile as the outer periphery of the rear cover 510 and extending around the motors 200, and a set of openings 523 that each surround one of the motors 200. The set of openings 523 includes a cutout 525 for the motor terminals 238. In an embodiment, the motors 200 including the motor terminals 238 fit within openings 523 and cutout 525. The sleeve 520 may be made of a material (e.g., metal, aluminum, or the like) that functions to dissipate heat from the motors 200.

In an embodiment, sleeve 520 may be sized in accordance with the axial length of the motors 200 (or length of the lamination stack). In an embodiment, the length of the sleeve 520 may be constructed in accordance with the length of the motors 200, while the remaining components of the drive unit 500 are sized irrespective of the length of the motors 200.

In an embodiment, motor adapter 530 is configured to interlock with the sleeve 520 and the master bearing 504. The motor adapter 530 pilots and supports front ends of the motors 200 both rotationally and radially. In an embodiment, motor adapter 530 includes a set of ramps 533 (or contours) that are structured to direct air flow around the motors 200 for cooling and to exhaust the air from the drive unit 500. The set of ramps 533 are curved members where a pair of the set of ramps 533 form a circular structure having an exhaust opening 535 into which the front ends of motors 200 fit. The circular structure may not form a complete walled circle because of the exhaust opening 535.

In an embodiment, the exhaust opening 535 forms a cutout to exhaust air that has cooled the motors 200. Air is exhausted radially outward from the exhaust opening 535.

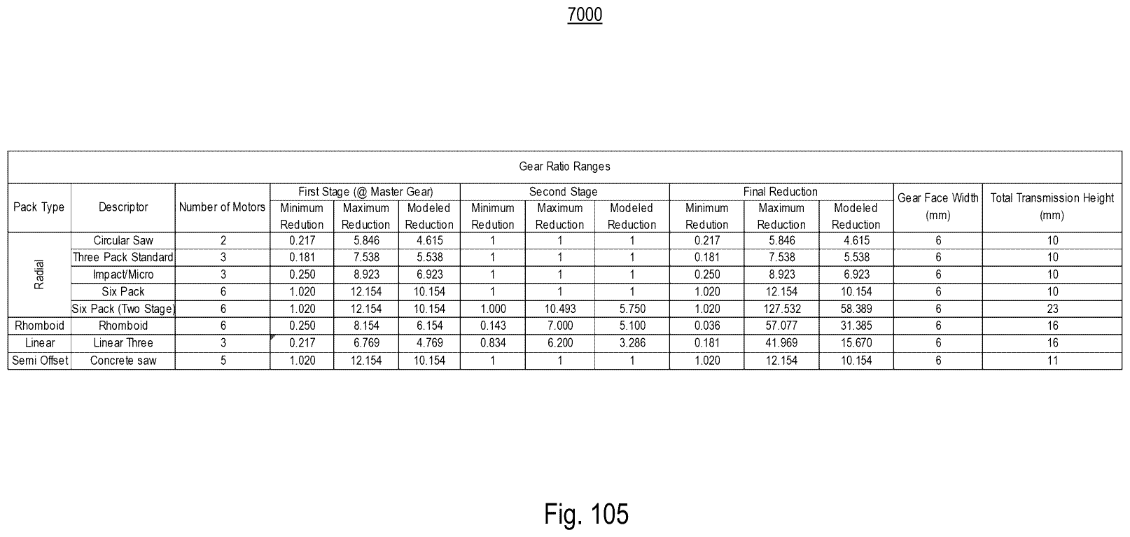

In an embodiment, the motor adapter 530 includes a set of through holes 537 to receive the pinions of the motors 200. The teeth of the master gear 550 mesh with the teeth of the pinions of the motors 200. In an embodiment, master gear 550 and the pinions of the motors 200 provides a gear reduction, as listed in Table 7000 of FIG. 105. In an example, where motors 200 run in unison at an output speed of 30,000 RPM, the output speed of the master gear 550 is approximately 5,416 RPM. The master gear 550 drives the output shaft 502 and the pulley 565.

In an embodiment, the front cover 590 provides a housing for the master gear 550, the pulley 565, and the output bearing 506. Front cover 590 includes a rear face 591, a center opening 592, and a tool interface 593. The rear face 591 is substantially aligned with the motor adapter 530, the sleeve 520, and the rear cover 510. The center opening 592 receives the master gear 550, the pulley 565, and the output bearing 506. The tool interface 593 is configured to mate with, drive, and/or otherwise interface with a power tool. For example, the tool interface 593 may be configured to include a belt (not shown) that is rotatably driven by the output shaft 502 and the pulley 565. The tool interface 593 may include other features that are configured to mate with and/or otherwise interface with a specific power tool. In one example, the tool interface 593 may interface to drive a blade for a table saw. In other examples, the center opening 592 may interface to drive a blade or accessory or other implement for a different type of power tool.

In comparison to drive unit 100, drive unit 500 has a smaller diameter across the rear cover 510 and a smaller overall circumference. Further, the distance between one motor relative to the other motors 200 is smaller in drive unit 500 compared to the distance between one motor relative to the other motors 200 in drive unit 100.

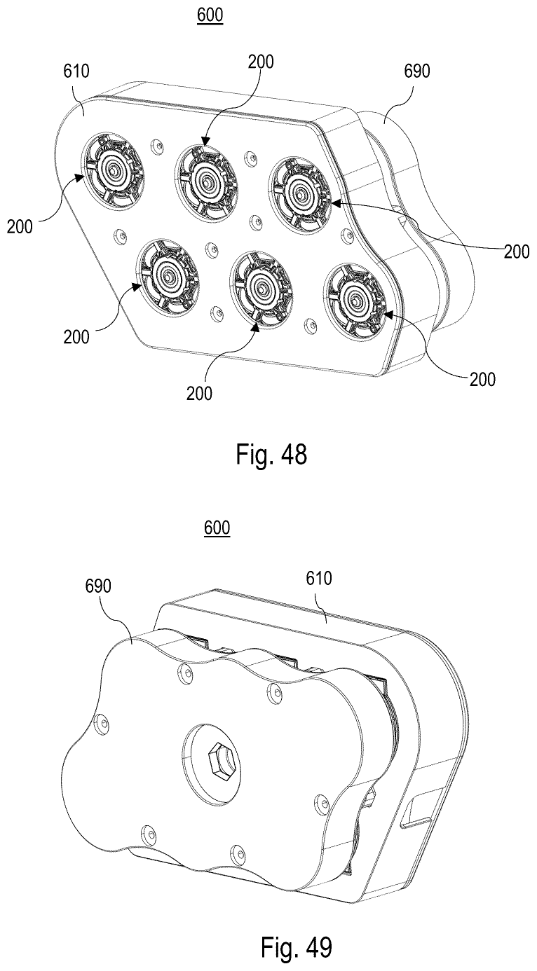

FIG. 48 depicts a perspective view of another multi-motor drive unit 600, according to an embodiment. FIG. 49 depicts another perspective view of the multi-motor drive unit 600 of FIG. 48, according to an embodiment.

In an embodiment, multi-motor drive unit 600 includes a series of Brushless Direct-Current (BLDC) motors 200 (in this example six motors) that cooperate to drive an output shaft (not shown). The motors 200 may be the same motors 200 as depicted and described above with reference, for example, to FIGS. 2-4 and 7-9. Drive unit 600 further includes a rear cover 610 and a front cover 690 that cover two ends of the unit. Motors 200 are disposed along a common radial plane and in two linear planes with each linear plane arranged along a longitudinal axis through the center of each pinion of a portion of the motors 200. In contrast to the drive unit 100 and the drive unit 500, the drive unit 600 is not at equidistant angular positions relative to the longitudinal axis. Instead, in drive unit 600, a first portion of the motors 200 are spaced equally apart along a first linear plane and a second portion of the motors 200 are spaced equally apart along a second linear plane. The first linear plane is along a longitudinal axis through the center of each pinion of the first portion of the motors 200. The second linear plane is along a longitudinal axis through the center of each pinion of the second portion of the motors 200. As discussed below, the motors 200 are mechanically bound to a single core gear that transfers torque from the output shafts of the individual motors 200 to the output shaft (not shown) of the drive unit 600.

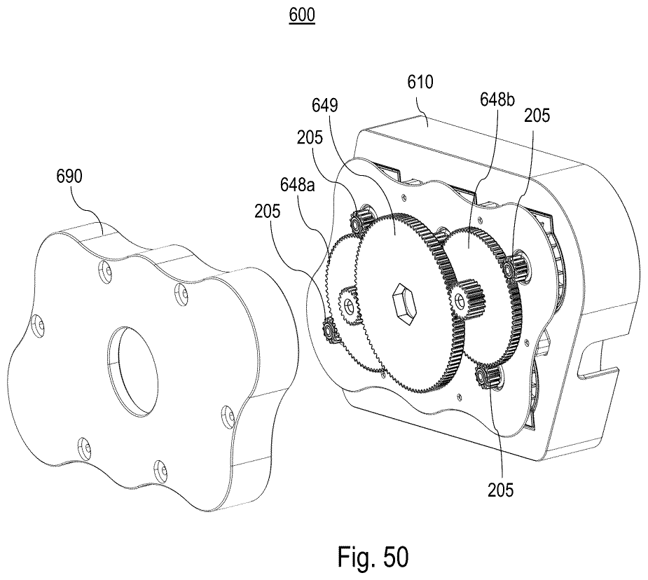

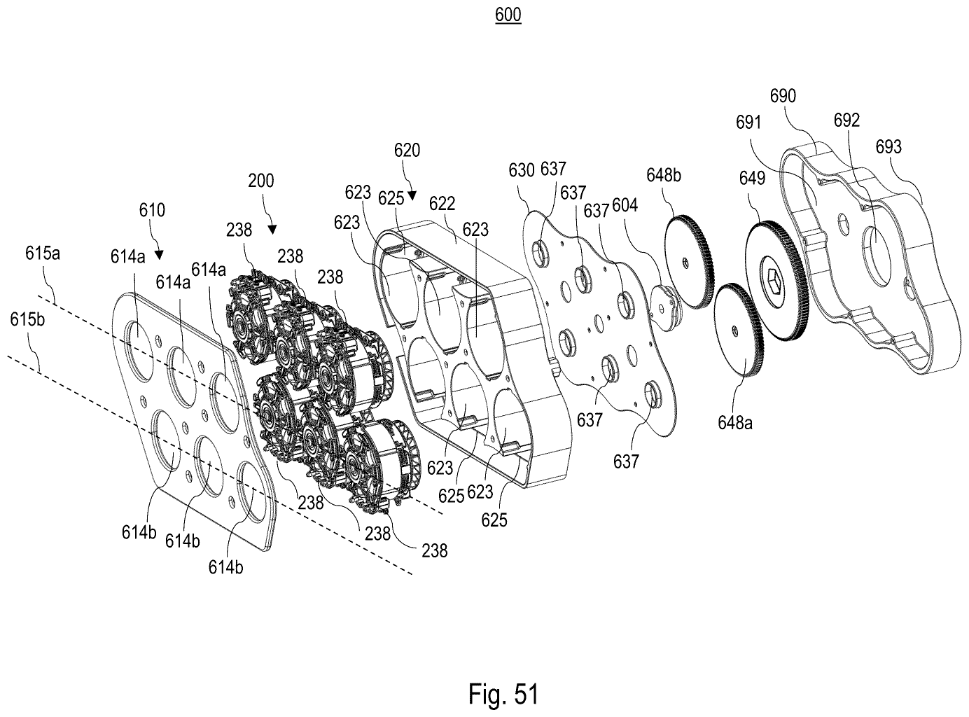

FIG. 50 depicts a partially exploded view of the drive 600 unit of FIG. 48, according to an embodiment. FIG. 51 depicts an exploded view of the drive unit 600 of FIG. 48, according to an embodiment.

As shown in FIG. 50 and FIG. 51, in addition to the motors 200, rear cover 610, and front cover 690, drive unit 600 includes a sleeve 620 disposed around the motors 200, a motor adapter 630 that supports front portions of the motors 200 and pilots a master bearing 604, a first stage transmission that includes first stage gears 648a and 648b that are driven by the motors 200, a second stage transmission that includes a second stage gear 649 that is driven by first stage gears 648a and 648b, an output bearing 604 for the output shaft (not shown). In an embodiment, a series of fasteners (not shown) are received through one of the front cover 690 or the rear cover 610, passed through corresponding through-holes of the aforementioned components, and securely fastened into the other of the rear cover 610 or the front cover 690 to complete the multi-motor drive unit 600. These components are described in detail with continued reference to FIGS. 48-51 throughout this disclosure.

In an embodiment, the rear cover 610 provides a mounting structure for initial mounting and securement of the motors 200. In an embodiment, rear cover 610 includes a set of air intakes 614a and 614b disposed on the rear cover 610. The set of air intakes 614a and 614b may be arranged in different configurations on the rear cover 610. In an embodiment, a first portion of the set of air intakes 614a are arranged in a first linear plane 615a and a second portion of the set of set of air intakes 614b are arranged in a second linear plane 615b. Motors 200 are mounted in the set of air intakes 614a and 614b. In an embodiment, motor fans 200 are positioned away from the set of air intakes 614a and 614b to generate air flow through the set of air intakes 614a and 614b into the motors 200.

In an embodiment, motors 200 are oriented such that the motor terminals 238 point out laterally instead of towards the center of the rear cover 610. In an embodiment, the motor terminals 238 for the motors 200 in the first linear plane 615a are pointed laterally away from the center of the rear cover 610 in a same direction. The motor terminals 238 for the motors 200 in the second linear plane 615b are pointed laterally away from the center of the rear cover 610 in a same direction, but in a direction that is opposite the motor terminals 238 for the motors 200 in the first linear plane 615a.

In an embodiment, sleeve 620 is provided to surround the motors 200 and may include material and features to create a substantially water-sealed enclosure around the motors 200. In an embodiment, sleeve 620 includes an outer body 622 having substantially the same profile as the outer periphery of the rear cover 610 and extending around the motors 200, and a set of openings 623 that each surround one of the motors 200. The set of openings 623 includes a cutout 625 for the motor terminals 238. In an embodiment, the motors 200 including the motor terminals 238 fit within openings 623 and cutout 625. The sleeve 620 may be made of a material (e.g., metal, aluminum, or the like) that functions to dissipate heat from the motors 200.

In an embodiment, sleeve 620 may be sized in accordance with the axial length of the motors 200 (or length of the lamination stack). In an embodiment, the length of the sleeve 620 may be constructed in accordance with the length of the motors 200, while the remaining components of the drive unit 600 are sized irrespective of the length of the motors 200.

In an embodiment, motor adapter 630 is configured to interlock with the sleeve 620 and the master bearing 604. The motor adapter 630 pilots and supports front ends of the motors 200 both rotationally and radially. In an embodiment, the motor adapter 630 includes a set of through holes 637 to receive the pinions of the motors 200. In an embodiment, motor adapter 630 is shaped and sized to fit front cover 690. Both the motor adapter 630 and the front cover 690 may be smaller in size than rear cover 610 and sleeve 620.

In an embodiment, the teeth of the first stage gears 648a and 648a mesh with the teeth of the pinions of the motors 200. In an embodiment, first stage gears 648a and 648b and the pinions of the motors 200 provides a gear reduction, as listed in Table 7000 of FIG. 105. Teeth of first stage gears 648a and 648b mesh with teeth of second stage gear 649. In an embodiment, first stage gears 648a and 648b and second stage gear 649 provide a gear reduction, as listed in Table 7000 of FIG. 105. In an example, where motors 200 run in unison at an output speed of 30,000 RPM, the output speed of the gear second stage gear 649 is approximately 955 RPM. The second stage gear 649 drives an output shaft.

In an embodiment, the front cover 690 provides a housing for the master first stage gears 648a and 648b, the second stage gear 649, and the master bearing 604. In an embodiment, front cover 690 is smaller than the rear cover 610 and sleeve 620. Front cover 690 includes a rear face 691, a center opening 692, and a front face 693. The rear face 691 is substantially aligned with the motor adapter 630. In an embodiment, the front cover 690 mates with the sleeve 620 to form an enclosure (e.g., a full enclosure) around the drive unit 600 components. In an embodiment, the center opening 692 is sized to receive master bearing 604 and support an output shaft (not shown).

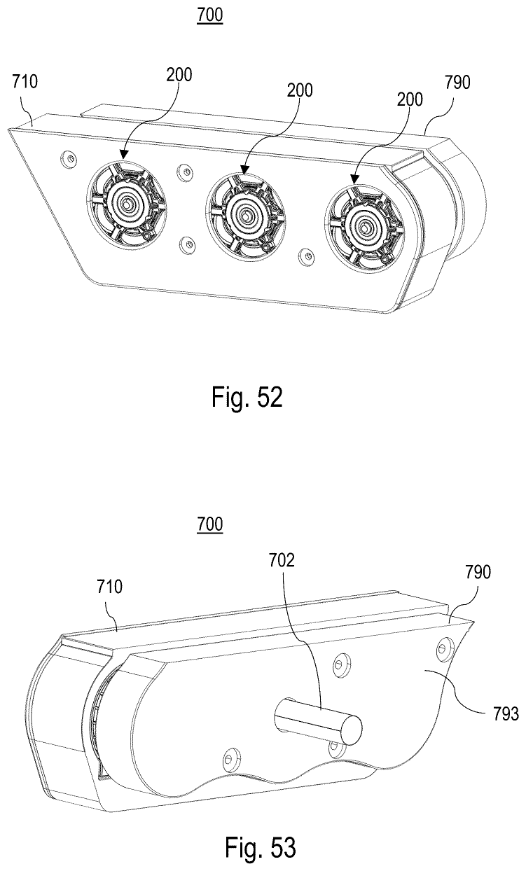

FIG. 52 depicts a perspective view of another multi-motor drive unit 700, according to an embodiment. FIG. 53 depicts another perspective view of the multi-motor drive unit 700 of FIG. 52, according to an embodiment.

In an embodiment, multi-motor drive unit 700 includes a series of Brushless Direct-Current (BLDC) motors 200 (in this example three motors) that cooperate to drive an output shaft 702. The motors 200 may be the same motors 200 as depicted and described above with reference, for example, to FIGS. 2-4 and 7-9. Drive unit 700 further includes a rear cover 710 and a front cover 790 that cover two ends of the unit. Motors 200 are disposed along a common radial plane and in a linear plane with the linear plane arranged along a longitudinal axis through the center of each pinion of the motors 200. In contrast to the drive unit 100 and the drive unit 500, the drive unit 700 is not at equidistant angular positions relative to the longitudinal axis. Instead, drive unit 700 is similar to drive unit 600 except with three motors 200 instead of six motors 200. The motors 200 are spaced equally apart along a linear plane. The linear plane is along a longitudinal axis through the center of each pinion of the motors 200. As discussed below, the motors 200 are mechanically bound to a single core gear that transfers torque from the output shafts of the individual motors 200 to the output shaft 702 of the drive unit 700.

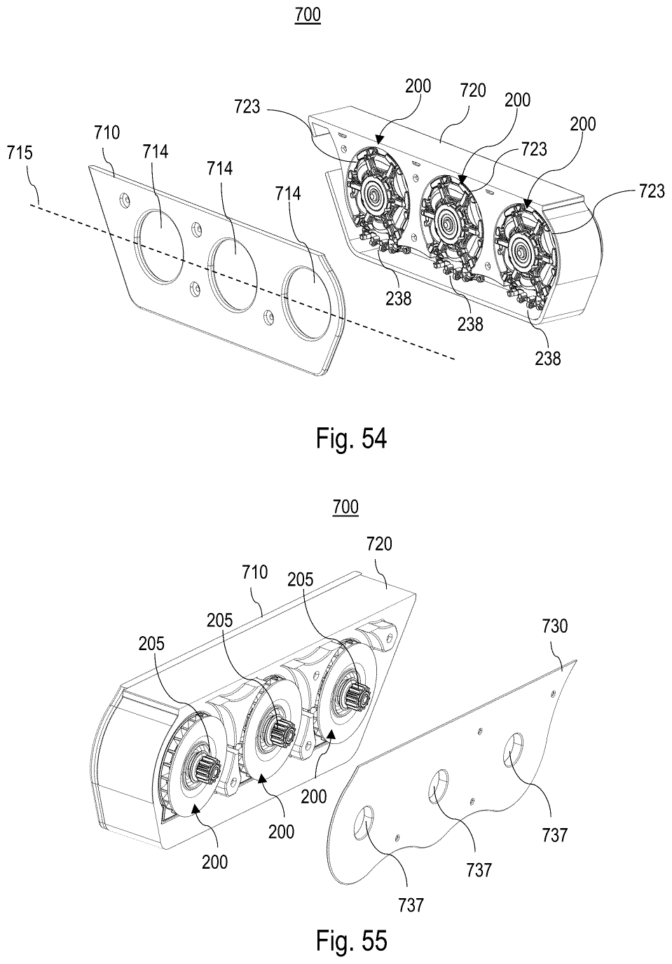

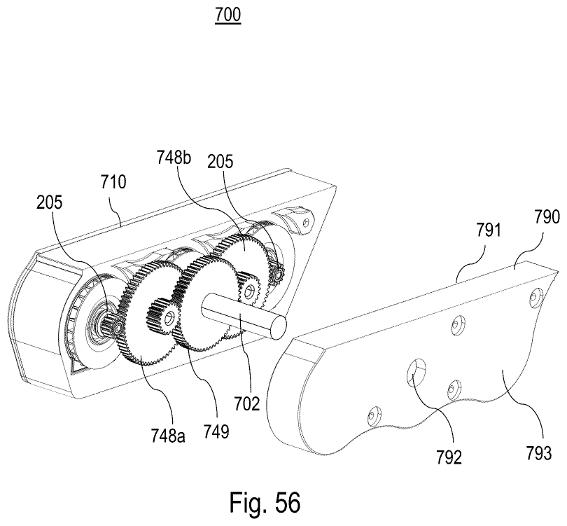

FIG. 54 depicts a partially exploded view of the drive unit 700 of FIG. 52, according to an embodiment. FIG. 55 depicts another partially exploded view of the drive unit 700 of FIG. 52, according to an embodiment. FIG. 56 depicts another partially exploded view of the drive unit 700 of FIG. 52, according to an embodiment.

As shown in FIGS. 54-56, in addition to the motors 200, rear cover 710, and front cover 790, drive unit 700 includes a sleeve 720 disposed around the motors 200, a motor adapter 730 that supports front portions of the motors 200 and pilots a master bearing (not shown), a first stage transmission that includes first stage gears 748a and 748b that are driven by the motors 200, a second stage transmission that includes a second stage gear 749 that is driven by first stage gears 748a and 748b, an output bearing (not shown) for the output shaft 702. In an embodiment, a series of fasteners (not shown) are received through one of the front cover 790 or the rear cover 710, passed through corresponding through-holes of the aforementioned components, and securely fastened into the other of the rear cover 710 or the front cover 790 to complete the multi-motor drive unit 700. These components are described in detail with continued reference to FIGS. 52-56 throughout this disclosure.

In an embodiment, the rear cover 710 provides a mounting structure for initial mounting and securement of the motors 200. In an embodiment, rear cover 710 includes a set of air intakes 714 disposed on the rear cover 710. The set of air intakes 714 may be arranged in different configurations on the rear cover 710. In an embodiment, the set of air intakes 714 are arranged in a linear plane 715. Motors 200 are mounted in the set of air intakes 714. In an embodiment, motor fans 200 are positioned away from the set of air intakes 714 to generate air flow through the set of air intakes 714 into the motors 200.

In an embodiment, motors 200 are oriented such that the motor terminals 238 point out laterally instead of towards the center of the rear cover 710. In an embodiment, the motor terminals 238 for the motors 200 in the linear plane 715 are pointed laterally away from the center of the rear cover 710 in a same direction.

In an embodiment, sleeve 720 is provided to surround the motors 200 and may include material and features to create a substantially water-sealed enclosure around the motors 200. In an embodiment, sleeve 720 includes an outer body 722 having substantially the same profile as the outer periphery of the rear cover 710 and extending around the motors 200, and a set of openings (not shown) that each surround one of the motors 200. The set of openings includes a cutout (not shown) for the motor terminals 238. In an embodiment, the motors 200 including the motor terminals 238 fit within openings and the cutout. The sleeve 720 may be made of a material (e.g., metal, aluminum, or the like) that functions to dissipate heat from the motors 200.

In an embodiment, sleeve 720 may be sized in accordance with the axial length of the motors 200 (or length of the lamination stack). In an embodiment, the length of the sleeve 620 may be constructed in accordance with the length of the motors 200, while the remaining components of the drive unit 600 are sized irrespective of the length of the motors 200.

In an embodiment, motor adapter 730 is configured to interlock with the sleeve 720 and the master bearing (not shown). The motor adapter 730 pilots and supports front ends of the motors 200 both rotationally and radially. In an embodiment, the motor adapter 730 includes a set of through holes 737 to receive the pinions of the motors 200. In an embodiment, motor adapter 730 is shaped and sized to fit front cover 790. Both the motor adapter 730 and the front cover 790 may be smaller in size than rear cover 710 and sleeve 720.

In an embodiment, the teeth of the first stage gears 748a and 748a mesh with the teeth of the pinions of the motors 200. In an embodiment, first stage gears 748a and 748b and the pinions of the motors 200 provides a gear reduction, as listed in Table 7000 of FIG. 105. Teeth of first stage gears 748a and 748b mesh with teeth of second stage gear 749. In an embodiment, first stage gears 748a and 748b and second stage gear 749 provide a gear reduction, as listed in Table 7000 of FIG. 105. In an example, where motors 200 run in unison at an output speed of 30,000 RPM, the output speed of the gear second stage gear 749 is approximately 1,914 RPM. The second stage gear 749 drives output shaft 702.

In an embodiment, the front cover 790 provides a housing for the first stage gears 748a and 748b, the second stage gear 749, and the master bearing (not shown). In an embodiment, front cover 790 is smaller than the rear cover 710 and sleeve 720. Front cover 790 includes a rear face 791, a center opening 792, and a front face 793. The rear face 791 is substantially aligned with the motor adapter 730. In an embodiment, the front cover 790 mates with the sleeve 720 to form an enclosure (e.g., a full enclosure) around the drive unit 700 components. In an embodiment, the center opening 792 is sized to receive master bearing (not shown) and support output shaft 702.

In an embodiment, drive unit 700 is similar in construction and function to drive unit 600, except that drive unit 700 includes three motors 200 instead of six motors 200. In both drive unit 600 and drive unit 700, the motors 200 are arranged in a linear manner and configured to drive a single output shaft. In an embodiment, drive unit 600 may be used with one type of power tool and drive unit 700 may be used with the same or a different type of power tool than drive unit 600.

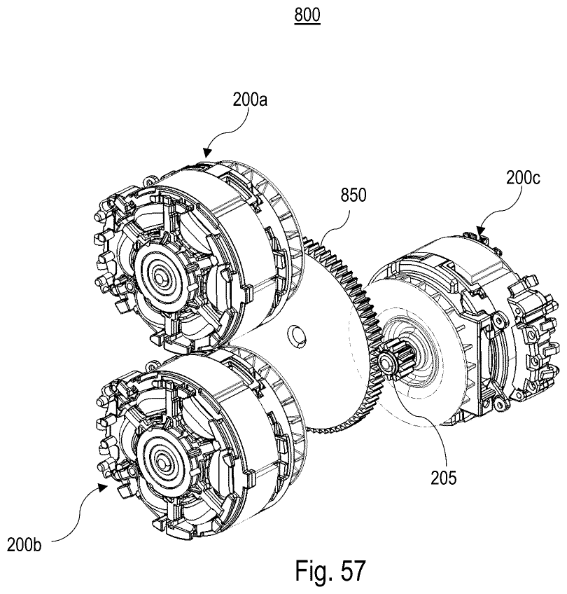

Embodiments described above are just examples of different ways of configuring at least two motors in a pack to form a drive unit, such as, drive unit 100, drive unit 500, drive unit 600, and drive unit 700. In each of these examples, motors 200 are arranged in a same radial plane to engage a master gear, even though the number of motors 200 may vary and the arrangement in the radial plane may vary. In an alternate embodiment, motors 200 may be arranged in an alternate or inverted orientation, as illustrated in FIG. 57.

FIG. 57 depicts a perspective view of an inverted arrangement of multiple motors 200a, 200b, 200c for use in a multi-motor drive unit 800, according to an embodiment. It is understood that this rendering is illustrating an arrangement and orientation of the motors without including all of the components of multi-motor drive unit, such as described above. In an embodiment, motors 200a, 200b, and 200c may be a part of drive unit 800 or alternatively may be a part of a power tool system in an arrangement other than a drive unit. Motors 200a, 200b, and 200c may be the same motors as motors 200. In an embodiment, motors 200a and 200b are oriented in a first radial plane and motor 200c is oriented in a second radial plane.

In an embodiment, drive unit 800 includes a master gear 850. Teeth of the pinions 205 of the motors 200a, 200b, and 200c engage and mesh with the teeth of the master gear 850. Motors 200a and 200b rotate in one direction and motor 200c rotates in an opposite direction from motors 200a and 200b. In an embodiment, motors 200a and 200b may rotate clockwise and motor 200c may rotate counter-clockwise.

FIG. 57 illustrates that the number and arrangement of motors may vary based on constraints such as, for example, power tool size constraints. That is, the arrangement and placement of the motors may be based on the availability of space within a system or device such as within a housing or may be based on the location and sizing of other components in the system or device, such as a handle.

In an embodiment, drive unit 800 may represent an arrangement where the use of the drive unit 800 is constrained by space or other characteristics to have two motors 200a and 200b on one side of the master gear 850 and only one motor 200c on the other side of the master gear 850. That is, drive unit 800 includes motors 200a and 200b oriented on a first radial plane and motor 200c oriented on a second radial plane, where the first radial plane and the second radial plane are different radial planes. Even though the motors 200a and 200b are on a different radial plane than motor 200c, the three motors 200a, 200b, and 200c all cooperate to drive master gear 850.

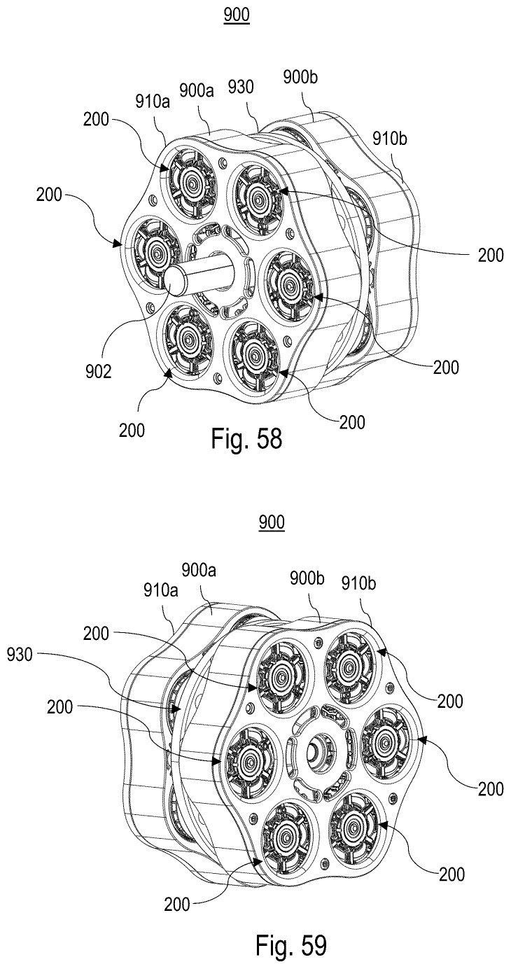

FIG. 58 depicts a perspective view of a drive unit 900 having multiple, multi-motor drive units, according to an embodiment. FIG. 59 depicts another perspective view of the drive unit 900 of FIG. 58, according to an embodiment.

In an embodiment, drive unit 900 includes multiple, multi-motor drive units 900a and 900b that are configured to cooperate together to drive a master gear (not shown) and an output shaft 902. The drive units 900a and 900b may similar to and include some or all of the features and components as drive unit 100. Similar to drive unit 100, drive units 900a and 900b include a series of BLDC motors 200 (in this example six motors) that cooperate to drive output shaft 902. The motors 200 may be the same motors 200 as depicted and described above with reference, for example, to FIGS. 2-4 and 7-9.

In an embodiment, drive unit 900a includes a rear cover 910a and drive unit 900b include a rear cover 910b. Rear cover 910a and rear cover 910b cover an end of the respective drive units 900a and 900b, as well as the ends of the whole drive unit 900. Drive unit 900a faces in an opposite direction from drive unit 900b so that the rear cover 910a and rear cover 910b are both facing outward. Instead of front covers like the front cover 190 of drive unit 100, drive unit 900 includes a common motor adapter 930 that functions as both as a front cover for drive units 900a and 900b, as well as a motor adapter like motor adapter 130 of drive unit 100, except that there is a single motor adapter 930 for both drive units 900a and 900b.

In an embodiment, motors 200 in the drive unit 900a are disposed along a common radial plane and a circular array around a center (or central) longitudinal axis of the drive unit 900 (i.e., longitudinal axis of the output shaft 902) at equidistant angular positions relative to the longitudinal axis. As discussed below, motors 200 are mechanically bound to a single core gear that transfers torque from the output shafts of the individual motors 200 to the output shaft 902 of the drive unit 900. Similarly, motors 200 in the drive unit 900b are disposed along a common radial plane and a circular array around a center (or central) longitudinal axis of the drive unit 900 (i.e., longitudinal axis of the output shaft 902) at equidistant angular positions relative to the longitudinal axis. The common radial plane for the motors 200 in drive unit 900b are in a different radial plane than the common radial plane for the motors 200 in drive unit 900a; however, both drive unit 900a and drive unit 900a share the same longitudinal axis along the output shaft 902.

In an embodiment, individual motors 200 of drive unit 900a are axially offset from individual motors 200 of drive unit 900b. That is, the longitudinal axis of each of the motors 200 in drive unit 900a are axially offset from the longitudinal axis of each of the motors 200 in drive unit 900b. As discussed below, motors 200 are mechanically bound to a single core gear that transfers torque from the output shafts of the individual motors 200 to the output shaft 902 of the drive unit 900.

In an alternate embodiment, drive unit 900 may include more than two drive units that are configured to cooperate together to drive the output shaft 902.

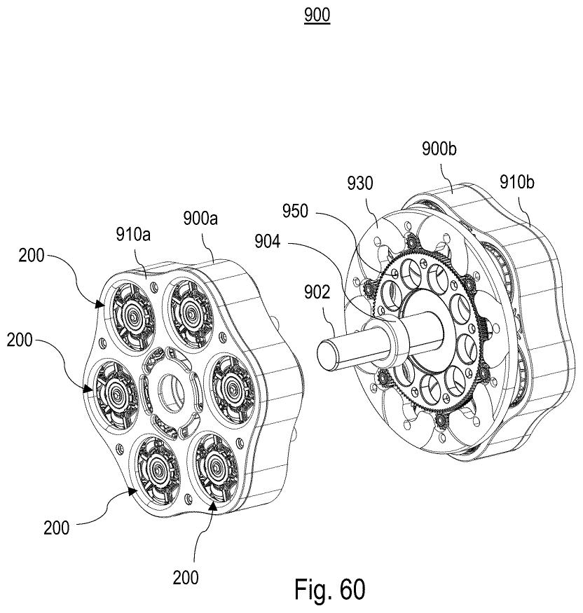

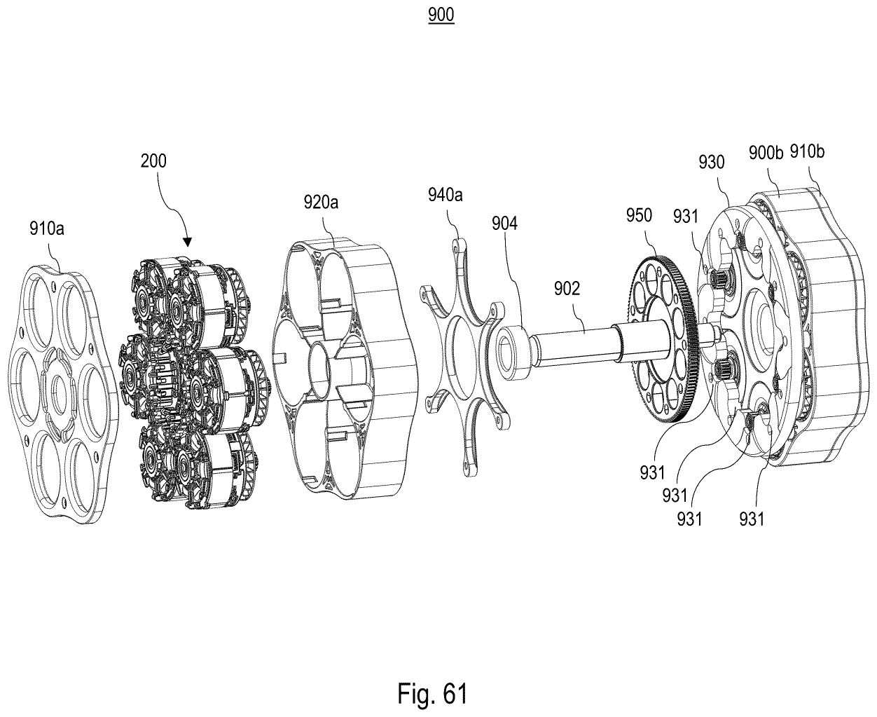

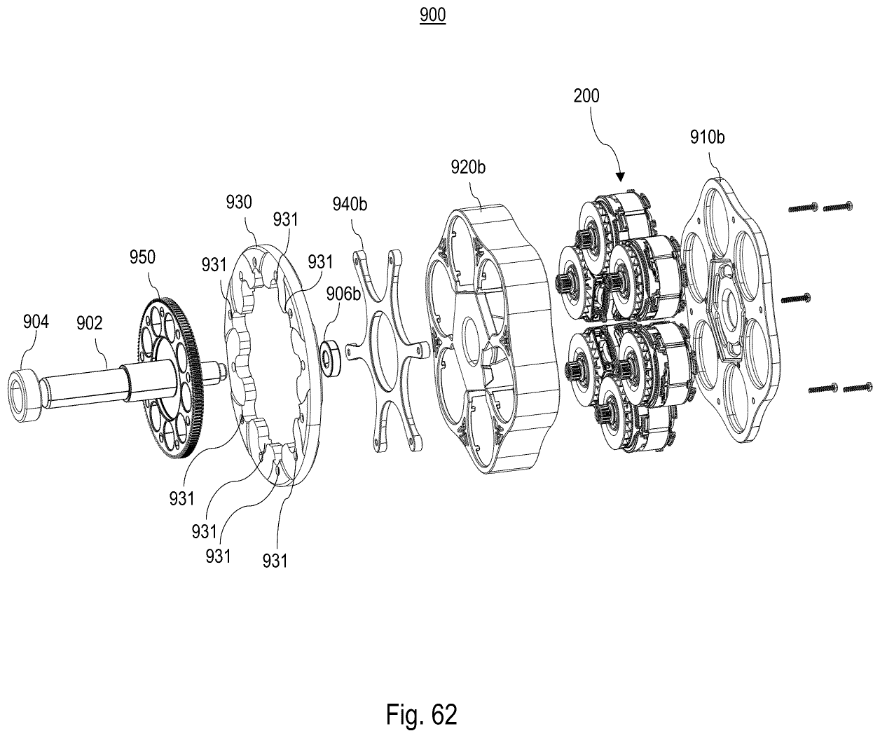

FIG. 60 depicts a partially exploded view of the drive unit 900 of FIG. 58, according to an embodiment. FIG. 61 depicts another partially exploded view of the drive unit 900 of FIG. 58, according to an embodiment. FIG. 62 depicts a partially exploded view of the drive unit 900 of FIG. 58, according to an embodiment.

As shown in FIG. 60, drive unit 900 includes drive unit 900a, drive unit 900b, and motor adapter 930 that supports front portions of the motors 200 for both drive units 900a and 900b and that pilots a master bearing 904. Drive unit 900 also includes a master gear 950 that is driven by the motors 200 of both drive unit 900a and drive unit 900b. The rear cover 910a and the rear cover 910b function the same as rear cover 110 of drive unit 100. These components are described in detail with continued reference to FIGS. 58-62.

In an embodiment, drive unit 900a includes sleeve 920a, spacer 940a, and output bearing (not shown) as best depicted in FIG. 61. Similarly, drive unit 900b includes sleeve 920B, spacer 940b and output bearing 906b, as best depicted in FIG. 62. Sleeve 920a and sleeve 920b function and operate in a same or similar manner as sleeve 120 of drive unit 100, as described above in detail. Spacer 940a and spacer 940b function and operate in a same or similar manner as spacer 140 of drive unit 100, as described above in detail.

In an embodiment, motor adapter 930 includes multiple piloting features 931 that are configured to support pinions of motors 200 for drive unit 900a and drive unit 900b. In this example, motor adapter 930 includes a piloting feature 931 for each of the motors 200, which is twelve in total. Additionally, motor adapter 930 provides support and piloting for master gear 950. Master gear 950 meshes with pinions of the motors 200 and supports master bearing 904 to drive output shaft 902.

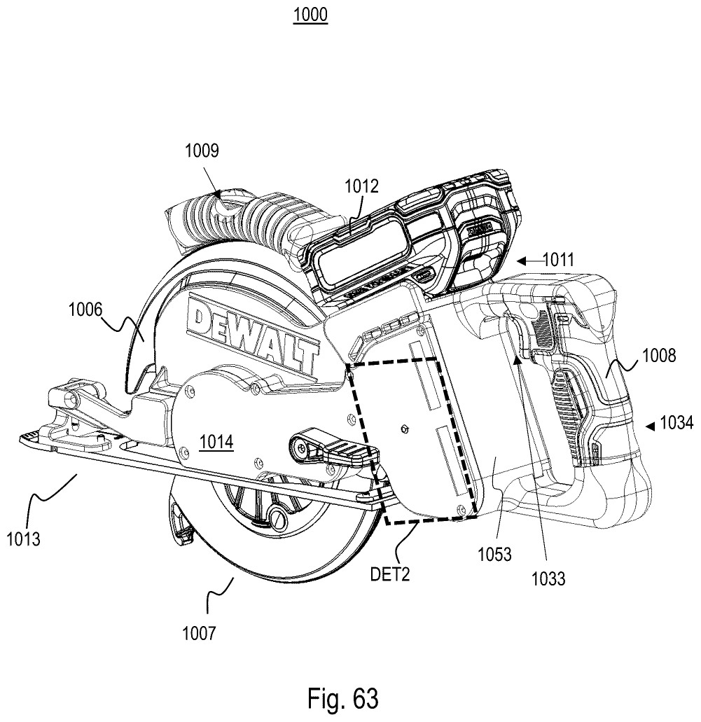

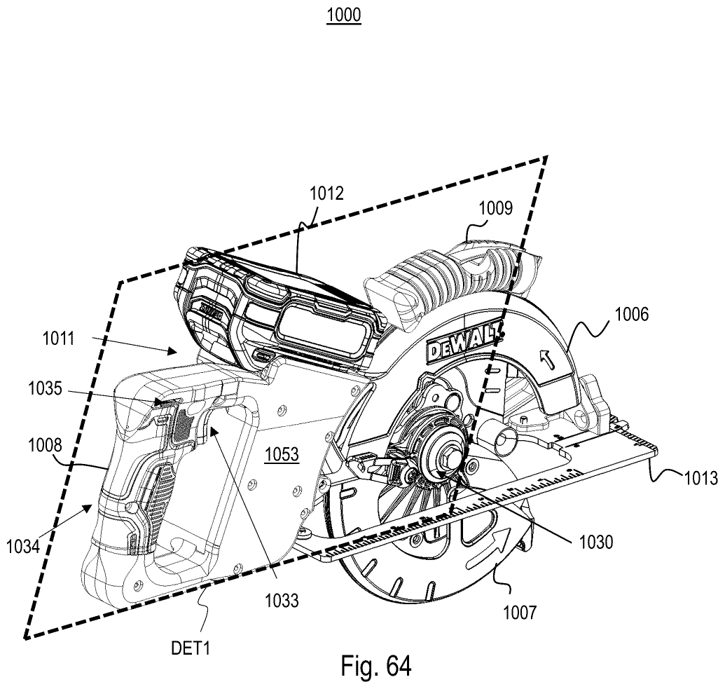

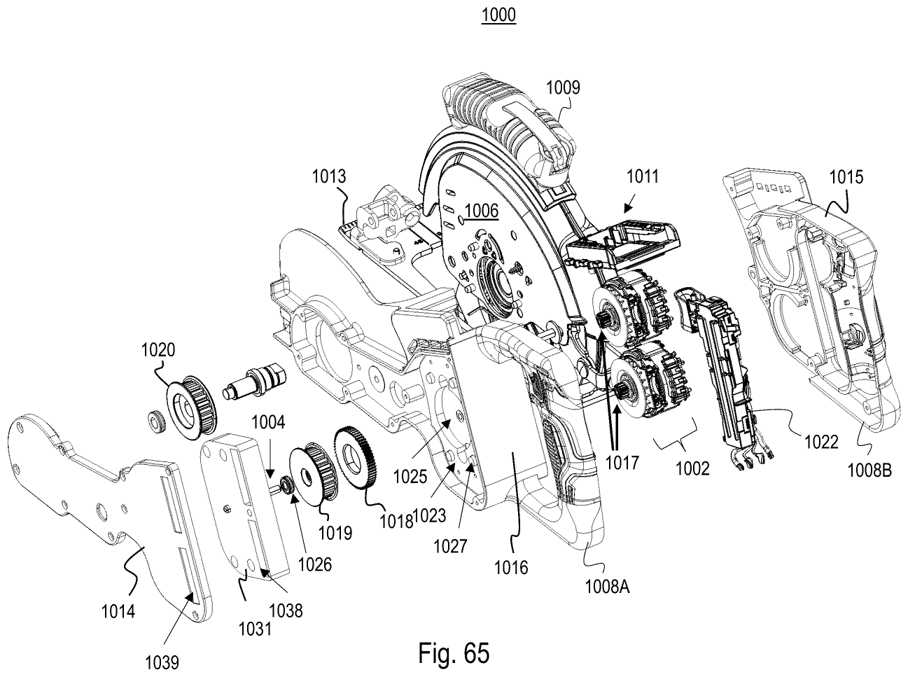

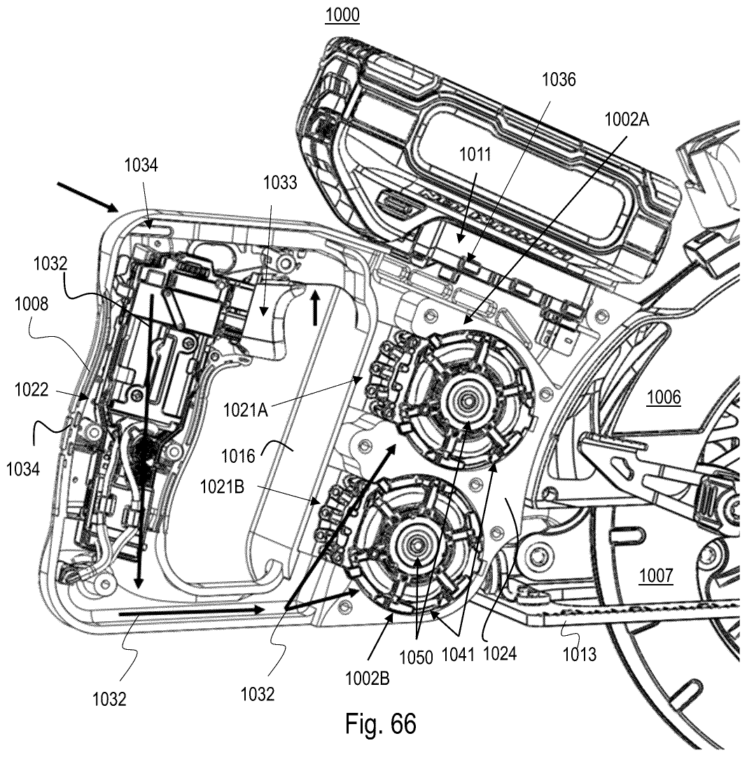

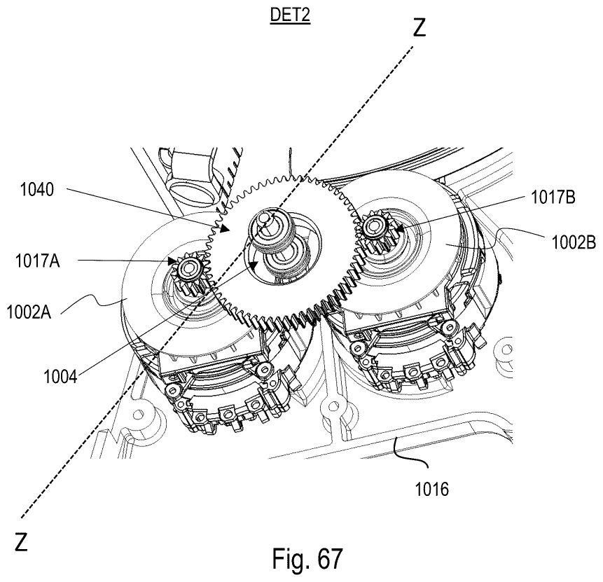

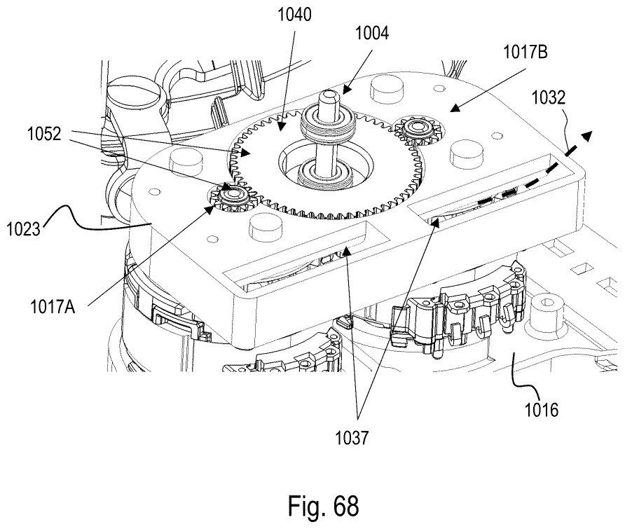

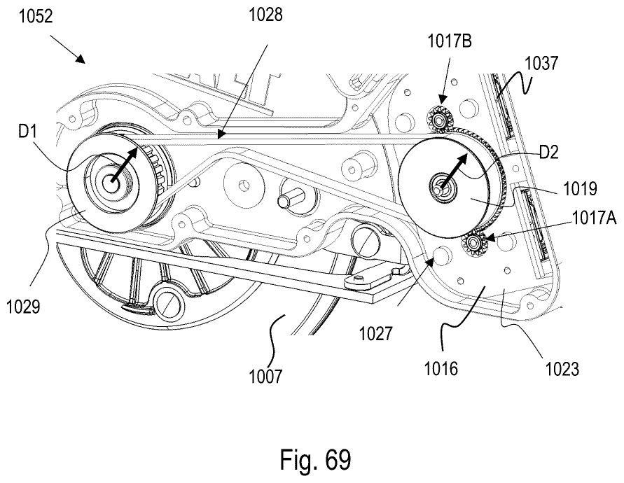

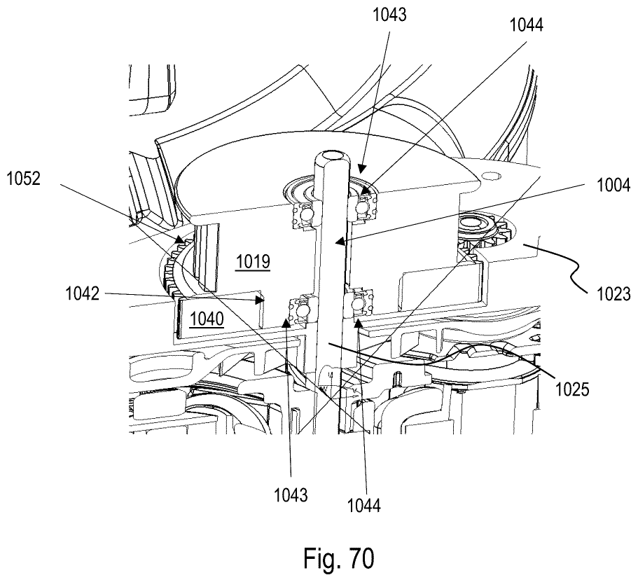

FIGS. 63-70 illustrate an example power-driven tool in the form of an example circular saw 1000 which may be driven by a multi-motor drive unit, in accordance with the principles described herein. FIGS. 63 and 64 depict left and right isometric views of the circular saw 1000, according to an embodiment. FIG. 65 depicts an exploded view of the circular saw 1000, according to an embodiment. FIG. 66 depicts a detail DET1 of the circular saw 1000 with the cover removed and motors exposed, as represented in FIG. 64. FIG. 67 depicts a detail DET2 of the circular saw 1000 with the cover removed and motors and a portion of the transmission exposed, as represented in FIG. 63. FIG. 68 depicts an isometric view of a portion of the transmission of the circular saw 1000 with a front cover and pulley cover removed and the pulley removed. FIG. 69 depicts the transmission with covers removed. FIG. 70 depicts a detailed cross-sectional view centered on a master pulley and the master gear 1018 of the circular saw of FIG. 63, the cross section Z-Z represented in FIG. 68.

Circular saw 1000 is configured to rotate a single rotating saw blade (not pictured) via an output shaft, as described below. The saw blade is housed inside an upper blade housing 1006 (sometimes also referred to as an upper blade guard). The upper blade housing 1006 may be semi-circular in shape to conform to the shape of the saw blade. In an embodiment, the circular saw 1000 may include a lower blade guard 1007. The lower blade guard 1007 may be semi-circular in shape and operable to pivot or retract when operated to expose the rotating saw blade therein to a workpiece.

The circular saw 1000 includes a handle assembly 1008 that may include a trigger 1033 and a grip 1034. The trigger 1033 may be engaged to operate the saw. A first hand may grip the handle assembly 1008 while a second hand may engage a stabilizing handle 1009 to operate the circular saw 1000. The stabilizing handle 1009 may be coupled to the upper blade housing 1006.

In embodiments, the circular saw 1000 may be used ambidextrously. In other words, the handle assembly 1008 may be used by a user's right hand, and the stabilizing handle 1009 may be used by a user's left hand or the handle assembly 1008 may be used by a user's left hand and the stabilizing handle 1009 may be used by a user's right hand. In embodiments, the stabilizing handle 1009 may be pivotable or otherwise movable to facilitate ambidextrous use.

In embodiments, the circular saw 1000 may include a shoe 1013. The shoe 1013 is a substantially planar surface and may help maintain a bevel orientation (a non-90 degree alignment) between a plane including the rotating saw blade and a plane including the substantially planar surface of the shoe 1013. The shoe 1013 may further maintain an alignment between a cut direction of the surface of the rotating saw blade and a work piece. The shoe 1013 includes a slit through which the rotating saw blade may pass.

The multi-motor drive unit 1050 and the transmission 1052 of the circular saw 1000 will be described in more detail with respect to FIGS. 65-70. The multi-motor drive unit 1050 and the transmission 1052 are housed within the tool housing 1053 of the circular saw 1000. The multi-motor drive unit 1050 includes a plurality of motors 1002 that commonly engage a master gear 1040. Each of the plurality of motors 1002 may be, for example, a Brushless Direct-Current (BLDC) motor. The plurality of motors 1002 may be similar to the motors 200 described above, and thus duplicative detailed description thereof will be omitted except where necessary.

In the example illustrated in the figures, the multi-motor drive unit 1050 includes two motors: a motor 1002A and a motor 1002B. This is not intended to be limiting, however. In embodiments, the multi-motor drive unit 1050 included with the circular saw 1000 may include any of the multi-motor drive units described above.

In FIG. 65, it may be seen that the tool housing 1053 may include a left cover 1014 and a right cover 1015. In an embodiment, the left cover 1014 and the right cover 1015 may form a portion of the exterior housing of the circular saw 1000. The left cover 1014 and the right cover 1015 may couple to a gear and motor adapter 1016 to form a housing around the circular saw 1000. The gear and motor adapter 1016 may provide support and alignment for the plurality of motors 1002 and a transmission including two pinions 1017, a master gear 1018, an input pulley 1019, and an output pulley 1020, as will be further described below.

FIG. 66 depicts DET1, a detail of the motor 1002A, motor 1002B, and a portion of the saw blade housing including the upper blade housing 1006 and the lower blade guard 1007. In the figure it may be seen that the motor 1002A and the motor 1002B are positioned within a motor adapter portion 1024, which may be integral to or coupled to the gear and motor adapter 1016. The motor adapter portion 1024 may provide a motor mounting support for the circular saw 1000.

In an embodiment, the motor 1002A and the motor 1002B of the multi-motor drive unit 1050 cooperate to drive a master gear 1040 rotating on a stationary shaft 1004. The motor 1002A and the motor 1002B may be positioned with rotational axes that are parallel to the rotational axis of the saw blade. Each of the motor 1002A and the motor 1002B may be positioned at approximately the same radial distance from a rotational axis of the saw blade towards the rear of the circular saw 1000 in a drive unit plane. The plurality of motors 1002 may be positioned towards the rear of the circular saw 1000 between the handle assembly 1008 and saw blade housed within the upper blade housing 1006 in the area under a left cover 1014 represented by the area DET2 depicted in FIG. 63.

By overlapping the drive motor plane and the saw blade plane instead of placing the drive motor plane adjacent to the saw blade plane, it is possible to make a circular saw that is narrower than prior saws along the rotational axis of the saw blade. The narrower circular saw profile may facilitate ambidextrous use of the circular saw 1000. The narrow profile may further allow an operator to cut a workpiece that is even closer to a wall. In embodiments, the narrower profile of the circular saw 1000 may further allow for the shoe 1013 to be movable into a dual-sided bevel position.

The motor 1002A and the motor 1002B may be positioned on opposing side of the stationary shaft 1004 inside motor seat portions 1041 of the motor adapter portion 1024. In embodiments, features within the motor seat portions 1041 may interlock with keyed sections (not depicted) of the motors to keep the motors in place to supply torque to the rotating saw blade.

In an embodiment, each respective motor of the plurality of motors 1002 includes an input terminal, in the example a motor terminal 1021A and a motor terminal 1021B, that may be oriented towards the rear of the circular saw 1000. By orienting the motor terminal 1021A and the motor terminal 1021B towards the rear of the circular saw 1000, it may be easier to couple the motor terminal 1021A and the motor terminal 1021B to motor electronics 1022 inside of the handle assembly 1008. This may be best viewed in FIG. 65, where a left handle assembly cover 1008A and a right handle assembly cover 1008B may be seen.

The left handle assembly cover 1008A and right handle assembly cover 1008B may be coupled together around the motor electronics 1022. In examples, the left handle assembly cover 1008A may be integrated into the gear and motor adapter 1016. In examples, the right handle assembly cover 1008B may be integrated into the right cover 1015. In examples, the gear and motor adapter 1016 may comprise a substantially integrated piece or include one or more sections coupled together.

FIG. 67 depicts a view of the plurality of motors 1002 (the motor 1002A and the motor 1002B) and the master gear 1040. As may be seen, the motor 1002A and motor 1002B each rotate a respective motor output shaft coupled to a respective planet gear (a pinion 1017A and a pinion 1017B). The two pinions 1017 each respectively engage the master gear 1040. The two pinions 1017 transfer torque from the motor output shafts to the master gear 1040 around the stationary shaft 1004. In an embodiment, the two pinions 1017 and the master gear 1040 may achieve a mechanical reduction.

FIG. 68 depicts the two pinions 1017 and the master gear 1040 positioned inside the gear sleeve 1023. The gear sleeve 1023 may help provide support for the stationary shaft 1004 on a right most end thereof. As may be seen in FIGS. 65 and 70, the gear sleeve 1023 may include a seat 1025 that may accommodate an end of the stationary shaft 1004. The bearing 1026 may create a rotatable coupling between the master gear 1040 and the stationary shaft 1004.

In FIG. 70, it may be seen that the input pulley 1019 may nest into an inset portion 1042 of the master gear 1040. The inset portion 1042 may comprise a cylindrical space and a portion of the input pulley 1019 may include a cylinder-shaped space designed to fit into the inset portion 1042. The input pulley 1019 may be press fit into the master gear 1040.

In examples, the input pulley 1019 may include one or more bearing seats 1043 for one or more bearings 1044. In examples, the one or more bearings 1044 may comprise two bearings. The one or more bearings 1044 may rotatably couple the input pulley 1019 and the master gear 1040 to the stationary shaft 1004.

Turning to FIG. 69, it may be seen that motive power may be transferred via a timing belt 1028 to an output pulley 1029. In an embodiment the output pulley 1029 may have a diameter D1 that is smaller than a diameter D2 of the input pulley 1019. This may be possible especially if the gearing on the circular saw 1000 is reduced via the two pinions 1017 and the master gear 1018. By making the diameter D1 smaller than the diameter D2, this may speed up the rotation of the output pulley 1029 and the rotating saw blade. Making the diameter D1 smaller may also allow for a saw blade flange 1030 that is smaller, allowing for a larger depth of cut.

As may be seen in FIG. 69, the gear sleeve 1023 may further include one or more bosses 1027. In an example embodiment, there may be four bosses. The one or more bosses 1027 may be used to align, couple, and/or nest with companion features on the gear and motor adapter 1016 and/or the pulley cap 1031, as may be seen in FIG. 65.

Turning to FIG. 66, a cooling path 1032 is depicted via several lines with arrows. The cooling path 1032 represents an air path through the circular saw 1000 according to an embodiment. The cooling path 1032 may be configured to cool any combination of the plurality of motors 1002 and/or the motor electronics 1022. In embodiments, the cooling path 1032 may be passive or active. For example, air that flows in the cooling path 1032 may be driven by fans internal to the multi-motor drive unit 1050.

In an embodiment, the cooling path 1032 may begin with an air inlet positioned just above or adjacent to the trigger 1033 (not shown) on the handle assembly 1008 (the air entering the handle assembly 1008 is represented by the arrow adjacent to the trigger 1033). In an embodiment, the air inlet may be positioned in the grip 1034 (i.e., see air inlet 1035 in FIGS. 64 and 66) of the handle assembly 1008 (the air entering the handle assembly is represented by the arrow adjacent to the air inlet 1035). In an embodiment, the air inlet may be positioned in a battery receptacle 1011 (i.e., see air inlet 1036 in FIG. 66). In an embodiment, the air flowing in the cooling path 1032 may enter a top side of the handle assembly 1008 above and/or behind the multi-motor drive unit 1050 (when the circular saw 1000 is in an operational position) and continue towards the rear of the handle assembly 1008 into the grip 1034.

Air in the cooling path 1032 may next descend through the grip 1034, past motor electronics 1022, and circulate back towards the front of the circular saw 1000 via a bottom section of the handle assembly 1008. Air in the cooling path 1032 may then enter the gear and motor adapter 1016 and move towards the top of the circular saw 1000 to the rear of the multi-motor drive unit 1050, eventually entering each of the plurality of motors 1002. Air may then pass through any combination of the plurality of motors 1002, potentially pushed by one or more fans integral to the plurality of motors 1002, emerging on the opposing side of the gear and motor adapter 1016.

Air in the cooling path 1032 may next exit one or more vents 1037 in the gear sleeve 1023, as depicted in FIG. 68. Air may next flow out of one or more vents 1038 in the pulley cap 1031 and one or more vents 1039 in the left cover 1014 to exit the circular saw 1000.

In embodiments, the circular saw 1000 may include a battery receptacle 1011 and a battery pack 1012. In an embodiment, the battery receptacle 1011 and battery pack 1012 may be positioned over the plurality of motors 1002 and handle assembly 1008. In embodiments, the center of mass of the battery receptacle 1011 and battery pack 1012 may be centered on the plane of the rotating saw blade. By aligning the center of gravity of the battery receptacle 1011 and the battery pack 1012 with the saw blade, it may be possible to more easily balance a center of gravity of the plurality of motors 1002 to intersect the plane of the rotating saw blade. By placing the battery receptacle 1011 and battery pack 1012 between the handle assembly 1008 and the upper blade housing 1006, it may be possible to position the center of gravity of the circular saw 1000 between the handle assembly 1008 and the stabilizing handle 1009. In embodiments, the battery receptacle 1011 may accept a variety of battery pack sizes. In embodiments, the center of gravity of the circular saw 1000 may be balanced between the handle assembly 1008 and the stabilizing handle 1009 irrespective of the size of the battery pack 1012.

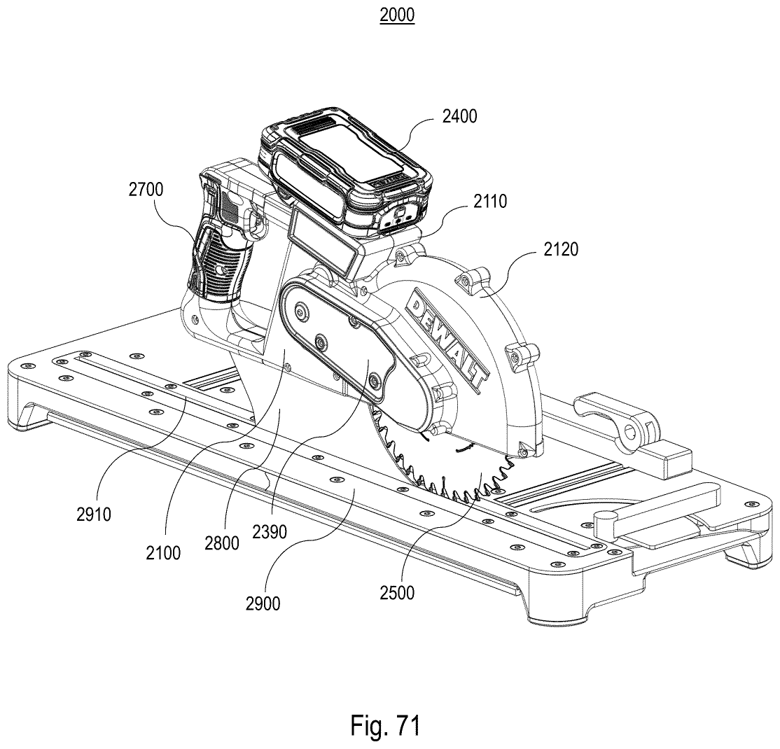

FIGS. 71-74 illustrate an example power-driven tool, in the form of an example multi-purpose saw 2000. The multi-purpose saw 2000 may be referred to interchangeably throughout as a riving knife suspended saw. The multi-purpose saw 2000 may be driven by a multi-motor drive unit, in accordance with the principles described herein. In an embodiment, the multi-purpose saw 2000 may include a same or similar drive unit as the drive unit 1050 of the circular saw 1000 of FIGS. 63-70. In an embodiment, the multi-purpose saw 2000 may include other similar components as the circular saw 1000, including for example the transmission components, pulley assembly, and blade.

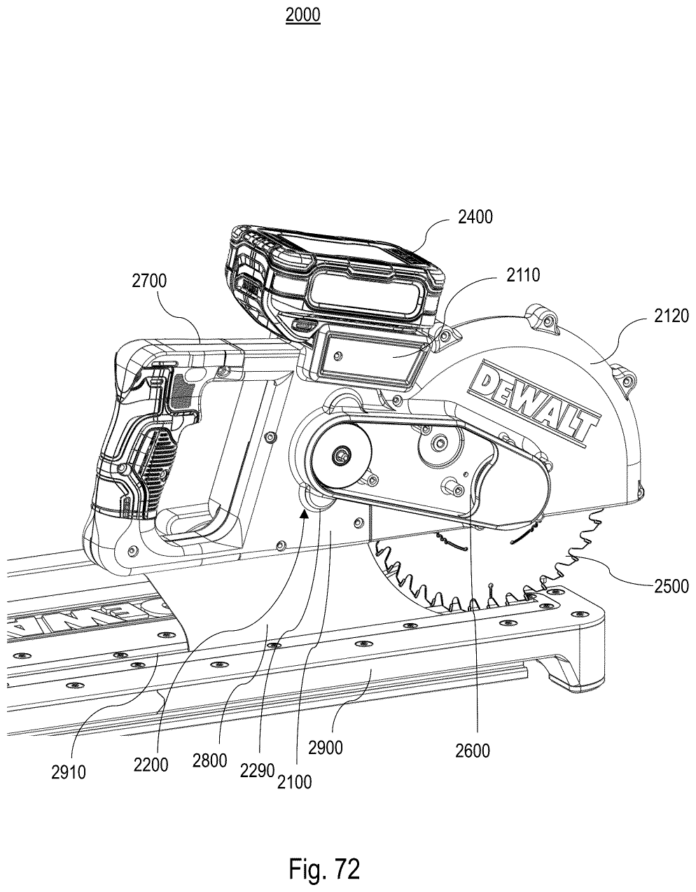

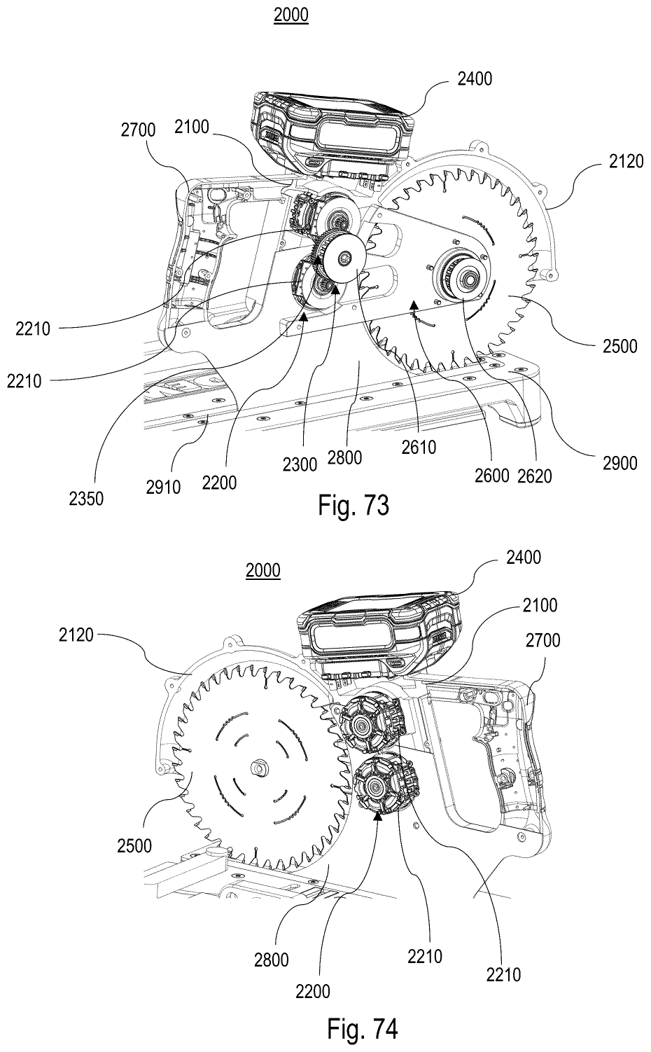

FIG. 71 depicts a front, right isometric view of the multi-purpose saw 2000. FIG. 72 depicts a rear, right isometric view of the multi-purpose saw 2000 of FIG. 71 with a transmission cover removed. FIG. 73 depicts a rear, right isometric view of the multi-purpose saw 2000 of FIG. 71 with the gears exposed. FIG. 74 depicts a rear, left isometric view of the multi-purpose saw 2000 of FIG. 71 with the motors exposed.

In an embodiment, multi-purpose saw 2000 includes a tool housing 2100 in which components, such as, for example, a multi-motor drive unit 2200 (or drive unit) and a transmission 2300, are received. A battery pack 2400 is removably couplable in a battery receptacle 2110 defined by the tool housing 2100, to supply power to the drive unit 2200. The drive unit 2200 and the transmission 2300 output a rotational force in response to power supplied by the battery pack 2400 that rotates a blade 2500. In particular, rotary force generated by the drive unit 2200 is transmitted, via the transmission 2300, to a pulley assembly 2600 to drive the pulley assembly 2600, which in turn rotates the blade 2500. The multi-purpose saw 2000 may include a handle 2700 for user operation of the multi-purpose saw 2000. The blade 2500 is partially received in a blade housing 2120. In an embodiment, the blade housing 2120 is semi-circular in shape, to conform to the shape of the blade 2500. The semi-circular shape of the blade housing 2120 leaves a portion of the blade 2500 exposed, for interaction with a workpiece during operation of the multi-purpose saw 2000, while functioning as a guard for the hand of the user.

In an embodiment, the multi-purpose saw 2000 is coupled or fixed to a riving knife 2800. The riving knife 2800 is slidably engaged with a table 2900 (or work table) through a slot 2910 in the table 2900. The riving knife 2800 supports the multi-purpose saw 2000 through the table 2900 and enables the multi-purpose saw 2000 to slide along the table 2900 without limiting or obstructing the rip cut capacity (e.g., horizontal rip cut capacity) of the multi-purpose saw 2000.

The drive unit 2200 and the transmission 2300 are housed within the tool housing 2100 of the multi-purpose saw 2000, with the front cover 2290 of the drive unit 2200 and a transmission cover 2390 defining corresponding exterior portions of the tool housing 2100. The drive unit 2200 includes a plurality of motors 2210 that are engaged with a master gear 2350 to drive a common shaft. Each of the plurality of motors 2210 may be, for example, a Brushless Direct-Current (BLDC) motor. The motors 2210 may be similar to the motors 200 described above, and thus duplicative detailed description thereof will be omitted except where necessary.

In an embodiment, the drive unit 2200 includes an arrangement of two motors 2210. In an embodiment, the stators of the motors 2210 are in a same radial plane with the blade 2500. Further, longitudinal axes through the pinions of the motors 2210 are parallel to a longitudinal axis through the center of the blade 2500. The drive unit 2200 includes one or more of the features described above with respect to drive unit 100, drive unit 500 and/or drive unit 1050 of the circular saw 1000 including a motor adapter, a sleeve, a rear cover, and a front cover 2290, where some of the components are not illustrated in this example, because they are described above in detail.

Motors 2210 may be positioned with rotational axes that are parallel to the rotational axis of the blade 2500. Each of the motors 2210 may be positioned at approximately the same radial distance from a rotational axis of the blade 2500 towards the rear of the multi-purpose saw 2000. The motors 2210 may be positioned towards the rear of the multi-purpose saw 2000 between the handle 2700 and blade 2500 housed within the blade housing 2120. By positioning the motors 2210 in the plane of the blade 2500 instead of adjacent to the plane of the blade 2500, the multi-purpose saw 2000 is narrower along the rotational axis of the blade 2500 than other conventional saws. The narrower multi-purpose saw 2000 profile may facilitate ambidextrous use of the multi-purpose saw 2000.

In an embodiment, the transmission 2300 may be included as part of the drive unit 2200, as in some of the drive units described above. In an embodiment, the transmission 2300 may be considered separate from the drive unit 2200, but cooperatively engaged with the drive unit 2200. The transmission 2300 includes the master gear 2350 that engages and meshes with the pinions of the motors 2210. In an embodiment, the pulley assembly 2600 includes an input pulley 2610 and an output pulley 2620 coupled together by a belt (not shown). The input pulley 2610 engages with the master gear 2350 and transfers rotational motion to the output pulley 2620 via the belt. In an embodiment, the belt may include a timing belt or a toothed timing belt.

In an embodiment, the compact assembly of the multi-purpose saw 2000 based on the location of the drive unit 2200 and the transmission 2300 provides for maximum visibility for the user making cuts on a workpiece with the multi-purpose saw 2000. In an embodiment, the center of gravity for the multi-purpose saw 2000 is centered over the plane of the riving knife 2800. A center of the handle 2700 is coplanar with the blade 2500 and the feed direction of a workpiece. The handle 2700 is also in line with the center of gravity of the multi-purpose saw 2000. The rotating moments of inertia are balanced about the riving knife 2800. In this manner, there is no off-axis torque upon startup (when power is first supplied to the motors 2210 to drive the blade 2500) or during operation. The reduced system inertia decreases spin up and braking time.

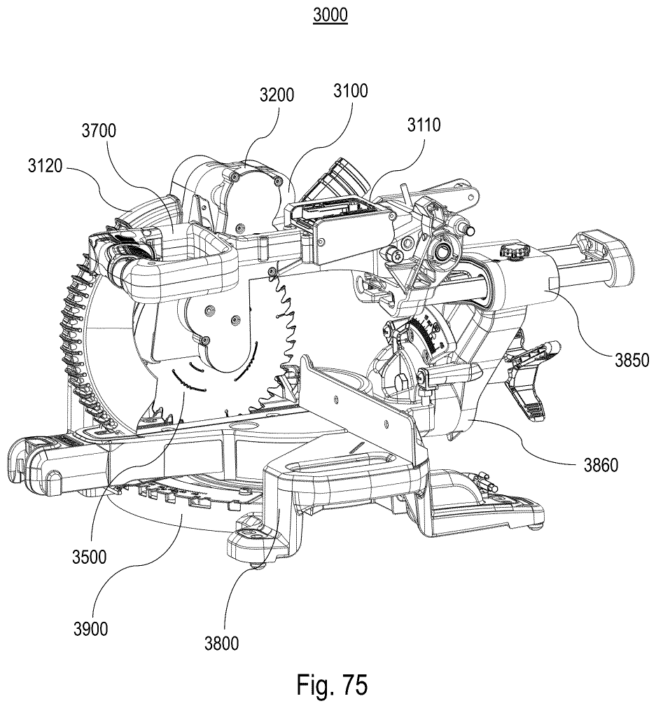

FIGS. 75-81 illustrate an example power-driven tool, in the form of an example miter saw 3000. The miter saw 3000 may be driven by a multi-motor drive unit, in accordance with the principals describe herein. In an embodiment, the miter saw 3000 may include a same or similar drive unit as the drive unit 1050 of the circular saw 1000 or the drive unit 2200 of the multi-purpose saw 2000.

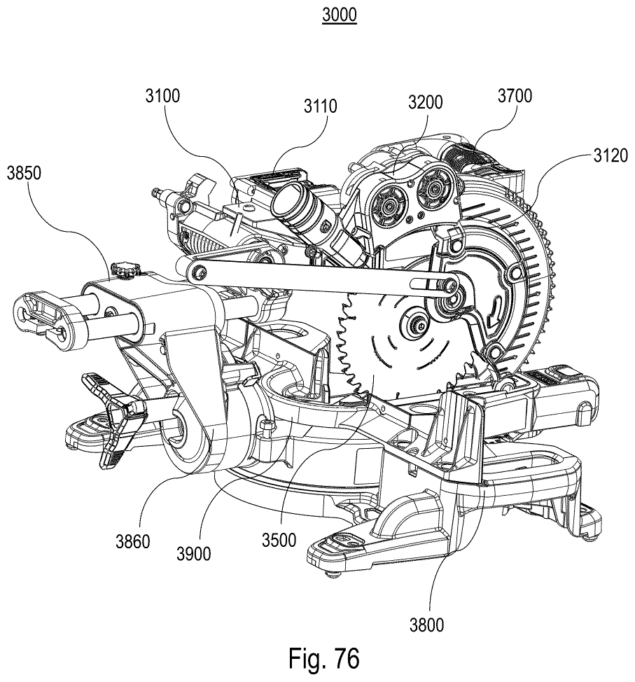

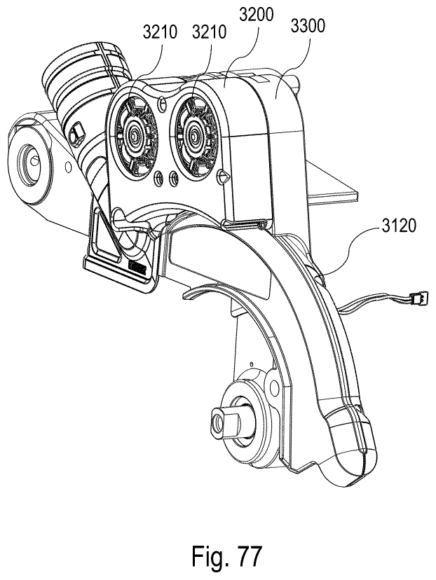

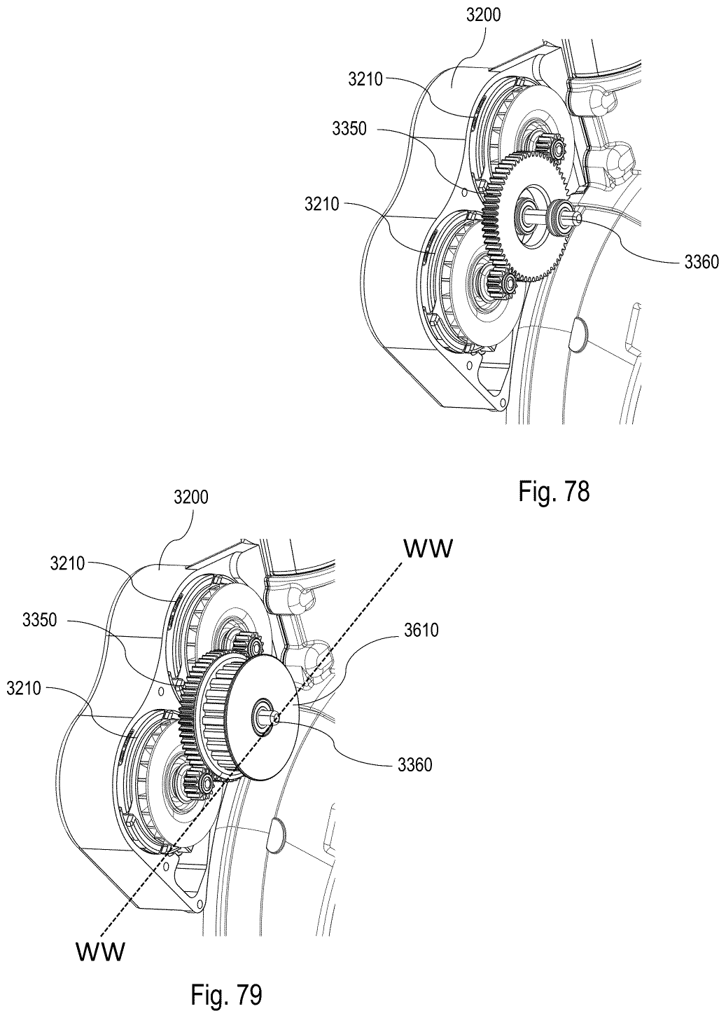

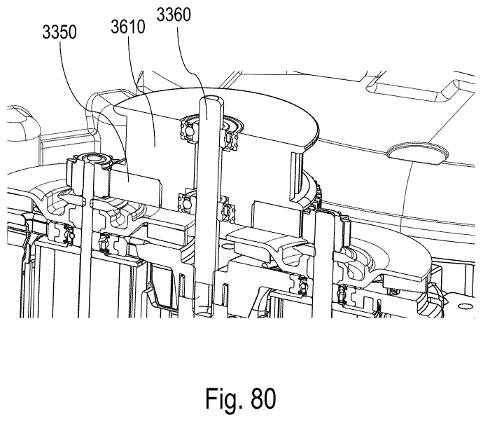

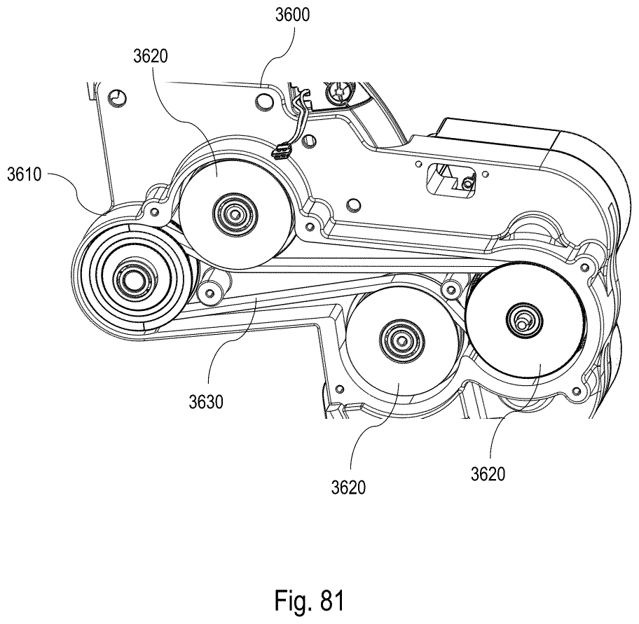

FIG. 75 depicts a perspective view of an example miter saw 3000. FIG. 76 depicts another perspective view of the miter saw 3000 of FIG. 75 with some components exposed. FIG. 77 depicts a perspective view of the multi-motor drive unit of the miter saw 3000 of FIG. 75 as disposed on the blade housing. FIG. 78 depicts a perspective view of the multi-motor drive unit and the transmission of the miter saw 3000 of FIG. 75. FIG. 79 depicts a perspective view of the multi-motor drive unit and the transmission of the miter saw 3000 of FIG. 75 with the master pulley attached to the master gear. FIG. 80 depicts a partial cross-sectional view WW centered on the master pulley of the miter saw 3000 of FIG. 75, with the cross-section WW represented in FIG. 79. FIG. 81 depicts a perspective view of the pulley assembly of the miter saw 3000 of FIG. 75. U.S. Pat. Nos. 7,252,027 and 9,707,633 describe general features and functionality of a miter saw and are hereby incorporated by reference in their entirety.

In an embodiment, miter saw 3000 includes a tool housing 3100 in which components, such as, for example, a multi-motor drive unit 3200 (or drive unit) and a transmission 3300, are received. A battery pack (not shown) is removably coupled in a battery receptacle 3110 defined by the tool housing 3100, to supply power to the drive unit 3200. The drive unit 3200 and the transmission 3300 output a rotational force in response to power supplied by the battery pack that rotates a blade 3500. In particular, rotary force generated by the drive unit 3200 is transmitted, via the transmission 3300, to a pulley assembly 3600 to drive the pulley assembly 3600, which in turn rotates the blade 3500. A handle 3700 provide for user operation of the miter saw 3000. The blade 3500 is partially received in a blade housing 3120. In an embodiment, the blade housing 3120 is semi-circular in shape, to conform to the shape of the blade 3500. The semi-circular shape of the blade housing 3120 leaves a portion of the blade 3500 exposed, for interaction with a workpiece during operation of the miter saw 3000, while functioning as a guard for the hand of the user.

In an embodiment, the miter saw 3000 has a base assembly 3800, including a rotatable table 3900 rotatably connected to the base assembly 3800. The miter saw 3000 has a saw assembly that includes drive unit 3200, transmission 3300, pulley assembly 3600, blade 3500, and a pivot arm 3850 that is pivotally attached to rotatable table 3900 via a pivot junction 3860 and supporting the saw assembly. Pivot arm 3850 may support connected to the saw assembly, allowing a user to move the saw assembly downwardly and away from the base assembly 3800 for cutting a workpiece. Persons skilled in the art shall recognize that pivot arm 3850 may support one or more sliding rails connected to the saw assembly, allowing a user to horizontally move the saw assembly towards and away from the front of the base assembly 3800.

The drive unit 3200 and the transmission 3300 are housed within the tool housing 3100 of the miter saw 3000, with the front cover 3290 of the drive unit 3200 and a transmission cover 3390 defining corresponding exterior portions of the tool housing 3100. The drive unit 3200 includes a plurality of motors 3210 that are engaged with a master gear 3350 rotating on a stationary shaft 3360. Each of the plurality of motors 3210 may be, for example, a Brushless Direct-Current (BLDC) motor. The motors 3210 may be similar to the motors 200 described above, and thus duplicative detailed description thereof will be omitted except where necessary.

In an embodiment, the drive unit 3200 includes an arrangement of two motors 3210. In an embodiment, the drive unit 3200 and the motors 3210 are located at the top of the miter saw 3000 in line with the blade 3500 with the axes of rotation of the motors 3210 in parallel with the blade 3500. Further, longitudinal axes through the pinions of the motors 3210 are parallel to a longitudinal axis through the center of the blade 3500. The drive unit 3200 includes one or more of the features described above with respect to drive unit 100, drive unit 500 and/or drive unit 1050 of circular saw 1000 including a motor adapter, a sleeve, a rear cover, and a front cover 3290, where some of the components are not illustrated in this example, because they are described above in detail.

In an embodiment, the transmission 3300 may be included as part of the drive unit 3200, as in some of the drive units described above. In an embodiment, the transmission 3300 may be considered separate from the drive unit 3200, but cooperatively engaged with the drive unit 3200. The transmission 3300 includes the master gear 3350 that engages and meshes with the pinions of the motors 3210. The master gear 3350 rotates around the stationary shaft 3360. The gear reduction from the motors 3210 to the master gear 3350 may be approximately a 60:13 gear reduction.

In an embodiment, pulley assembly 3600 includes an input pulley 3610 and multiple output pulleys 3620 coupled together by a belt 3630. The input pulley 3610 engages with the master gear 3350 and transfers rotational motion to the output pulleys 3620 via the belt 3630. In an embodiment, the master gear 3350 is pressed onto input pulley 3610, which may be a ribbed timing pulley. In an embodiment, the belt 3630 may include a timing belt or a toothed timing belt. The pulley assembly 3600 uses smaller pulleys than a conventional miter saw and thus achieves increased blade speed and cutting performance. With less gear contact, belt noise from the belt 3630 may be reduced compared to a conventional miter saw.

In an embodiment, the compact assembly of the miter saw 3000 based on the location of the drive unit 3200 and the transmission 3300 provides for maximum visibility for the user making cuts on a workpiece with the miter saw 3000. In an embodiment, the center of gravity for the miter saw 3000 is coplanar with the blade 3500 and centered about the pivot arm 3850. There is a decreased weight realized for the miter saw 3000 compared to a conventional miter saw. Making the center of gravity coplanar with the blade 3500 avoids torsional moments as well as mitigates some of amount of overall system inertia. In an embodiment, a weight or weights may be added to the drive unit 3200 and/or the motors 3210 to match the inertia between the blade 3500 and the motors 3210 to cancel out the total system inertia during startup and shutdown, which may have the effect of eliminating and/or reducing kick on startup or stop.

By placing the drive unit 3200 and the transmission 3300 close to the miter saw 3000 centerline, an overall thinner profile of the miter saw 3000 is achieved which mitigates out-of-plane torsion and assists in ensuring a more exact cut on a workpiece. With the pulley assembly 3600 as close to blade housing 3120 the miter saw 3000 width is reduced and in-cut visibility is increased for the user.

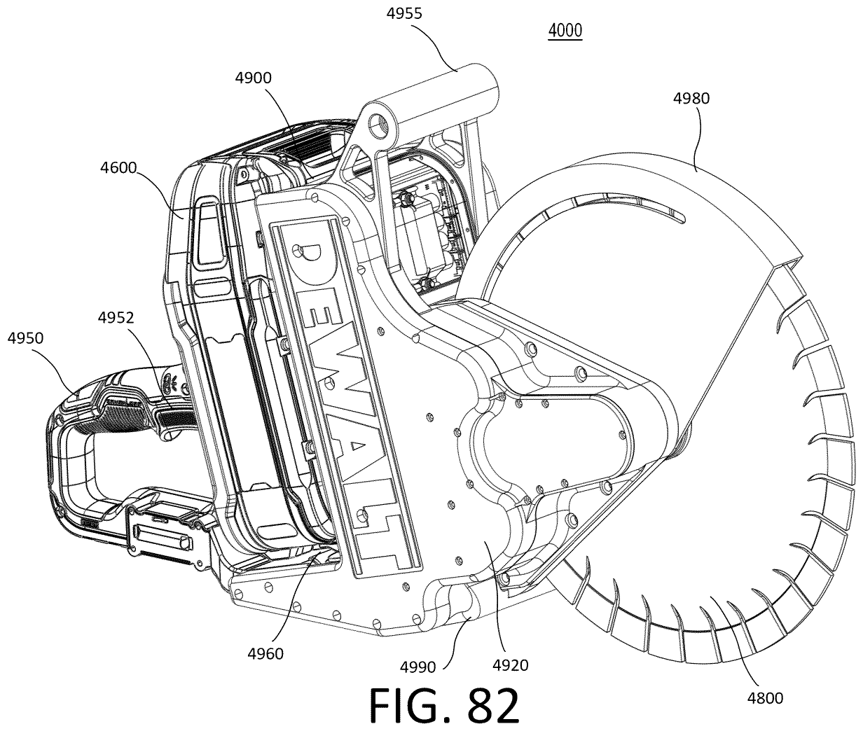

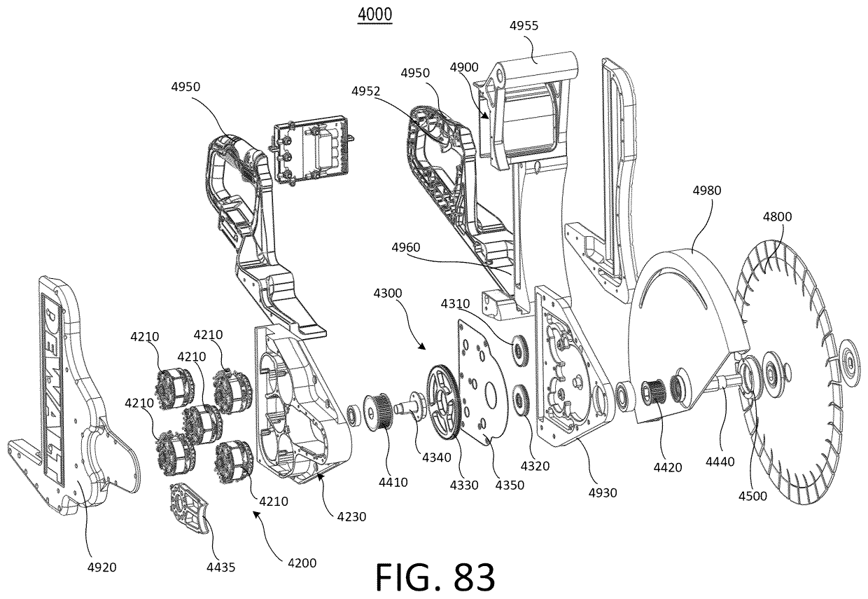

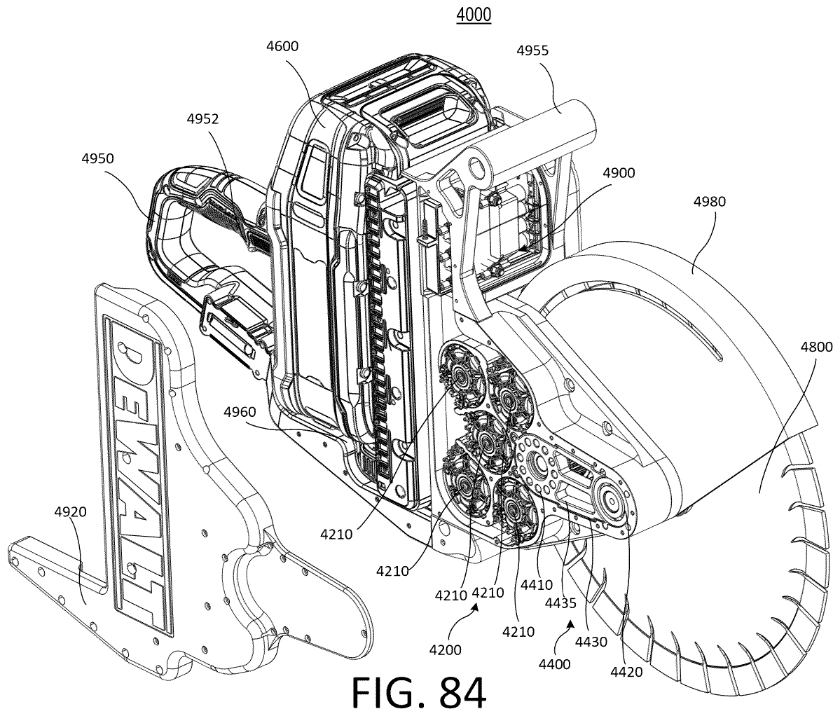

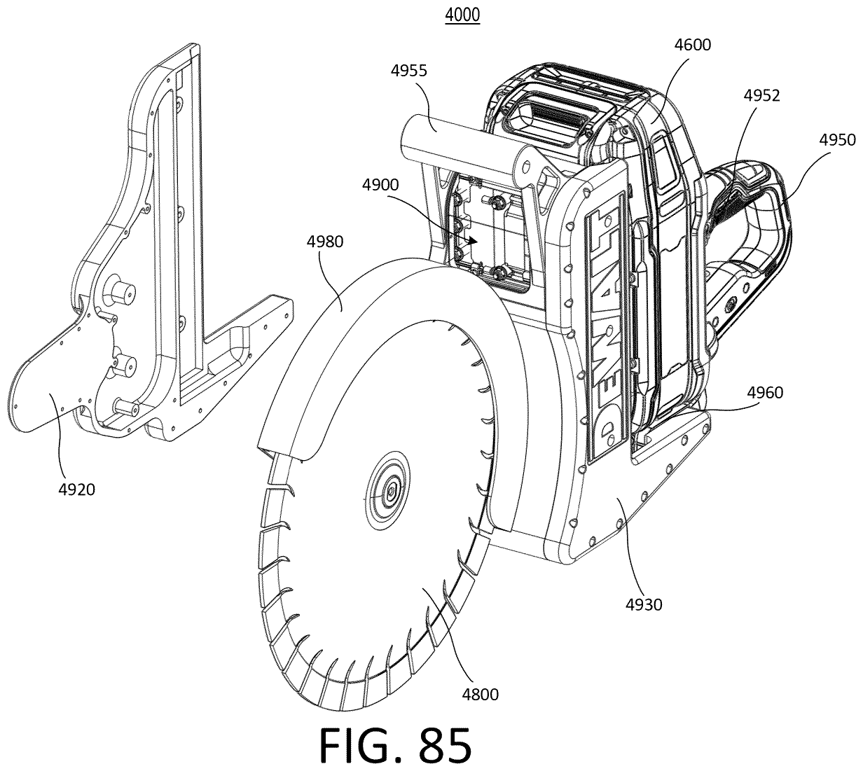

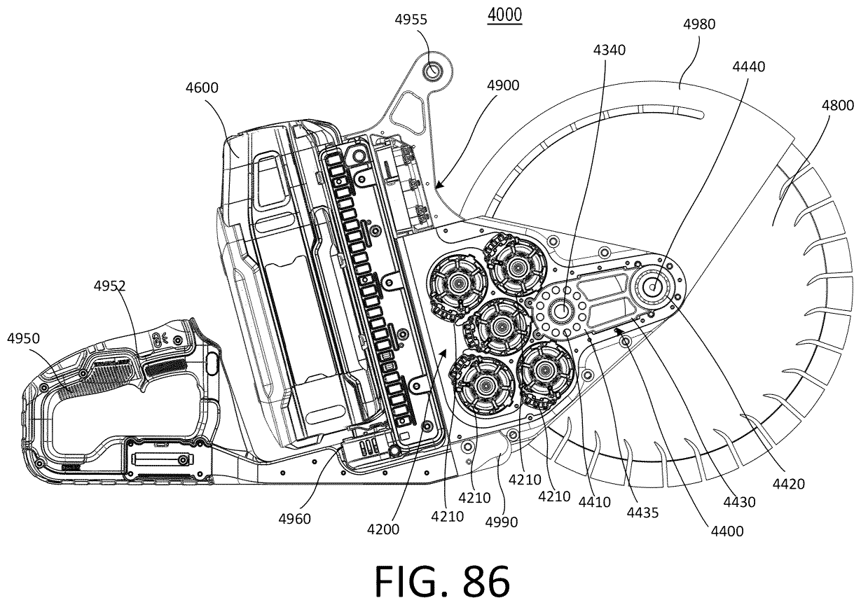

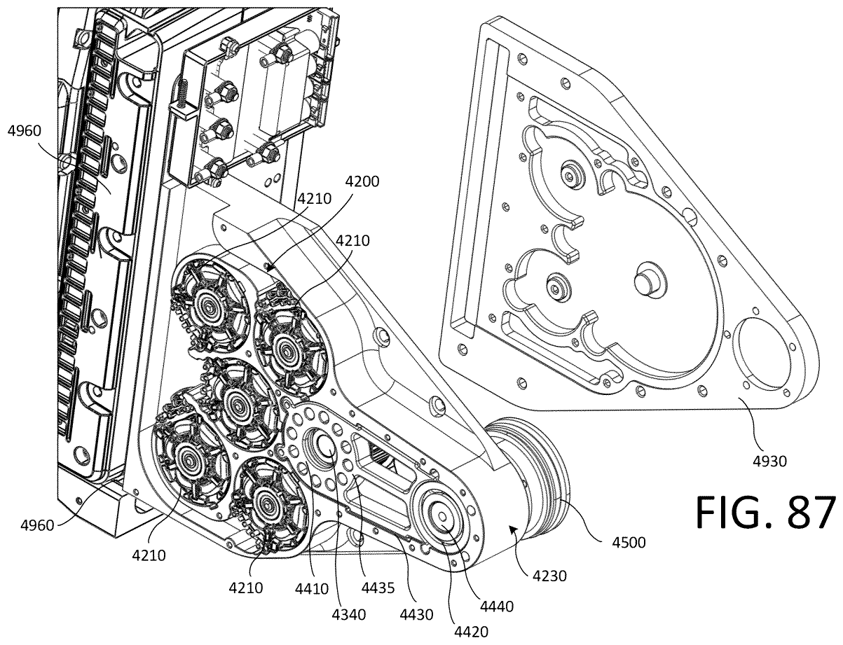

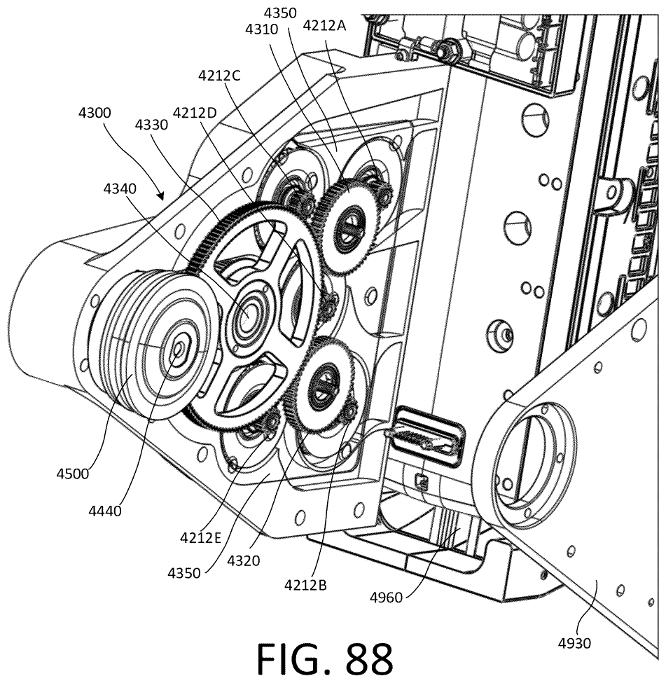

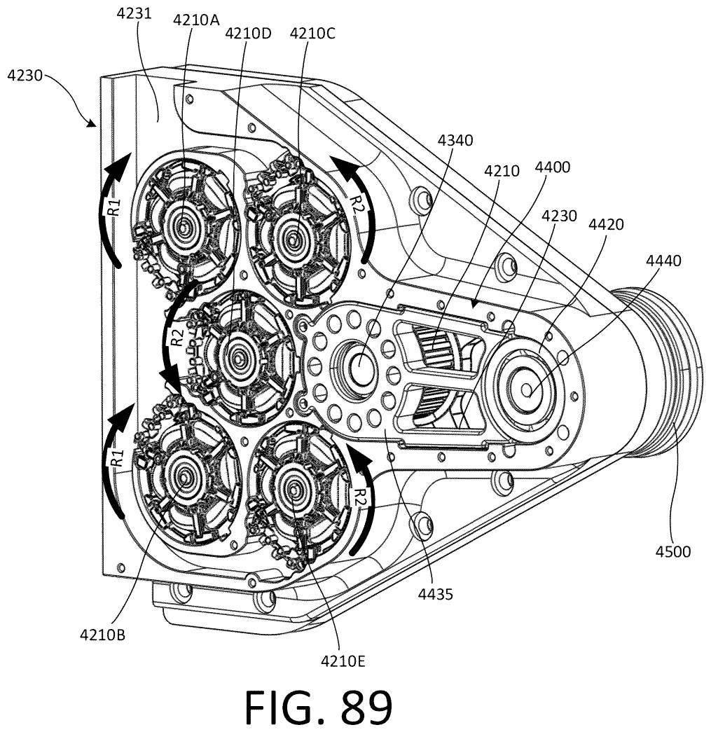

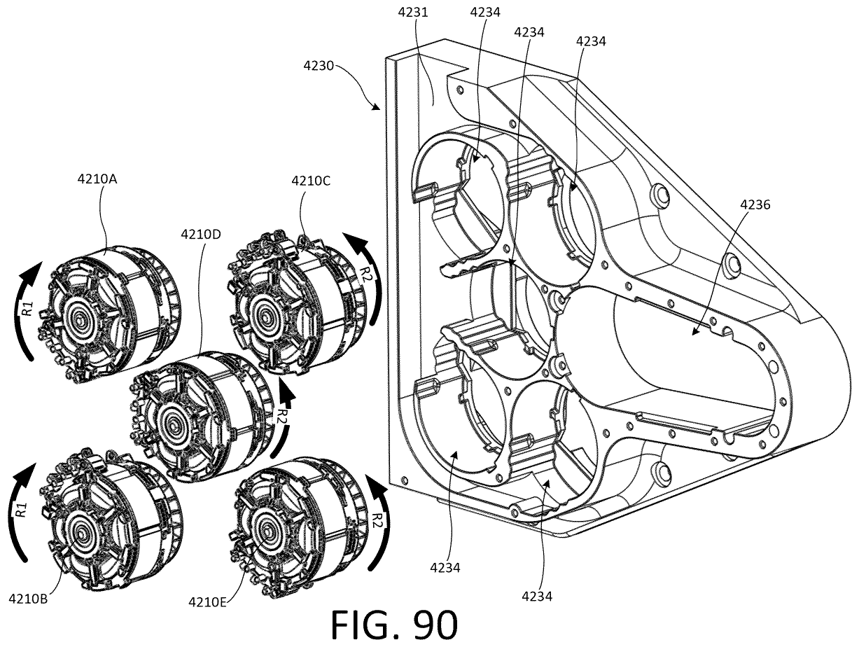

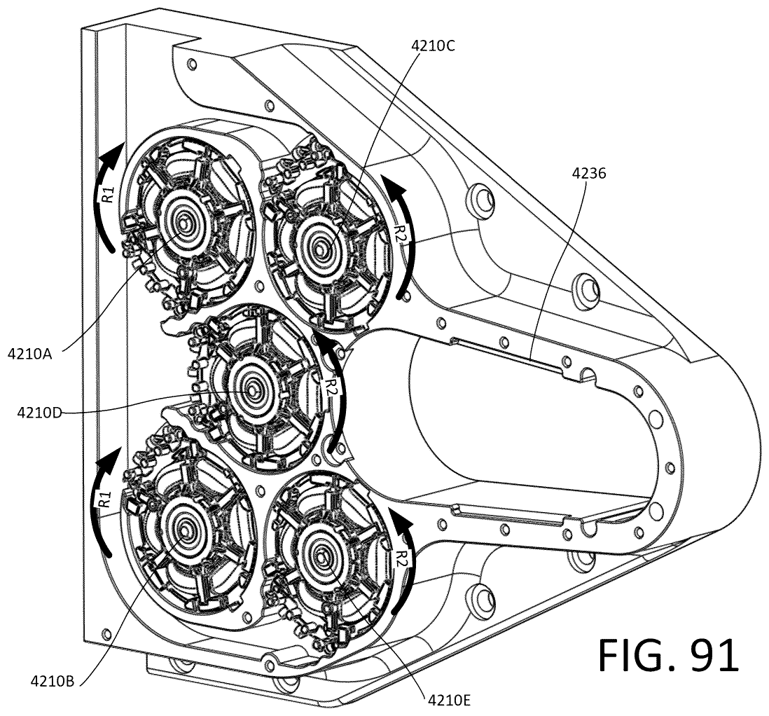

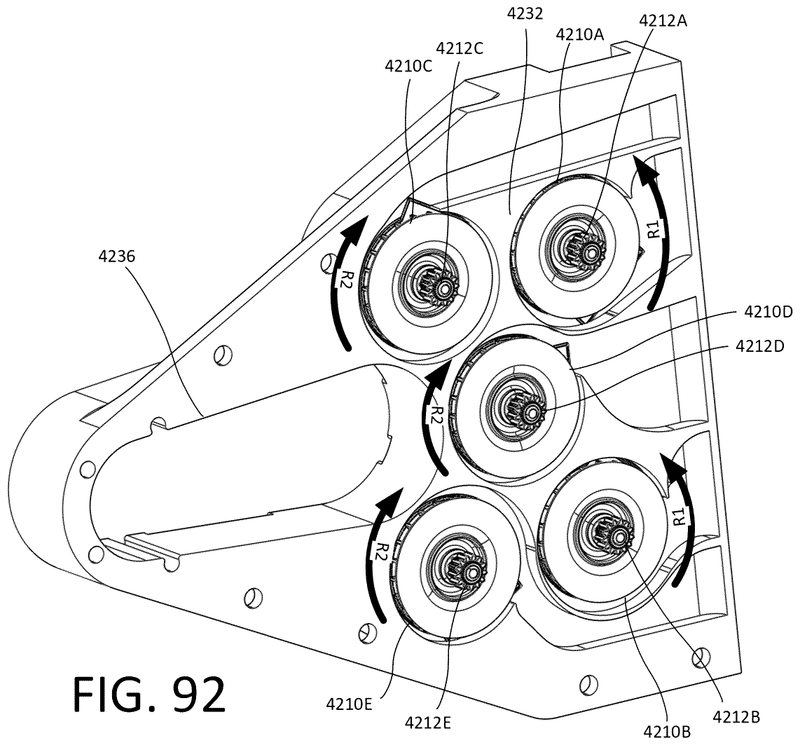

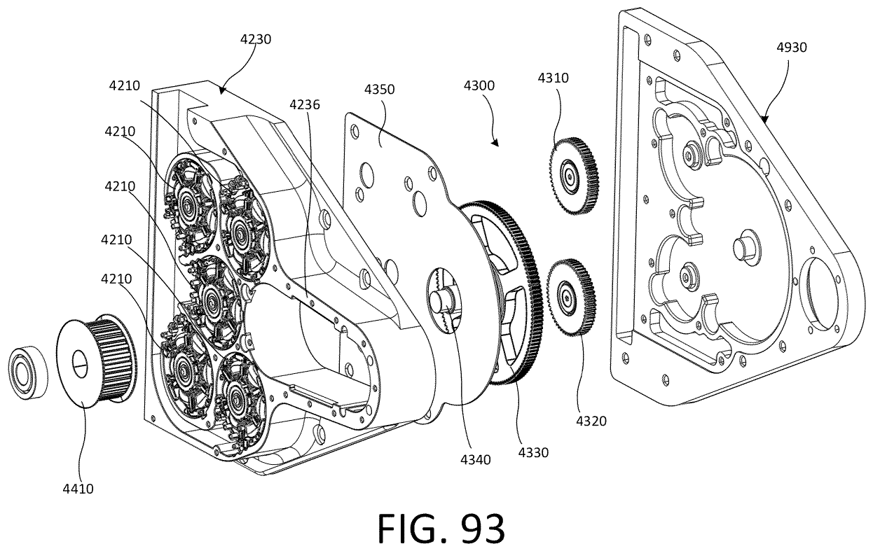

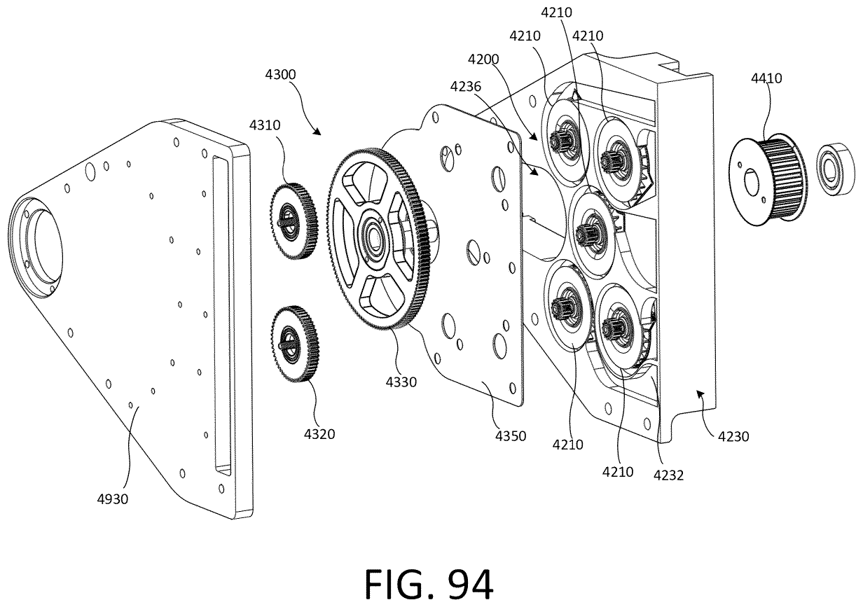

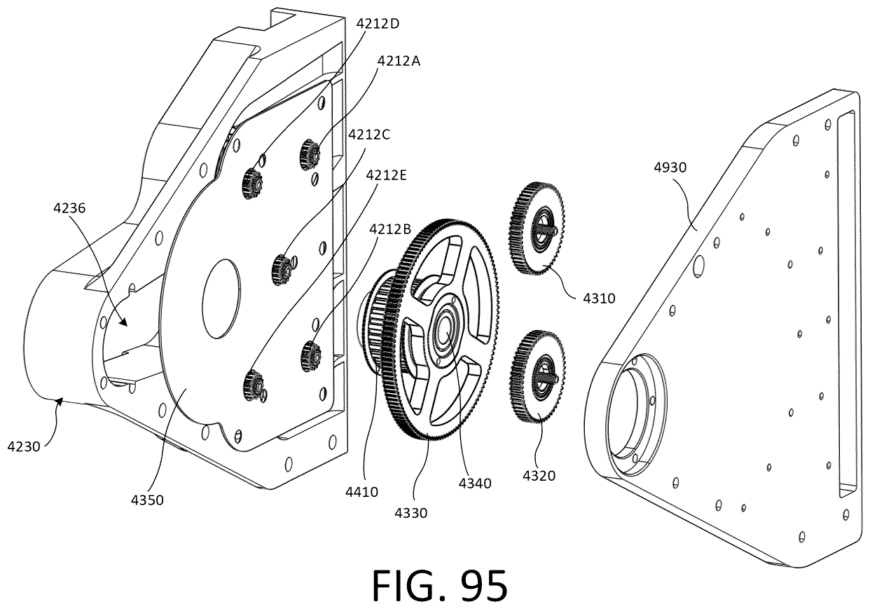

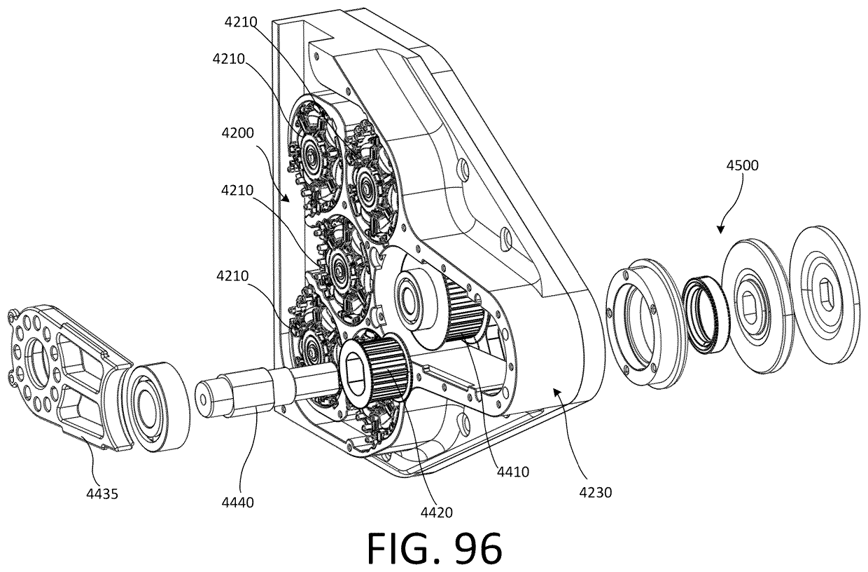

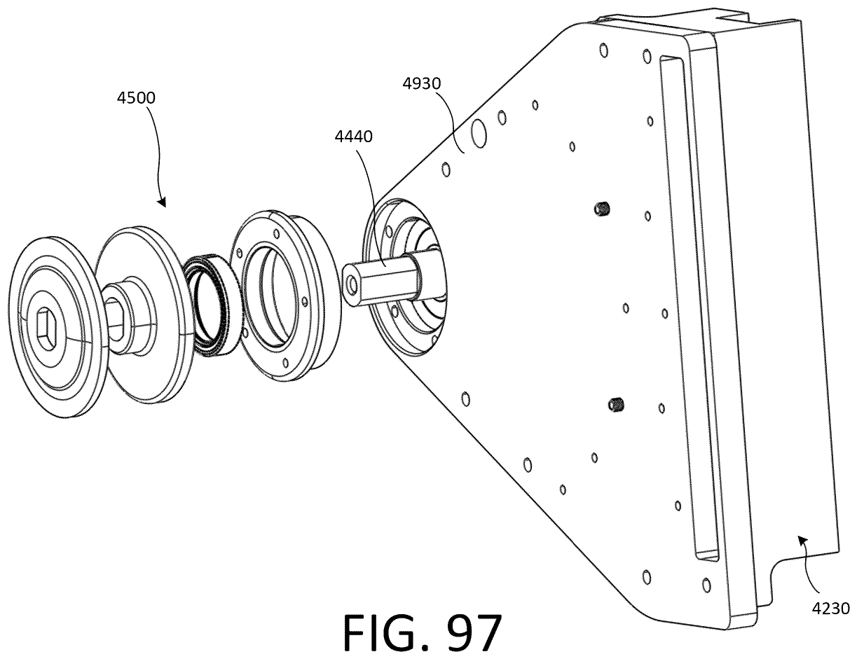

FIGS. 82-95 illustrate an example power-driven tool, in the form of an example concrete saw 4000, which may be driven by a multi-motor drive unit, in accordance with the principles described herein. In particular, FIG. 82 is an assembled perspective view, and FIG. 83 is an exploded perspective view, of the example concrete saw 4000. FIG. 84 is a perspective view from a first side of the example concrete saw 4000, FIG. 85 is a perspective view from a second side of the example concrete saw 4000, and FIG. 86 is a side view of the first side of the example concrete saw 4000. In FIGS. 84-86, a motor cover 4920 of the example concrete saw 4000 has been removed so that components of an example multi-motor drive unit 4200 installed in a tool housing 4900 of the example concrete saw 4000 are visible. FIG. 87 is a perspective view from the first side of the example concrete saw 4000, and FIG. 88 is a perspective view from the second side of the example concrete saw. In FIGS. 87 and 88, the motor cover 4920 and a transmission cover 4930 are removed so that an arrangement of the components of the multi-motor drive unit 4200 and a transmission 4300 are visible. FIG. 89 is an assembled perspective view, and FIG. 90 is a partially exploded perspective view of the example multi-motor drive unit 4200. FIG. 91 is a perspective view from the first side of the example concrete saw, and FIG. 92 is a perspective view from the second side of the example concrete saw, with the transmission cover 4930 and a pulley assembly 4400 removed, illustrating an arrangement of motors 4210 of the example multi-motor drive unit 4200. FIG. 93 is a partially exploded perspective view from the first side of the example concrete saw 4000, and FIG. 94 is a partially exploded perspective view from the second side of the example concrete saw 4000, illustrating components of the multi-motor drive unit 4200 and the transmission 4300. FIG. 95 is a partially exploded perspective view illustrating components of the transmission 4300. FIG. 96 is a partially exploded view of the example pulley assembly 4400 example hub assembly 4500, from the first side of the multi-motor drive unit 4200. FIG. 97 is an exploded view of the example hub assembly 4500, from the second side of the multi-motor drive unit 4200.

The example concrete saw 4000 includes a tool housing 4900 in which components, such as, for example, a multi-motor drive unit 4200 and a transmission 4300, are received. A battery pack 4600 is removably couplable in a battery receptacle 4960 defined by the tool housing 4900, to supply power to the multi-motor drive unit 4200. The multi-motor drive unit 4200 and the transmission 4300 output a rotational force in response to power supplied by the battery pack 4600 that rotates a blade 4800. In particular, rotary force generated by the multi-motor drive unit 4200 is transmitted, via the transmission 4300, to a pulley assembly 4400 to drive the pulley assembly 4400, which in turn rotates the blade 4800. A first handle portion 4950 and a second handle portion 4955 provide for user operation of the concrete saw 4000. In some examples, a first hand of the user may grip the first handle portion 4950, and a second hand of the user may grip the second handle portion 4955. In some examples, a trigger 4952 provided on the first handle portion 4950 may be engaged to provide for operation of the concrete saw 4000. In some examples, the second handle portion 4955 may provide for stabilizing and guiding the concrete saw 4000 during operation. In some examples, the concrete saw 4000 may be used ambidextrously. For example, the first handle portion 4950 may be gripped by one of a left hand or a right hand or the user, and the second handle portion 4955 may be gripped by the other of the left hand or the right hand of the user, to accommodate user preferences for operation of the concrete saw 4000. The blade 4800 is partially received in a blade guard 4980. In this example, the blade guard 4980 is semi-circular in shape, to conform to the shape of the blade 4800. The semi-circular shape of the blade guard 4980 leaves a portion of the blade 4800 exposed, for interaction with a workpiece during operation of the concrete saw 4000, while functioning as a guard for the hand of the user on the second handle portion 4955 during operation of the concrete saw 4000.

The multi-motor drive unit 4200 and the transmission 4300 of the example concrete saw 4000 will be described in more detail with respect to FIGS. 87-95. The multi-motor drive unit 4200 and the transmission 4300 are housed within the tool housing 4900 of the example concrete saw 4000, with the motor cover 4920 and the transmission cover 4930 defining corresponding exterior portions of the tool housing 4900. The multi-motor drive unit 4200 includes a plurality of motors 4210 that are engaged with a common output gear to cooperatively drive a common output shaft. Each of the plurality of motors 4210 may be, for example, a Brushless Direct-Current (BLDC) motor. The motors 4210 may be similar to the motors 200 described above, and thus duplicative detailed description thereof will be omitted except where necessary.

As shown in FIGS. 87-91, the multi-motor drive unit 4200 includes an arrangement of five motors 4210, each mounted in a corresponding opening 4234 in a motor adapter 4230. The motor adapter 4230 includes a first side 4231 defining an intake side of the multi-motor drive unit 4200, and a second side 4232 defining an exhaust side of the multi-motor drive unit 4200. In this example arrangement, some of the motors 4210 rotate in a first direction, for example, a clockwise direction as illustrated by the arrows R1 in the orientation shown in FIGS. 89 and 91, in response to power supplied to the motors 4210 from the battery pack 4600. In this example arrangement, some of the motors 4210 rotate in a second direction, for example, a counterclockwise direction as illustrated by the arrows R2 in the orientation shown in FIGS. 89 and 91, in response to power supplied to the motors 4210 from the battery pack 4600. In the example arrangement shown in FIGS. 89-92, a first motor 4210A and a second motor 4210B rotate in the direction of the arrows R1, and a third motor 4210C, a fourth motor 4210D, and a fifth motor 4210E rotate in the direction of the arrows R2. Rotation of the motors 4210 in this manner causes corresponding rotation of pinions 4212 of the motors 4210. In particular, as shown in FIG. 92, a pinion 4212A of the first motor 4210A and a pinion 4212B of the second motor 4210B rotate in the direction of the arrows R1 (corresponding to the rotation of the motors 4210A, 4210B), and a pinion 4212C of the third motor 4210C, a pinion 4212D of the fourth motor 4210D, and a pinion 4212E of the fifth motor 4210E rotate in the direction of the arrows R2 (corresponding to the rotation of the motors 4210C, 4210D, 4210E), in response to the above described rotation of the motors 4210.

The transmission 4300 is coupled to the plurality of motors 4210 of the multi-motor drive unit 4200 to receive a driving force, for example, a rotational driving force, and transmit the driving force to the blade 4800 for rotation of the blade 4800. As shown in FIGS. 88, 92-96, in some examples, a plate 4350 is positioned in the motor adapter 4230, between the multi-motor drive unit 4200 and the transmission 4300. In this example arrangement, the transmission 4300 includes a first idler gear 4310 and a second idler gear 4320, each rotatably mounted on a respective shaft coupled on the motor adapter 4230. The first idler gear 4310 is in meshed engagement with the pinion 4212A of the first motor 4210A, such that the first idler gear 4310 rotates in response to rotation of the first motor 4210A, and transfers the rotary force to a master gear 4330. Similarly, the second idler gear 4320 is in meshed engagement with the pinion 4212B of the second motor 4210B, such that the second idler gear 4320 rotates in response to rotation of the second motor 4210B, and transfers the rotary force to the master gear 4330. Thus, the master gear 4330 rotates in response to rotation of the first idler gear 4310 and/or the second idler gear 4320. The pinion 4212C of the third motor 4210C, the pinion 4212D of the fourth motor 4210D, and the pinion 4212E of the fifth motor 4210E are each in meshed engagement with the master gear 4330, such that the master gear 4330 rotates in response to rotation of the third motor 4210C and/or the fourth motor 4210D and/or the fifth motor 4210E. The master gear 4330 is mounted on a driving shaft 4340 that rotates together with the master gear 4330. Rotation of the driving shaft 4340 drives the pulley assembly 4400, which in turn provides for rotation of the blade 4800.

The pulley assembly 4400 is received in an opening 4236 in the motor adapter 4230. The pulley assembly 4400 includes a first pulley 4410, or a driven pulley positioned at a first end portion of the opening 4236, and a second pulley 4420, or a driving pulley positioned at a second end portion of the opening 4236, with a belt 4430 coupling the first pulley 4410 and the second pulley 4420. The first pulley 4410 is mounted on the driving shaft 4340, such that the first pulley 4410 rotates together with the master gear 4330 and the driving shaft 4340. The second pulley 4420 is mounted on an output shaft 4440, such that the output shaft 4440 rotates together with the second pulley 4420. The belt 4430 extends around an outer circumferential surface of the first pulley 4410 and an outer circumferential surface of the second pulley 4420, such that the belt 4430 transfers a rotational force from the first pulley 4410 to the second pulley 4420 and the second pulley 4420 rotates in response to rotation of the first pulley 4410 (and the master gear 4330/driving shaft 4340). In some examples, the second pulley 4420 is smaller than the first pulley 4410, for example, a diameter of the second pulley 4420 is smaller than a diameter of the first pulley 4410. This may provide for an increase in rotational speed output to the blade 4800, while maintaining a relatively small profile. In some examples, a tensioner 4435 between the first pulley 4410 and the second pulley 4420, to maintain a relative position of the first pulley 4410 and the second pulley 4420, and alignment of the belt 4430. A hub assembly 4500 couples the output shaft 4440 to a hub portion of the blade 4800, to transmit a rotary force from the pulley assembly 4400 to the blade 4800, to provide for rotation of the blade 4800.

In operation, in response to an application of power to the motors 4210 (for example, user manipulation of the trigger 4952), the motors 4210 generate a rotary force. The rotary force generated by the motors 4210 is transmitted, by the transmission 4300, to the pulley assembly 4400, where the rotary force is output to the blade 4800, causing the blade 4800 to rotate to perform an operation on a workpiece.

In this example arrangement, the motors 4210 and the pulley assembly 4400 are coupled in the motor adapter 4230 in a substantially planar arrangement, with the components of the transmission 4300 arranged on an opposite side of the motor adapter 4230. This results in a relatively small profile associated with the multi-motor drive unit 4200/pulley assembly 4400/transmission 4300. This narrower profile, for example, in the direction of the axis of rotation of the blade 4800, may provide for a more compact overall profile of the concrete saw 4000, improving lateral cut clearances (i.e., clearances from walls, edges and the like), and allowing for maximum depth of cut of the concrete saw 4000. This relatively compact arrangement of the multi-motor drive unit 4200, transmission 4300, and pulley assembly 4400 may also facilitate ambidextrous use of the concrete saw 4000.

This relatively compact arrangement of the multi-motor drive unit 4200, transmission 4300, and pulley assembly 4400, and positioning proximate the blade 4800, allow for a more forward, upright orientation of the battery pack 4600 installed in the battery receptacle 4960, contributing to the lateral alignment of center of gravity with the first and second handle portions 4950, 4955 and the blade 4800, and improving stability and balance during operation of the concrete saw 4000. In this example arrangement of the multi-motor drive unit 4200, transmission 4300, pulley assembly 4400, and blade 4800, the center of gravity of the concrete saw 4000 is at a central portion of the multi-motor drive unit 4200/transmission 4300, positioned proximate, and to the rear of the blade 4800, with the battery pack 4600 installed in the battery receptacle 4960. During operation, the center of gravity falls into, or is in alignment with a cut being made, and forward of the heel portion 4990 of the concrete saw 4000. This allows a notable portion of the weight to be directed into the cut, and not borne by the user. Together with the alignment of the center of gravity with the blade 4800 to improve lateral stability/balance during operation, this may enhance user operation and control of the concrete saw 4000, and may reduce user fatigue associated with use of the concrete saw 4000.

In this example arrangement, all of the motors 4210 are engaged with the master gear 4330 of the transmission 4300, with the axes of rotation of the motors 4210 of the multi-motor drive unit 4200, the first and second idler gears 4310, 4320 and master gear 4330 of the transmission 4300, the first and second pulleys 4410, 4420 of the pulley assembly 4400, and the blade 4800 all arranged in parallel. The parallel axis arrangement of the motors 4210, the gears 4310, 4320, 4330, the pulleys 4410, 4420 and the blade 4800 may provide for more stable operation of the concrete saw 4000, and may reduce vibratory and/or inertial forces experienced by the user during operation of the concrete saw 4000.

As described above, in this example arrangement, some of the motors 4210 (for example, the first motor 4210A and second motor 4210B) rotate in a first direction R1, and some of the motors 4210 (for example, the third motor 4210C, fourth motor 4210D, and fifth motor 4210E) rotate in a second direction R2, opposite the first direction R1. In this arrangement, operation of the first and second motors 4210A, 4210B cancels out inertial forces generated due to operation of all but one of the third, fourth and fifth motors 4210C, 4210D, 4210E. This may reduce or substantially eliminate a significant amount of reaction torque associated with operation of the motors 4210.

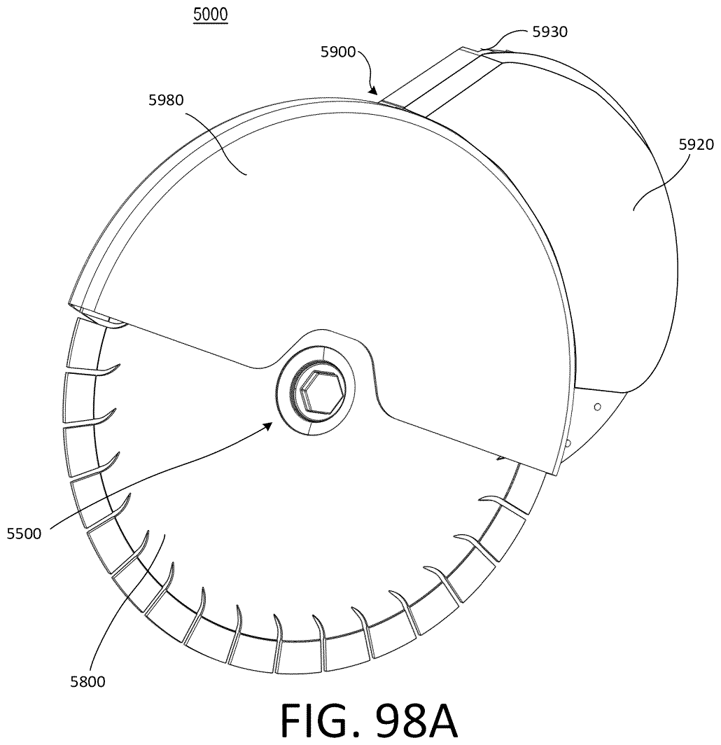

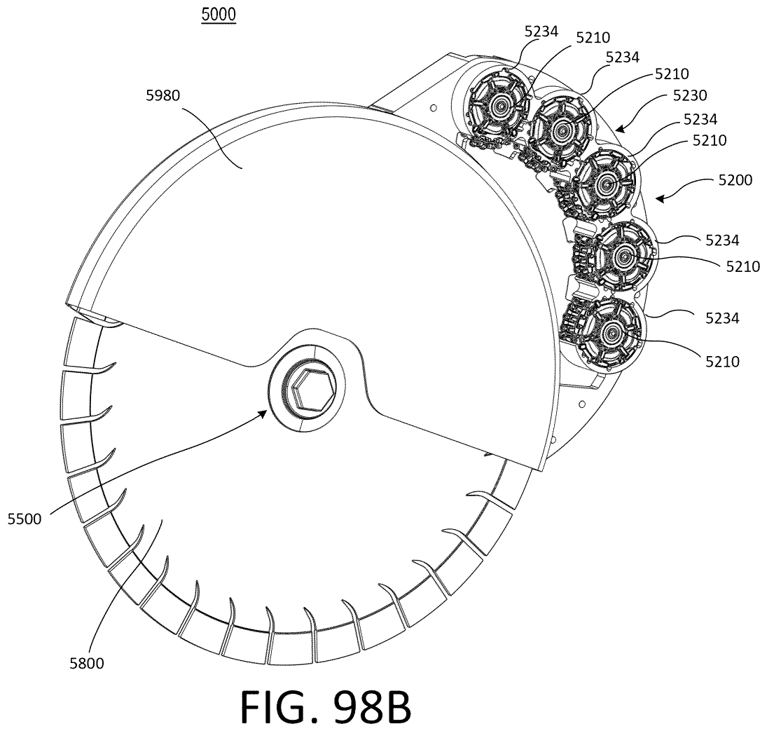

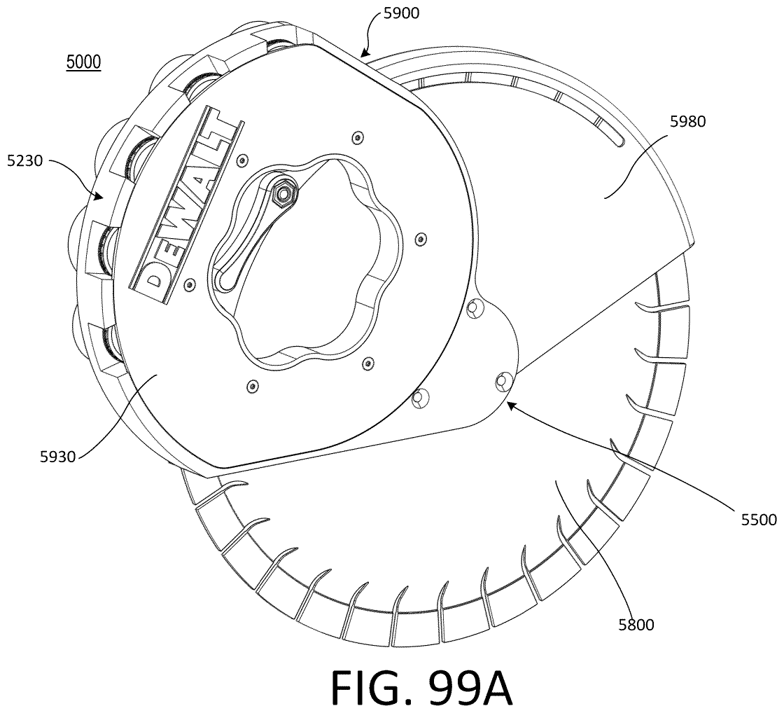

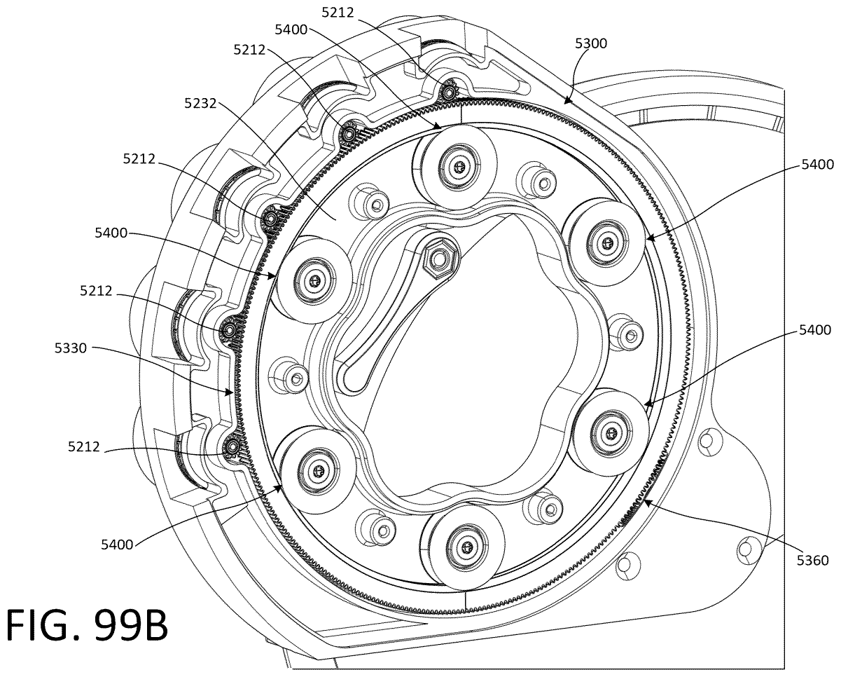

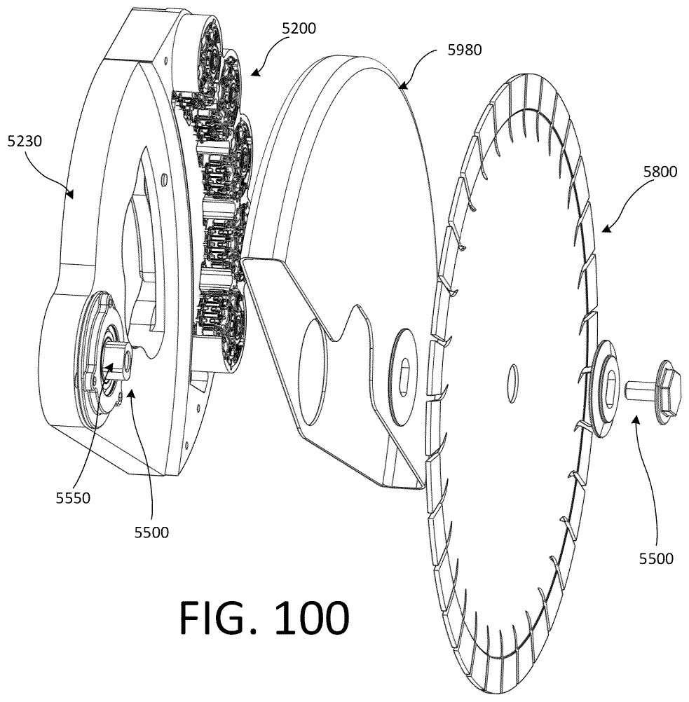

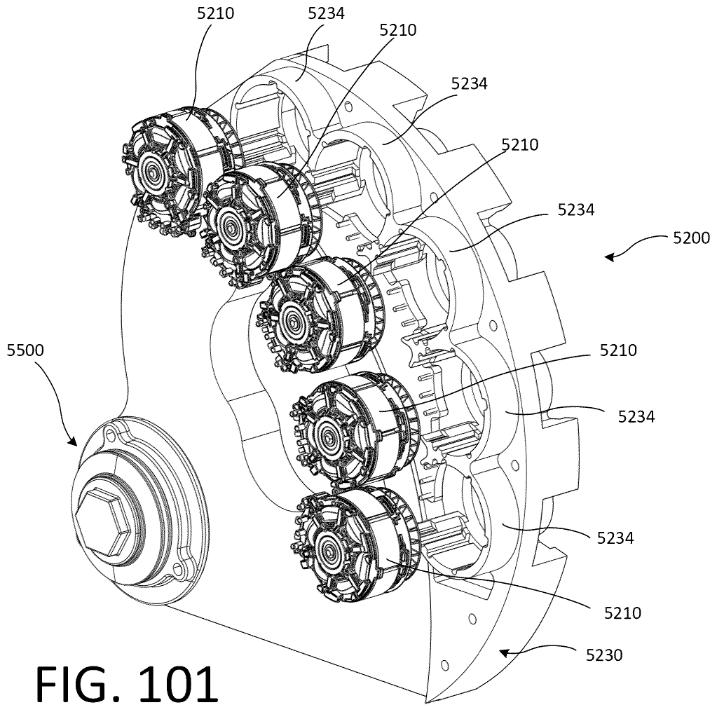

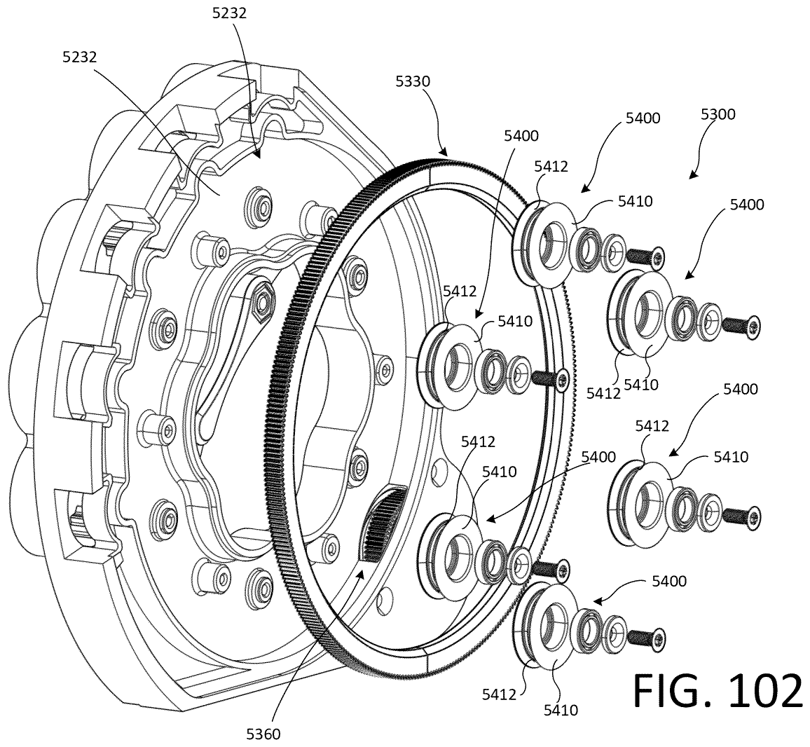

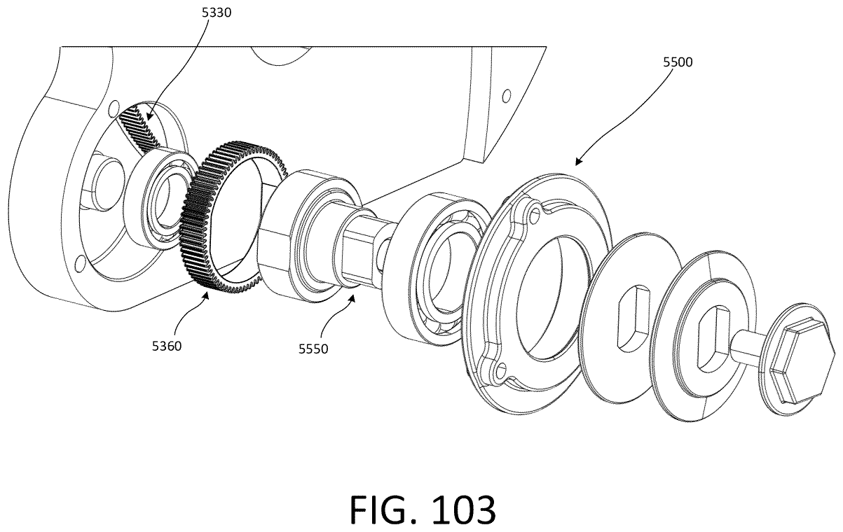

FIGS. 98A-103 illustrate an example drive assembly 5000 for a power-driven tool, such as, for example, a concrete saw as described above, or other power-driven tool which may be driven by a multi-motor drive unit, in accordance with the principles described herein. In particular, FIGS. 98A and 98B are perspective views of an example multi-motor drive unit and blade guard assembly 5000, from a first side of the assembly 5000. FIGS. 99A and 99B perspective views of the example multi-motor drive unit and blade guard assembly, from a second side of the assembly. In FIG. 98A, a motor cover 5920 has been removed, so that components of a multi-motor drive unit 5200 are visible. In FIG. 99B, a transmission cover 5930 has been removed, so that components of a transmission 5300 are visible. FIG. 100 is a partially exploded view of the example drive assembly shown in FIGS. 98A-99B. FIG. 101 is a partially exploded view of the example multi-motor drive unit 5200 shown in FIG. 98B. FIG. 102 is a partially exploded view of the example transmission 5300 shown in FIG. 99B. FIG. 103 is an exploded view of an example hub assembly 5500, coupling the example multi-motor drive unit 5200 and transmission 5300 to a blade 5800.

The example assembly 5000, including the multi-motor drive unit 5200 operably coupled with the transmission 5300 to rotate the blade 5800 may be a component of a power-driven tool such as, for example, a concrete saw as described above with respect to FIGS. 82-97, or other power-driven tool which may be driven by the rotary force output by the multi-motor drive unit 5200 and transmission 5300. In some examples, multi-motor drive unit 5200 and the transmission 5300 output a rotational force in response to power supplied by a power source, such as, for example, a battery or other power storage and/or supply source. In particular, rotary force generated by the multi-motor drive unit 5200 is transmitted, via the transmission 5300, to the blade 5800, with the hub assembly 5500 providing for coupling of the blade 5800 to an output shaft 5550 of the transmission 5300, to fix the 5800 relative to the assembly 5000, and rotate the blade 5800. The blade 5800 is partially received in a blade guard 5980. In this example, the blade guard 5980 is semi-circular in shape, to conform to the shape of the blade 5800, leaving a portion of the blade 5800 exposed for interaction with a workpiece during operation, while functioning as a guard as the blade 5800 rotates during operation.

The multi-motor drive unit 5200 and the transmission 5300 are received within a housing 5900, with the motor cover 5920 and the transmission cover 5930 defining corresponding exterior portions of the housing 5900. The multi-motor drive unit 5200 includes a plurality of motors 5210 that are engaged with a common master gear and output gear to cooperatively drive a common output shaft. Each of the plurality of motors 5210 may be, for example, a Brushless Direct-Current (BLDC) motor. The motors 5210 may be similar to the motors 200 described above, and thus duplicative detailed description thereof will be omitted except where necessary.

The example multi-motor drive unit 5200 includes an arrangement of five motors 5210, in an arcuate arrangement along a periphery of the blade guard 5980/blade 5800. Each motor 5210 is mounted in a corresponding opening 5234 in a motor adapter 5230. In this example arrangement, the motors 5210 all rotate in the same direction, about respective axes of rotation that are arranged in parallel. Rotation of the motors 5210 causes corresponding rotation of pinions 5212 of the motors 5210 (see FIG. 99B).

The transmission 5300 is coupled to the plurality of motors 5210 of the multi-motor drive unit 5200 to receive a driving force, for example, a rotational driving force, and transmit the driving force to the blade 5800 for rotation of the blade 5800. In this example arrangement, the pinions 5212 of the plurality of motors 5210 are engaged, for example, in meshed engagement, with a master gear 5330 of the transmission 5300 such that the master gear 5330 rotates in response to rotation of the motors 5210/pinions 5212. The master gear 5330 is in meshed engagement with an output gear 5360, such that the output gear 5360 rotates in response to rotation of the master gear 5330 (and the pinions 5212/motors 5210). An output shaft 5550 is coupled, for example, fixedly coupled to the output gear 5360 such that the output shaft 5550 rotates together with the output gear 5360. The output shaft 5550 is coupled in the hub assembly 5500, coupling the blade 5800 to the multi-motor drive unit 5200/transmission 5300, to transfer the rotational force from the multi-motor drive unit 5200/transmission 5300 to the blade 5800 to rotate the blade 5800.

The master gear 5330 is rotatably mounted on a plurality of roller assemblies 5400. In this example arrangement, the pinions 5212 are positioned along an outer circumferential portion of the master gear 5330, to provide for engagement between teeth of the pinions 5212 and teeth of the master gear 5330. The roller assemblies 5400 are positioned along an inner circumferential portion of the master gear 5330, with the inner circumferential portion of the master gear 5330 riding in recessed portions 5412 of rollers 5410 of each of the roller assemblies 5400. The roller assemblies 5400 are rotatably mounted on pins coupled to a plate portion 5232 of the motor adapter 5230. The roller assemblies 5400 are positioned on the plate portion 5232 such that the roller assemblies 5400 support and guide the rotation of the master gear 5330.

In operation, in response to an application of power to the motors 5210, the motors 5210 generate a rotary force. The rotary force generated by the motors 5210 is transmitted, via the pinions 5212, to the transmission 5300 and to the hub assembly 5500, where the rotary force is output to the blade 5800, causing the blade 4800 to rotate to perform an operation on a workpiece. In particular, the master gear 5330 rotates in response to rotation of the pinions 5212, each in meshed engagement with the master gear 4330. The output gear 5360 rotates in response to rotation of the master gear 5330. The output shaft 5550 is fixed in, and rotates with the output gear 5360, and is fixed in the hub assembly 5500 such that the blade 5800, coupled to the hub assembly 5500, rotates in response to rotation of the output shaft 5550 and the hub assembly 5500.

In this example arrangement, the motors 5210 are coupled in the motor adapter 5230 in a substantially planar arrangement, with the components of the transmission 5300 arranged on an opposite side of the motor adapter 5230. This results in a relatively small profile associated with the multi-motor drive unit 5200/transmission 5300. This narrower profile, for example, in the direction of the axis of rotation of the blade 5800, may provide for a more compact overall profile of the assembly 5000, and a power-driven tool to be driven by the assembly 5000. In an example in which the assembly 5000 is incorporated into a concrete saw, such as the example concrete saw 4000 described above, this arrangement may improve lateral cut clearances (i.e., clearances from walls, edges and the like), and may allow for maximum depth of cut of the concrete saw 4000. This relatively compact arrangement of the multi-motor drive unit 5200 and transmission 5300 may also facilitate ambidextrous use of the concrete saw 4000.

In this example arrangement, the motors 5210 of the multi-motor drive unit 5200 are positioned in a substantially arcuate arrangement, at an outer periphery of the blade 5800/blade guard 5980. In this example arrangement, the master gear 5330 is positioned between an axis of rotation of the blade 5800 and the arcuate arrangement of motors 5210. This arrangement of the multi-motor drive unit 5200 and transmission 5300, positioned proximate the blade 5800, may improve stability and balance during operation of a power-driven tool driven by the assembly 5000.

In this example arrangement, all of the motors 5210 are engaged with the master gear 5330 of the transmission 5300, with the axes of rotation of the motors 5210 of the multi-motor drive unit 5200, the master gear 5330 and output gear 5360, and the blade 5800 all arranged in parallel. The parallel axis arrangement of the motors 5210, the gears 5330, 5360, and the blade 5800 may improve stability during operation, and may reduce vibratory and/or inertial forces experienced by the user during operation.

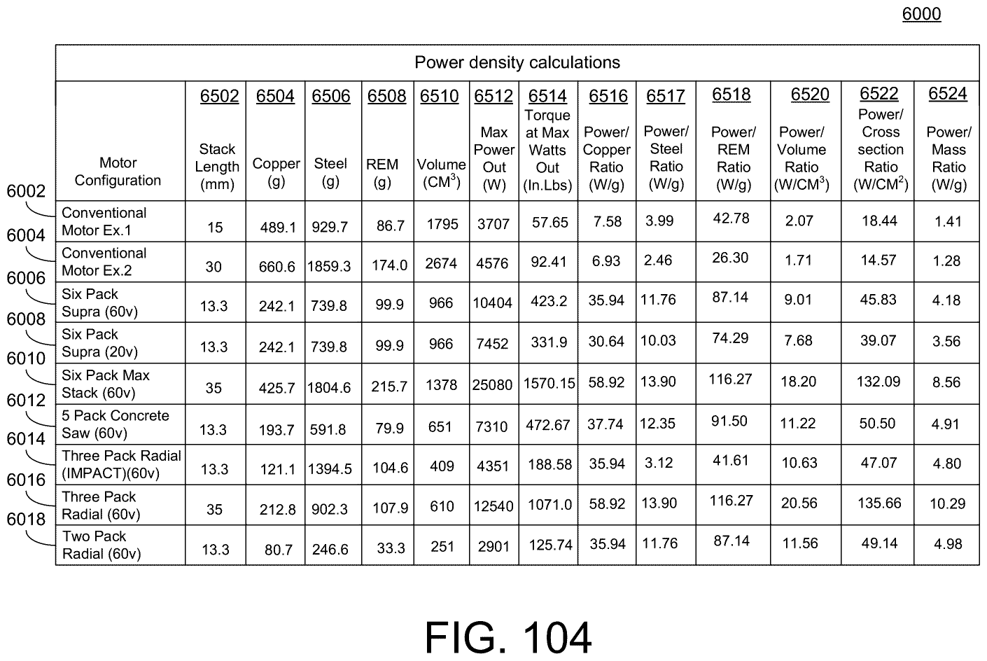

FIG. 104 depicts a table 6000 of power density calculations. Table 6000 compares power density calculations for one or more of the multi-motor drive units described above against one or more conventional motor arrangements. Table 6000 includes the following motor configurations in the rows of the table: conventional motor Ex. 1 6002, conventional motor Ex. 2 6004, six pack multi-motor 6006 with a 60V 9 Ah power supply, six pack multi-motor 6008 with a 20V 27 Ah power supply, six pack multi-motor 6010 with a 60V 30 Ah power supply, concrete saw with five pack motor 6012, impact driver with three pack radial motor 6014, three pack radial motor 6016, and a two pack radial motor 6018.

In the example motor configurations, the six pack multi-motor 6006, 6008, and 6010 includes the drive unit 100. The various configurations of the six pack multi-motor 6006, 6008, and 6010 are the drive unit 100 being used with different power supplies (e.g., different battery packs or combinations of battery packs). The concrete saw with five pack motor 6012 is the concrete saw 4000. The impact driver with three pack radial 6014 is a power tool using the drive unit 500. The three pack radial 6016 is the drive unit 500. The two pack radial 6018 is like the drive unit 500 but with only two motors instead of three.

The table includes characteristics and calculations for each of the various motor configurations. The characteristics include stack length 6502, copper mass 6504, steel mass 6506, rare earth metals (REM) mass 6508, volume 6510, max power out 6512, torque at max watts out 6514, power/copper ratio 6516, power/steel ratio 6517, power/REM ratio 6518, power/volume ratio 6520, power/cross section ratio 6522, and power/mass ratio 6524.

Table 6000 illustrates the advantages and improvements in various power density calculations of the drive units described above compared to conventional motor configurations. For example, in an embodiment, six pack multi-motor 6006, 6008, and 6010 achieve a power/volume ratio 6520 in the range of approximately 5 W/cm³ to 25 W/cm³. In an embodiment, six pack multi-motor 6006, 6008, and 6010 achieves a power/volume ratio 6520 in the range of approximately 7 W/cm³ to 18 W/cm³. In an embodiment, six pack multi-motor 6006 achieves a power/volume ratio 6520 of at least 9 W/cm³. In an embodiment, six pack multi-motor 6008 achieves a power/volume ratio 6520 of at least 7 W/cm³. In an embodiment, six pack multi-motor 6010 achieves a power/volume ratio 6520 of at least 17 W/cm³. As can be seen from the Table 6000, these power/volume ratios 6520 are an improvement over the power/volume ratios 6520 of conventional motors 6002 and 6004.

In another example, in an embodiment, six pack multi-motor 6006, 6008, 6010 achieve a power/copper ratio 6516 in the range of approximately 25 W/g to 65 W/g. In an embodiment, six pack multi-motor 6006, 6008, 6010 achieve a power/copper ratio 6516 in the range of approximately 30 W/g to 60 W/g. In an embodiment, six pack multi-motor 6006 achieves a power/copper ratio 6516 of at least 35 W/g. In an embodiment, six pack multi-motor 6008 achieves a power/copper ratio 6516 of at least 30 W/g. In an embodiment, six pack multi-motor 6010 achieves a power/copper ratio 6516 of at least 56 W/g. As can be seen from the Table 6000, these power/copper ratios 6516 are an improvement over the power/copper ratios 6516 of conventional motors 6002 and 6004.

For example, in an embodiment, six pack multi-motor 6006, 6008, and 6010 achieve a power/cross-section ratio 6522 in the range of approximately 20 W/cm² to 140 W/cm². In an embodiment, six pack multi-motor 6006, 6008, and 6010 achieves a power/cross-section ratio 6522 in the range of approximately 30 W/cm² to 135 W/cm². In an embodiment, six pack multi-motor 6006 achieves a power/cross-section ratio 6522 of at least 45 W/cm². In an embodiment, six pack multi-motor 6008 achieves a power/cross-section ratio 6522 of at least 39 W/cm². In an embodiment, six pack multi-motor 6010 achieves a power/cross-section ratio 6522 of at least 126 W/cm². As can be seen from the Table 6000, these power/cross-section ratios 6522 are an improvement over the power/cross-section ratios 6522 of conventional motors 6002 and 6004.

It is understood from table 6000 that the above are just a few examples of the improvements realized in various power density calculations and that other improvements are as indicated in table 6000.

FIG. 105 depicts a table 7000 of gear ratio ranges for various motor configurations. The first column of table 7000 lists different motor configurations including a circular saw such as circular saw 1000, three pack standard such as drive unit 500, impact/micro such as an impact tool with a two motor drive unit, six pack such as drive unit 100 but with a single stage transmission, six pack (two stage) such as drive unit 100, rhomboid such as drive unit 600, linear three such as drive unit 700, and concrete saw such as concrete saw 4000. Table 7000 depicts various gear reduction ratios for each of the listed motor configurations. In an embodiment, the gear reduction ratios include minimum reductions, maximum reductions, and modeled reductions for first stage gears, second stage gears, and final reduction gears.

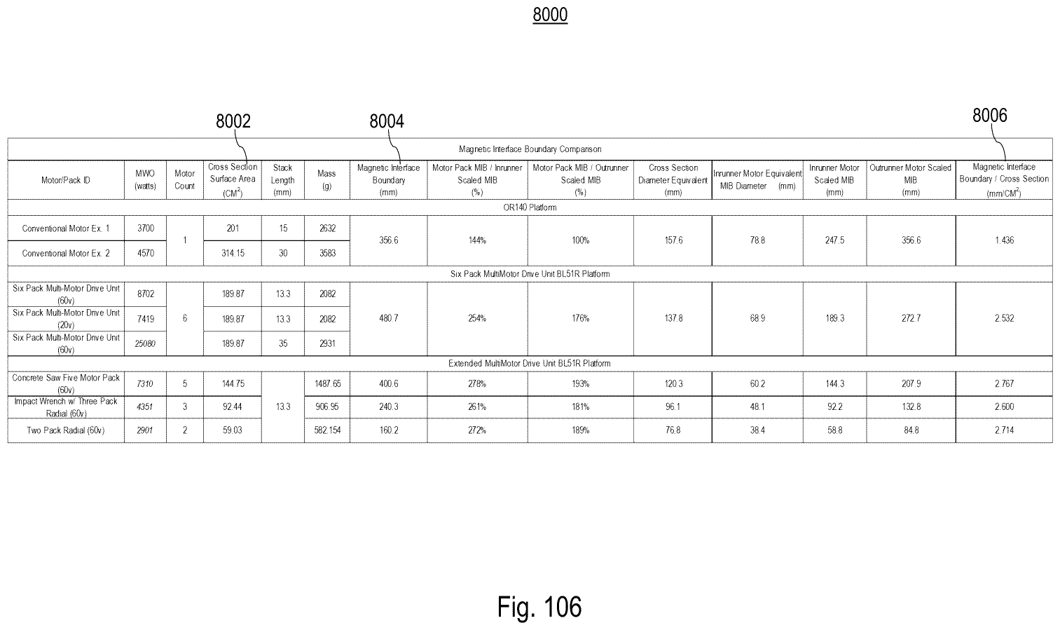

FIG. 106 depicts a table 8000 of magnetic interface boundaries for various motor configurations. The magnetic interface boundary (or MIB) is described above with reference to the electro-magnetic boundary. Table 8000 differs from the description above in that the table 8000 provides a cross-section surface area 8002 and a magnetic interface boundary 8004 to obtain a magnetic interface boundary/cross section ratio 8006 for each of the motor configurations. The first column of table 8000 lists different motor configurations including two conventional motor configurations. The other motor configurations include a six pack multi-motor such as drive unit 100 in two different power supply configurations, a concrete saw with five pack motor such as concrete saw 4000, impact driver with three pack radial such as drive unit 500, and a two pack radial motor pack.

Table 8000 illustrates the increase in the magnetic boundary interface relative to the cross section of the motor configuration for all of the new motor configurations compared to the two conventional motor configurations. For example, in an embodiment, the new motor configurations achieve a magnetic interface boundary/cross section ratio 8006 in a range of approximately 1.5 mm/cm² to 3.0 mm/cm². In an embodiment, the new motor configurations achieve a magnetic interface boundary/cross section ratio 8006 in a range of approximately 1.7 mm/cm² to 2.8 mm/cm². In an embodiment, the new motor configurations achieve a magnetic interface boundary/cross section ratio 8006 in a range of approximately 2.0 mm/cm² to 2.7 mm/cm². In an embodiment, the new motor configurations achieve a magnetic interface boundary/cross section ratio 8006 of at least 2.5 mm/cm². In an embodiment, the new motor configurations achieve a magnetic interface boundary/cross section ratio 8006 of at least 2.7 mm/cm².

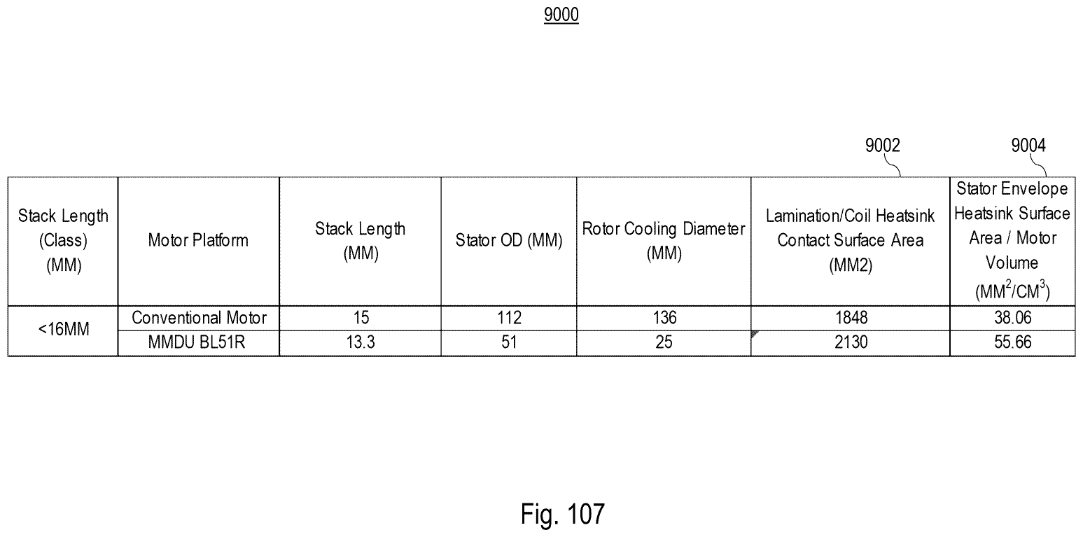

FIG. 107 depicts a table 9000 of cooling characteristics for a conventional outer-rotor motor and a multi-motor drive unit, such as drive unit 100. Table 9000 illustrates the lamination/coil heatsink contact surface area 9002 and a stator envelope heatsink surface area/motor volume ratio 9004. As illustrated, the six pack motor configuration such as drive unit 100 achieves an improved stator envelope heatsink surface area/motor volume ratio 9004 as compared to the conventional outer-rotor motor. In an embodiment, the improvement may be attributed, at least in part, to an increase in the heat sink surface area of the sleeve 120 of drive unit 100. Sleeve 120 may be made of a material (e.g., aluminum or other thermally conductive material) that dissipates heat from the motor components. In an embodiment, for example, the six pack motor achieves a stator envelope heatsink surface area/motor volume ratio 9004 in a range of approximately 40 mm²/cm³ to 70 mm²/cm³. In an embodiment, for example, the six pack motor achieves a stator envelope heatsink surface area/motor volume ratio 9004 in a range of approximately 50 mm²/cm³ to 60 mm²/cm³. In an embodiment, for example, the six pack motor achieves a stator envelope heatsink surface area/motor volume ratio 9004 in a range of approximately 53 mm²/cm³ to 60 mm²/cm³. In an embodiment, for example, the six pack motor achieves a stator envelope heatsink surface area/motor volume ratio 9004 of at least 55 mm²/cm³.

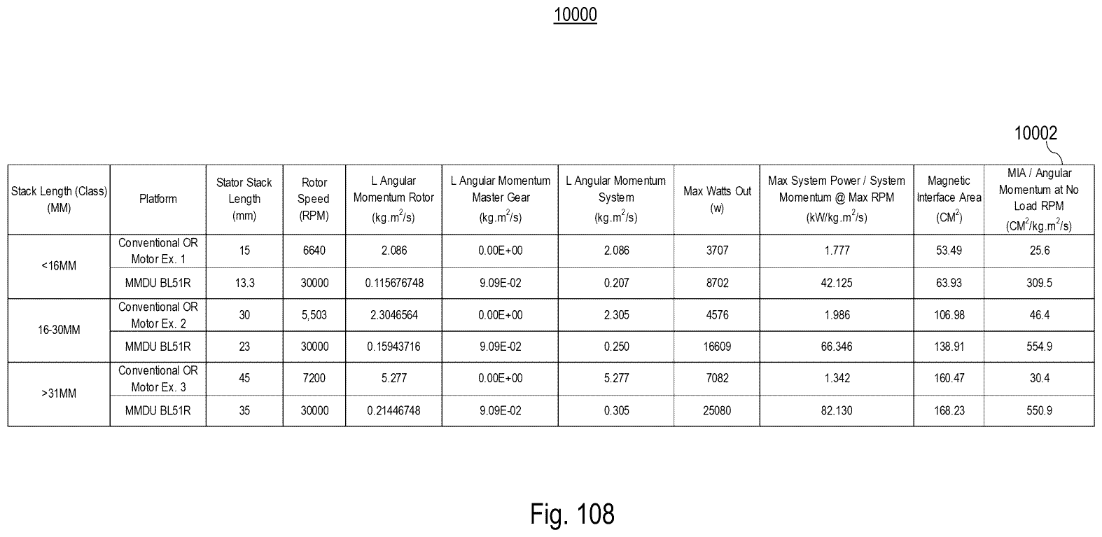

FIG. 108 depicts a table 10000 of inertia calculations for various motor configurations. Table 10000 illustrates the magnetic interface area (MIA)/angular momentum at no load RPM ratio 10002. As illustrated, different six pack motor configurations such as drive unit 100 in different configuration (e.g., different stator stack lengths) achieve an improved magnetic interface area (MIA)/angular momentum at no load RPM ratio 10002 as compared to the conventional motor in different configurations.

In an embodiment, for example, the six pack motor achieves a magnetic interface area (MIA)/angular momentum ratio at no load RPM ratio 10002 in a range of approximately 200.0 cm²/kg·m²/s to 600 cm²/kg·m²/s. In an embodiment, for example, the six pack motor achieves a magnetic interface area (MIA)/angular momentum ratio at no load RPM ratio 10002 in a range of approximately 250.0 cm²/kg·m²/s to 565 cm²/kg·m²/s. In an embodiment, for example, the six pack motor achieves a magnetic interface area (MIA)/angular momentum ratio at no load RPM ratio 10002 in a range of approximately 300.0 cm²/kg·m²/s to 555 cm²/kg·m²/s. In an embodiment, for example, the six pack motor achieves a magnetic interface area (MIA)/angular momentum ratio at no load RPM ratio 10002 of at least 309.0 cm²/kg·m²/s. In an embodiment, for example, the six pack motor achieves a magnetic interface area (MIA)/angular momentum ratio at no load RPM ratio 10002 of at least 550.0 cm²/kg·m²/s.

In some aspects, the techniques described herein relate to a multi-motor drive unit including: a rear cover; a plurality of motors disposed around a center longitudinal axis along a radial plane, a rear end of the plurality of motors being secured to the rear cover and each of the plurality of motors including a pinion; a master gear including peripheral teeth that engage the pinion of each of the plurality of motors; a motor adapter disposed between the master gear and the plurality of motors to pilot and support the master gear and a front end of the plurality of motors; an output shaft; and a front cover to pilot and support an output bearing of the output shaft.

In some aspects, the techniques described herein relate to a multi-motor drive unit, wherein: the rear cover defines a center opening around the center longitudinal axis; and each of the plurality of motors includes terminals that are located radially inward of a circumference of the center opening.

In some aspects, the techniques described herein relate to a multi-motor drive unit, wherein: the rear cover includes a plurality of air intakes disposed equidistantly around the center opening.

In some aspects, the techniques described herein relate to a multi-motor drive unit, wherein: the plurality of motors includes motors of equal size and structure.

In some aspects, the techniques described herein relate to a multi-motor drive unit, wherein: each of the plurality of motors includes a fan disposed on a distal end of a rotor shaft of each of the plurality of motors; and each of the plurality of motors is disposed and positioned in a respective air intake of the plurality of air intakes such that the fan of each of the plurality of motors generates airflow through the respective air intake.

In some aspects, the techniques described herein relate to a multi-motor drive unit, further including: a spacer disposed between the motor adapter and the master gear, the spacer including a set of outwardly-projecting arms extending at least partially between the fans of the plurality of motors to redirect the airflow expelled from the fans along a generally radial direction.

In some aspects, the techniques described herein relate to a multi-motor drive unit, wherein: the spacer is configured to create a circumferential exhaust path extending around the multi-motor drive unit.

In some aspects, the techniques described herein relate to a multi-motor drive unit, wherein: a ratio of a total fan circumference of the fans of the plurality of motors to a cross-sectional area of the multi-motor drive unit is approximately 4.56 mm/cm².

In some aspects, the techniques described herein relate to a multi-motor drive unit, wherein: the motor adapter includes a plurality of arms in spaces between adjacent motors from the plurality of motors, each of the plurality of arms in contact with at least a portion of one of the plurality of motors.

In some aspects, the techniques described herein relate to a multi-motor drive unit, further including: a sleeve to surround the plurality of motors, the sleeve being disposed between the rear cover and the front cover.

In some aspects, the techniques described herein relate to a multi-motor drive unit, wherein: the sleeve includes a thermally conductive material to remove heat from the plurality of motors.

In some aspects, the techniques described herein relate to a multi-motor drive unit, wherein: the sleeve includes a plurality of arms in spaces between adjacent motors from the plurality of motors, each of the plurality of arms engage at least a portion of one of the plurality of motors to radially align and secure the plurality of motors.

In some aspects, the techniques described herein relate to a multi-motor drive unit, wherein: the motor adapter forms a master bearing that pilots and supports the master gear, wherein the master bearing is radially aligned with the pinion of each of the plurality of motors.

In some aspects, the techniques described herein relate to a multi-motor drive unit, wherein: a magnetic interface boundary/cross section ratio is in a range of approximately 1.5 mm/cm² to 3.0 mm/cm².

In some aspects, the techniques described herein relate to a multi-motor drive unit, wherein: a power/mass ratio is in a range of approximately 3 W/g to 10 W/g.

In some aspects, the techniques described herein relate to a multi-motor drive unit, wherein: the magnetic interface boundary of the multi-motor drive unit is a sum of an electro-magnetic boundary of each of the plurality of motors.

In some aspects, the techniques described herein relate to a multi-motor drive unit, wherein: a power/volume ratio is in a range of approximately 5 W/cm³ to 25 W/cm³.

In some aspects, the techniques described herein relate to a multi-motor drive unit, wherein the master gear includes: a first sun gear that meshes with the pinion of each of the plurality of motors; and a second sun gear that is coaxial with the first sun gear.

In some aspects, the techniques described herein relate to a multi-motor drive unit, wherein: a diameter of the second sun gear is smaller than a diameter of the first sun gear.

In some aspects, the techniques described herein relate to a multi-motor drive unit, further including: a planet gear and carrier assembly that is coupled to the master gear through the second sun gear, the planet gear and carrier assembly being coupled to drive the output shaft.

In some aspects, the techniques described herein relate to a multi-motor drive unit, wherein: the plurality of motors includes six brushless direct-current motors spaced at equidistant angular positions relative to the center longitudinal axis.

In some aspects, the techniques described herein relate to a multi-motor drive unit, wherein: the rear cover defines a center opening around the center longitudinal axis; and the plurality of motors includes three brushless direct-current motors with each of the plurality of motors having terminals that are offset relative to the center opening.

In some aspects, the techniques described herein relate to a multi-motor drive unit, further including: a single set of position sensors disposed in proximity to a rotor of one of the plurality of motors; and a motor control unit that is electrically connected to the plurality of motors, the motor control unit uses the single set of position sensors to control the plurality of motors.

In some aspects, the techniques described herein relate to a multi-motor drive unit, wherein the motor control unit includes: a controller; a single gate driver that is electrically connected to the controller; and a single inverter circuit that is electrically connected the controller, the single gate driver, the plurality of motors, wherein the controller is configured to receive positional information from the single set of position sensors and to control the plurality of motors using the single gate driver and the single inverter circuit.

In some aspects, the techniques described herein relate to a multi-motor drive unit, wherein: the controller generates a set of common commutation drive signals; the single inverter circuit synchronously drives the plurality of motors using the set of common commutation drive signals.

In some aspects, the techniques described herein relate to a multi-motor drive unit, wherein the motor control unit includes: a controller; a plurality of gate drivers that are electrically connected to the controller with each of the plurality of gate drivers electrically connected to one or more motors of the plurality of motors; and a plurality of inverter circuits that are electrically connected to the controller with each of the plurality of inverter circuits electrically connected to one gate driver of the plurality of gate drivers and to one motor of the plurality of motors, wherein the controller is configured to receive positional information from the single set of position sensors and to control the plurality of motors using the plurality of gate drivers and the plurality of inverter circuits.

In some aspects, the techniques described herein relate to a multi-motor drive unit, wherein: an angular orientation of each of the plurality of motors is sequentially shifted; and the controller generates a set of commutation drive signals, wherein the set of commutation drive signals for each of the plurality of motors is sequentially shifted.

In some aspects, the techniques described herein relate to a multi-motor drive unit, wherein: the plurality of motors includes a first set of motors and a second set of motors; an angular orientation of the first set of motors is shifted relative to an angular orientation of the second set of motors; and the controller generates a first set of commutation drive signals for the first set of motors and a second set of commutation drive signals for the second set of motors, the first set of commutation drive signals shifted relative to the second set of commutation drive signals.

In some aspects, the techniques described herein relate to a multi-motor drive unit including: an output shaft; and a plurality of motors aligned in a radial plane and operably coupled to the output shaft to drive the output shaft, wherein an angular orientation of a first motor of the plurality of motors as measured between a stator of the first motor and a magnetic polarity of a rotor of the first motor is shifted compared to an angular orientation of a second motor of the plurality of motors as measured between a stator of the second motor and a magnetic polarity of a rotor of the second motor to distribute a cumulative torque ripple attributed to the first motor and the second motor.

In some aspects, the techniques described herein relate to a multi-motor drive unit, wherein: the plurality of motors includes a first set of motors including the first motor having a first angular orientation and a second set of motors including the second motor having a second angular orientation, the first angular orientation shifted relative to the second angular orientation.

In some aspects, the techniques described herein relate to a multi-motor drive unit, wherein: the plurality of motors includes six motors arranged around a center longitudinal axis in the radial plane.

In some aspects, the techniques described herein relate to a multi-motor drive unit, wherein: the plurality of motors includes three motors arranged around a center longitudinal axis in the radial plane.

In some aspects, the techniques described herein relate to a multi-motor drive unit, wherein: the plurality of motors includes three motors arranged in a linear arrangement in the radial plane.

In some aspects, the techniques described herein relate to a multi-motor drive unit, further including: a motor control unit that is electrically connected to the plurality of motors and that is configured to generate a set of commutation drive signals, wherein the set of commutation drive signals for each of the plurality of motors is sequentially shifted.

In some aspects, the techniques described herein relate to a multi-motor drive unit, further including: a single set of position sensors disposed in proximity to a rotor of one of the plurality of motors; and a motor control unit that is electrically connected to the plurality of motors, the motor control unit uses the single set of position sensors to control the plurality of motors.

In some aspects, the techniques described herein relate to a multi-motor drive unit including: an output shaft; a plurality of motors aligned in a radial plane and operably coupled to the output shaft to drive the output shaft; and a motor control unit that is electrically connected to the plurality of motors and that is configured to sequentially commutate each of the plurality of motors during a commutation drive cycle for a single rotation of the output shaft.

In some aspects, the techniques described herein relate to a multi-motor drive unit, wherein: the motor control unit sequentially commutates the plurality of motors in 20 degree intervals.

In some aspects, the techniques described herein relate to a multi-motor drive unit, wherein: each of the plurality of motors is commutated at a high efficiency zone thereof where an efficiency of each of the plurality of motors exceeds an average efficiency of the plurality of motors.

In some aspects, the techniques described herein relate to a multi-motor drive unit, wherein the motor control unit includes: a controller that generates a set of common commutation drive signals; and a plurality of inverter circuits that are electrically connected to the controller, wherein the controller is configured to sequentially commutate the plurality of motors using the set of common commutation drive signals.

In some aspects, the techniques described herein relate to a multi-motor drive unit, further including: a single set of position sensors disposed in proximity to a rotor of one of the plurality of motors, wherein the controller is configured to control the plurality of motors using the single set of position sensors.

In some aspects, the techniques described herein relate to a multi-motor drive unit, wherein: the plurality of motors includes a first set of motors and a second set of motors; the commutation drive cycle includes a first sub-portion of the commutation drive cycle and a second sub-portion of the commutation drive cycle; and the motor control unit is configured to commutate the first set of motors during the first sub-portion of the commutation drive cycle and to commutate the second set of motors during the second sub-portion of the commutation drive cycle.

In some aspects, the techniques described herein relate to a multi-motor drive unit including: a rear cover; a plurality of motors disposed in a linear arrangement along a radial plane, the plurality of motors being secured to the rear cover and each of the plurality of motors including a pinion; a first stage transmission that engages the pinion of each of the plurality of motors; a second stage transmission that engages the first stage transmission; a motor adapter disposed between the first stage transmission and the plurality of motors to pilot and support the first stage transmission and a front end of the plurality of motors; an output shaft driven by the second stage transmission; and a front cover to support the output shaft, the front cover coupled to the rear cover.

In some aspects, the techniques described herein relate to a multi-motor drive unit, wherein: the plurality of motors includes three brushless direct-current motors; and the first stage transmission includes a first gear driven by the pinion of two of the plurality of motors and a second gear driven by the pinion of two of the plurality of motors.

In some aspects, the techniques described herein relate to a multi-motor drive unit, wherein: the plurality of motors includes: a first set of three brushless direct-current motors arranged in a first linear arrangement along the radial plane, and a second set of three brushless direct-current motors arranged in a second linear arrangement along the radial plane; and the first stage transmission includes: a first gear driven by the pinion of two of the first set of three brushless direct-current motors and by the pinion of two of the second set of three brushless direct-current motors, and a second gear driven by the pinion of two of the first set of three brushless direct-current motors and by the pinion of two of the second set of three brushless direct-current motors.

In some aspects, the techniques described herein relate to a drive unit including: a plurality of electric motors, each including a stator having a body and a plurality of coils, a rotor rotatably interfacing the stator, an output shaft coupled to the rotor to provide a rotary output, and a fan mounted on at least one of the output shaft or the rotor; and a motor mount (i.e., rear cover) including a plurality of air intakes defined by a plurality of mounting regions formed circumferentially around the plurality of air intakes and on which the plurality of electric motors is mounted, each air intake having a diameter that is smaller than an outer diameter of the stator of the electric motor mounted to the respective mounting region thereto, wherein the fan of each electric motor generates an airflow that passes through the respective air intake and through the stator in contact with the plurality of coils.

In some aspects, the techniques described herein relate to a drive unit, wherein each electric motor includes at least one end insulator arranged to electrically insulate the plurality of coils from the body, wherein the at least one end insulator is mounted in contact with the respective mounting region of the motor mount.

In some aspects, the techniques described herein relate to a drive unit, wherein at least one electric motor of the plurality of electric motors includes a plurality of motor terminals electrically coupled to the plurality of coils, and the motor mount includes at least one opening though which the plurality of motor terminals is accessible for coupling to a plurality of power wires.

In some aspects, the techniques described herein relate to a drive unit, wherein the at least one opening is located at a center point of the motor mount radially inward of the plurality of air intakes.

In some aspects, the techniques described herein relate to a drive unit, wherein the at least one opening is a slot extending laterally relative to a center point of the motor mount.

In some aspects, the techniques described herein relate to a drive unit, further including an a housing forming at least one slot in radial alignment with the fans of the plurality of electric motors, and a fan baffle located adjacent the fans of the plurality of electric motors to expel the airflow through the at least one slot.

In some aspects, the techniques described herein relate to a drive unit including: a first motor including a stator having a body and a plurality of coils, a rotor rotatably interfacing the stator, and an output shaft coupled to the rotor to provide a rotary output; a second motor including a stator having a body and a plurality of coils, a rotor rotatably interfacing the stator, and an output shaft coupled to the rotor to provide a rotary output; a drive system commonly coupled to the rotary output of the first motor and the rotary output of the second motor; and a controller configured to determine an angular position of the rotor of the first motor and control a commutation of the first motor and the second motor accordingly.

In some aspects, the techniques described herein relate to a drive unit, wherein the first motor includes set of position sensors disposed proximate the rotor, wherein the controller receives signals from the set of position sensors and determines the angular position of the rotor of the first motor accordingly.

In some aspects, the techniques described herein relate to a drive unit, wherein the controller is configured to monitor a back-emf voltage of the first motor induced through the plurality of coils of the first motor, and determines the angular position of the rotor of the first motor accordingly.

In some aspects, the techniques described herein relate to a drive unit, wherein the controller is configured to measure a phase current of the first motor, and determines the angular position of the rotor of the first motor accordingly.

In some aspects, the techniques described herein relate to a drive unit including: a plurality of electric motors, each including a stator having a body and a plurality of coils, a rotor rotatably interfacing the stator, and an output shaft coupled to the rotor to provide a rotary output, wherein the rotary outputs of the plurality of electric motors substantially align along a plane; and a drive assembly including a first gear located on the plane and driven by the rotary output of a first electric motor of the plurality of electric motors, a second gear located on the plane and driven by the rotary output of a second electric motor of the plurality of electric motors, and a master gear offset from the plane and driven by the first and second gears to provide a rotary output of the drive unit.

In some aspects, the techniques described herein relate to a drive unit, further including a motor adapter to which the plurality of electric motors is mounted and including a plurality of through holes through which output shafts of the plurality of electric motors extend, wherein the first and second gears are rotationally supported by the motor adapter.

In some aspects, the techniques described herein relate to a power tool including: a tool housing supporting an output spindle configured to rotatably drive a rotary accessory; an accessory housing circumferentially surrounding at least a portion of the rotary accessory; a plurality of electric motors supported by the tool housing and orientated circumferentially outside the accessory housing, each electric motor including a stator having a body and a plurality of coils, a rotor rotatably interfacing the stator, and an output shaft coupled to the rotor to provide a rotary output, wherein a first plane formed by the rotary accessory intersects the stators of the plurality of electric motors, and the rotary outputs of the stators of the plurality of electric motors substantially align along a second plane parallel to the first plane; and a drive assembly including a gear that engages the rotary outputs of the plurality of electric motors and is located along the second plane circumferentially outside the accessory housing, a pulley secured to the gear, and a belt drivably mounted on the pulley and the output spindle along a third plane parallel to the first plane to transmit rotation output of the gear to the output spindle.

In some aspects, the techniques described herein relate to a power tool, further including a motor adapter mounted within the tool housing, the motor adapter at least partially circumferentially supporting the stators of the plurality of electric motors, and including side openings that provide access to motor terminals of the plurality of electric motors.

In some aspects, the techniques described herein relate to a power tool, wherein the motor terminals of each of the plurality of motors are mounted on a circumferential outer surface of the stator thereof and face away from the rotary accessory.

In some aspects, the techniques described herein relate to a power tool, further including a battery receptacle mounted on the tool housing to receive a removeable battery pack therein, wherein a plane formed through the output shafts of the plurality of electric motors passes through the removable battery pack.

In some aspects, the techniques described herein relate to a power tool, wherein herein an angular orientation of a first motor of the plurality of electric motors as measured between the stator of the first motor and a magnetic polarity of the rotor of the first motor is shifted compared to an angular orientation of a second motor of the plurality of electric motors as measured between the stator of the second motor and a magnetic polarity of the rotor of the second motor to distribute a cumulative torque ripple attributed to the first motor and the second motor.

In some aspects, the techniques described herein relate to a power tool, wherein in a first mode of operation of the power tool, only one of the plurality of electric motors is operated to drive the output spindle, and in a second mode of operation of the power tool, all of the plurality of electric motors are operated to drive the output spindle.

In some aspects, the techniques described herein relate to a power tool including: a tool housing supporting an output spindle configured to rotatably drive a rotary accessory; an accessory housing circumferentially surrounding at least a portion of the rotary accessory; a plurality of electric motors supported by the tool housing, each electric motor including a stator having a body and a plurality of coils, a rotor rotatably interfacing the stator, and an output shaft coupled to the rotor to provide a rotary output, wherein the plurality of electric motors overlap a side surface of the accessory housing; and a drive assembly configured to transmit rotation output of the plurality of electric motors to the output spindle.

In some aspects, the techniques described herein relate to a power tool including: a tool housing supporting an output spindle configured to rotatably drive a rotary accessory; an accessory housing circumferentially surrounding at least a portion of the rotary accessory; a plurality of electric motors supported by the tool housing and orientated circumferentially outside the accessory housing, each electric motor including a stator having a body and a plurality of coils, a rotor rotatably interfacing the stator, and an output shaft coupled to the rotor to provide a rotary output, wherein a first plane formed by the rotary accessory intersects the stators of the plurality of electric motors, and the rotary outputs of the stators of plurality of electric motors substantially align along a second plane parallel to the first plane; and a drive assembly including a gear located along the second plane that partially overlaps a side surface of the rotary accessory and engages the rotary outputs of the plurality of electric motors and the output spindle to transmit rotational output of the plurality of electric motors to the output spindle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “bottom,” “lower,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A multi-motor drive unit comprising:
a rear cover;
a plurality of motors disposed around a center longitudinal axis along a radial plane, a rear end of the plurality of motors being secured to the rear cover and each of the plurality of motors including a pinion;
a master gear including peripheral teeth that engage the pinion of each of the plurality of motors;
a motor adapter disposed between the master gear and the plurality of motors to pilot and support the master gear and a front end of the plurality of motors;
an output shaft; and
a front cover to pilot and support an output bearing of the output shaft.

2. The multi-motor drive unit of claim 1, wherein:
the rear cover defines a center opening around the center longitudinal axis; and
each of the plurality of motors includes terminals that are located radially inward of a circumference of the center opening.

3. The multi-motor drive unit of claim 2, wherein:
the rear cover includes a plurality of air intakes disposed equidistantly around the center opening.

4. The multi-motor drive unit of claim 1, wherein:
the plurality of motors comprises motors of equal size and structure.

5. The multi-motor drive unit of claim 3, wherein:
each of the plurality of motors includes a fan disposed on a distal end of a rotor shaft of each of the plurality of motors; and
each of the plurality of motors is disposed and positioned in a respective air intake of the plurality of air intakes such that the fan of each of the plurality of motors generates airflow through the respective air intake.

6. The multi-motor drive unit of claim 5, further comprising:
a spacer disposed between the motor adapter and the master gear, the spacer including a set of outwardly-projecting arms extending at least partially between the fans of the plurality of motors to redirect the airflow expelled from the fans along a generally radial direction.

7. The multi-motor drive unit of claim 6, wherein:
the spacer is configured to create a circumferential exhaust path extending around the multi-motor drive unit.

8. The multi-motor drive unit of claim 5, wherein:
a ratio of a total fan circumference of the fans of the plurality of motors to a cross-sectional area of the multi-motor drive unit is approximately 4.56 mm/cm².

9. The multi-motor drive unit of claim 1, wherein:
the motor adapter includes a plurality of arms in spaces between adjacent motors from the plurality of motors, each of the plurality of arms in contact with at least a portion of one of the plurality of motors.

10. The multi-motor drive unit of claim 1, further comprising:
a sleeve to surround the plurality of motors, the sleeve being disposed between the rear cover and the front cover.

11. The multi-motor drive unit of claim 10, wherein:
the sleeve includes a thermally conductive material to remove heat from the plurality of motors.

12. The multi-motor drive unit of claim 10, wherein:
the sleeve includes a plurality of arms in spaces between adjacent motors from the plurality of motors, each of the plurality of arms engage at least a portion of one of the plurality of motors to radially align and secure the plurality of motors.

13. The multi-motor drive unit of claim 1, wherein:
the motor adapter forms a master bearing that pilots and supports the master gear, wherein the master bearing is radially aligned with the pinion of each of the plurality of motors.

14. The multi-motor drive unit of claim 1, wherein:
a magnetic interface boundary/cross section ratio is in a range of approximately 1.5 mm/cm² to 3.0 mm/cm².

15. The multi-motor drive unit of claim 1, wherein:
a power/mass ratio is in a range of approximately 3 W/g to 10 W/g.

16. The multi-motor drive unit of claim 14, wherein:
the magnetic interface boundary of the multi-motor drive unit is a sum of an electro-magnetic boundary of each of the plurality of motors.

17. The multi-motor drive unit of claim 1, wherein:
a power/volume ratio is in a range of approximately 5 W/cm³ to 25 W/cm³.

18. The multi-motor drive unit of claim 1, wherein the master gear includes:
a first sun gear that meshes with the pinion of each of the plurality of motors; and
a second sun gear that is coaxial with the first sun gear.

19. The multi-motor drive unit of claim 1, further comprising:
a single set of position sensors disposed in proximity to a rotor of one of the plurality of motors; and
a motor control unit that is electrically connected to the plurality of motors, the motor control unit uses the single set of position sensors to control the plurality of motors.

20. The multi-motor drive unit of claim 19, wherein the motor control unit comprises:
a controller;
a single gate driver that is electrically connected to the controller; and
a single inverter circuit that is electrically connected the controller, the single gate driver, the plurality of motors, wherein the controller is configured to receive positional information from the single set of position sensors and to control the plurality of motors using the single gate driver and the single inverter circuit.

21. The multi-motor drive unit of claim 20, wherein:
the controller generates a set of common commutation drive signals;
the single inverter circuit synchronously drives the plurality of motors using the set of common commutation drive signals.
